(19) United States
(12) Patent Application Publication
(10) Pub. No.: US 2011/0276975 A1
(43) Pub. Date: Nov. 10, 2011

(54) AUDIO DEVICE

(76) Inventors: Niall Brown, Prague (CZ); Grant Fraser Malcolm, Kirkcaldy (GB); Grant M. More, Edinburgh (GB); Michael Robinson, Edinburgh (GB); James Thomas Deas, Edinburgh (GB); Peter John Frith, Edinburgh (GB)

(21) Appl. No.: 13/129,249

(22) PCT Filed: Nov. 13, 2009
(86) PCT No.: PCT/GB2009/051531

§ 371 Date: Jul. 20, 2011

(30) Foreign Application Priority Data
Nov. 14, 2008 (GB) 0820920.7

(51) Int. Cl. G06F 9/46

(52) U.S. Cl. 718/103

(57) ABSTRACT

An audio device is provided that is arranged for communication of data and signalling with a controller, signalling from the device to the controller being made in discrete time slots, the device comprising: a plurality of nodes, each assigned a priority value and each having one or more unsolicited response sources capable of generating an unsolicited response for transmission to the controller, wherein unsolicited responses generated from a particular node are assigned the priority value of that node; and unsolicited response management means operable to hold unsolicited responses generated by the plurality of nodes that are awaiting transmission to the controller, wherein when two or more unsolicited responses are awaiting transmission to the controller in the unsolicited response management means, the device is arranged to transmit the unsolicited response with the highest assigned priority value first, in the next free time slot.

### FIELD OF THE INVENTION

The invention relates to an audio device such as a codec, in other words a device for converting at least one digital data stream or signal; in particular but not necessarily exclusively it relates to a high definition audio codec apparatus.

### BACKGROUND

High Definition Audio (HDA), sometimes called Azalia, is a specification, by Intel®, that describes an infrastructure for integrated audio in a PC chipset environment. HDA is described in Intel High Definition Audio Specification, revision 1.0, 15 Apr. 2004, which specification is hereby incorporated by reference in its entirety.

High Definition Audio is capable of processing more channels at higher quality than previous integrated audio formats, such as Audio Codec'97 (AC'97) for example. AC'97 was developed to allow users to listen to music and movies with stereo sound. However, with the success of DVD movies encoded with Dolby Digital® and Digital Theatre System DTS® multi-channel audio formats needing full surround sound with anywhere from six to eight speakers, AC'97 has been unable to keep up with user demands. HDA compliant hardware is capable of supporting up to eight channels at 192 kHz/32-bit quality, while the AC'97 specification can only support six channels at 48 kHz/20-bit. Further, HDA hardware can additionally act as a hub, for example in a multi-room configuration, as HDA improves the capability to convey two or more different audio streams simultaneously.

FIG. 1 illustrates a known HDA hardware configuration in a PC chipset environment, which comprises a HDA codec 2. HDA codec 2 has an incoming analogue audio data path 3 and an outgoing analogue audio data path 5 and an incoming digital audio data path 7 and an outgoing digital audio data path 9. In accordance with the HDA specification, all audio data is routed via a HDA link interface 10 and HDA link 21 of codec 2, to and from an external HDA controller 20. In the incoming analogue audio data path 3, an analogue audio signal is received from an audio source 4 by analogue-to-digital converter (ADC) 6. ADC 6 converts (or “captures”) the analogue signal to digital data before it is processed by digital signal processing (DSP) unit 8 and forwarded to HDA link interface 10 where it is serialised and transmitted over HDA link 21. As will be apparent to the person skilled in the art, the DSP unit 8 is an entirely optional feature of codec 2. In the outgoing analogue audio data path 5, data sent over HDA link 21 is received by the HDA link interface 10, deserialised and processed by DSP unit 12, before being converted (“rendered”) to an analogue signal by digital-to-analogue converter (DAC) 14 for output to a connected output device 16, such as a headset or speakers. Again, as will be apparent to the person skilled in the art, the DSP unit 12 is an entirely optional feature of codec 2.

In the incoming digital audio data path 7, a digital audio signal is received from an audio source 11 by a digital interface 13 before it is forwarded to HDA link interface 10 where it is serialised and transmitted over HDA link 21. In the outgoing digital audio data path 9, data sent over HDA link 21 is received by the HDA link interface 10, deserialised and output to a connected output device 17, such as a set top box, via a digital interface 15 and an output port (not shown) e.g. TOSlink.

Although only one analogue input converter and only one analogue output converter are shown in FIG. 1, it is known for HDA codecs such as HDA codec 2, to have a plurality of analogue input and output converters for receiving and outputting multiple analogue audio sources. Although only one digital input converter and only one digital output converter are shown in FIG. 1, it is known for HDA codecs such as HDA codec 2, to have a plurality of digital input and output converters for receiving and outputting multiple audio sources, such as a Sony/Philips Digital Interface (S/PDIF) transmitter and receiver and High-Definition multimedia input (HDMI).

HDA codec 2 is physically connected to HDA controller 20 in Southbridge 22 (sometimes called the I/O controller hub) by HDA link interface 10 via 5-wire HDA link 21. Southbridge 22 is in turn connected to Northbridge 24 (sometimes called the memory controller hub), which contains a memory controller 26 that is in communication with system memory 28. Northbridge 26 links the Southbridge 22 to the host CPU 30. Running on the host CPU 30 is a software layer 32 that controls the HDA controller 20 via driver 34.

Although only one HDA codec 2 is shown connected to the HDA controller 20, provision is made in the specification to connect multiple HDA codecs to the HDA controller 20. This may be for the purpose of providing so-called “function groups” for various purposes. For example, one HDA controller may belong to the audio function group (AFG) for processing audio data and another HDA codec may belong to a modem function group for performing modem functions.

HDA controller 20 is a bus mastering I/O peripheral that contains one or more direct memory access (DMA) engines 36, each of which can be used to transfer a single audio stream to memory 28 from the HDA codec 2 or from memory 28 to the HDA codec 2 depending on the DMA type. DMA engines 36 allow HDA controller 20 to read and/or write to memory 28 independently of the host CPU 30.

Data is organised for transmission via HDA link 21 in streams and channels. In this context, a stream is a logical or virtual connection created between system memory (buffer) 28 and the HDA codec that is rendering or capturing the data, HDA codec 2 in the example shown in FIG. 1. Streams can either be input streams or output streams. Input streams are transmitted from HDA codec 2 via HDA link 21 to HDA controller 20. Output (outbound) streams are transmitted by HDA controller 20 over the HDA link 21 and received by HDA link interface 10 of HDA codec 2, and can be broadcast to more than one HDA codec. All channels within a stream must have the same sample rate and the same sample size. Streams are transferred over HDA link 21 in a series of frames. Each frame contains a sample block corresponding to each stream, or at least each enabled stream, “enabled” in sense that data is available to be transferred.

From the HDA controller 20, each stream is driven by a single DMA engine 36 over HDA link 21. A stream contains one or more related components or channels of data, each of which is dynamically bound to a single converter in HDA codec 2 for rendering or capturing. For example, an outbound stereo stream contains two channels, left and right. For simplicity, FIG. 1 only shows the analogue input and output paths and the digital input and output paths as single lines, though as will be apparent to the skilled person, the signal lines may represent stereo or dual mono paths. Each sample block corresponding to this stereo stream in the series of frames will contain two samples (channels), left and right, which are bound to a stereo DAC in the HDA codec. The two samples (channels) are transmitted across HDA link 21 together in the same sample blocks, but each sample (channel) is bound to a separate DAC in HDA codec 2 (only one DAC is shown in FIG. 1).

FIG. 2 schematically illustrates the individual wires of HDA link 21 which constitutes the connection between HDA codec 2 and HDA Controller 20. HDA link 21 is a 5 wire digital serial interface which transmits serialised data between HDA codec 2 and the HDA controller 20. The HDA link 21 carries a bit clock (BCLK) signal 40, a synchronisation (SYNC) signal 42, a serial data out (SDO) signal 44, a serial data in (SDI) signal 46 and a link reset signal (RST#) signal 48.

BCLK signal 40 is generated by the HDA controller 20 and is used by HDA codec 2 and any additional HDA codecs connected to the HDA controller 20. BCLK 40 is the sample rate time base and is defined as a 24 MHz clock in the HDA specification.

SYNC signal 42 is generated by HDA controller 20 and is used to mark input and output frame boundaries with Frame Sync markers as well as identifying outbound data streams with stream tags, as will be described later. SYNC 42 connects to HDA codec 2 and any additional HDA codecs connected to the HDA controller 20.

SDO signal 44 is a serial data output signal that is generated by HDA controller 20 and transmitted to HDA codec 2. Output streams from HDA controller 20 as well as commands and other signalling are transmitted to HDA codec 2 on SDO 44. In the case of multiple HDA codecs being connected to HDA controller 20 by the HDA link 21, HDA controller 20 generates output streams for each and every connected HDA codec in SDO signal 44. Data is double pumped on SDO 44. In other words, HDA controller 20 drives data onto SDO 44, and HDA codec 2 samples the data on SDO 44 with respect to both the rising and falling edges of BCLK 40.

SDI signal 46 is a serial data input signal generated by HDA codec 2 for transmission to HDA controller 20. Input streams from HDA codec 2 are transmitted to HDA controller 20 on SDI 46. In the case of multiple HDA codecs being connected to HDA controller 20 by the HDA link 21, each HDA codec must generate a separate serial data input signal for transmission to HDA controller 20. Data is single pumped on SDI 46. In other words, HDA codec 2 drives data onto SDI 46 and HDA controller 20 samples SDI 46 with respect to the rising edge of BCLK 40 only. As well as being generated by HDA codec 2, it is also possible for HDA controller 20 to generate SDI signals during initialization.

The RST# signal 48 is generated by HDA controller 20 and connects to HDA codec 2 and any additional HDA codecs connected to the HDA controller 20. Assertion of the RST# signal 48 results in all interface logic in HDA link interface 10 being reset to default power on state.

FIG. 3 illustrates the demarcation of a known HDA frame. A frame is defined as a 20.833 μs window of time marked by the falling edge of a Frame Sync marker transmitted on SYNC 42.

As shown in FIG. 3, the clock signal on BCLK 40 is a 24 MHz clock. The Frame Sync marker is a high going pulse on SYNC 42, which is exactly 4 BCLK cycles in width (8 SDO bits). A Frame Sync marker is generated every 500 BCLK pulses. The Frame Sync marker is generated by HDA controller 20.

The falling edge of Frame Sync marker on SYNC 42 identifies the start of the ‘current frame’ and hence the end of the ‘previous frame’. The falling edge of Frame Sync marker, generated 500 BCLK cycles (not all shown in FIG. 3) after Frame Sync marker, identifies the start of the ‘next frame’ and hence the end of the ‘current frame’. A new frame therefore starts every 20.833 μs, which corresponds to the 500 cycles of BCLK at 24 MHz.

In one frame there are 1000 output bits on SDO 44 (numbered 999 to 0) and 500 input bits on SDI 46 (numbered 499 to 0) due to SDO 44 being double pumped and SDI 46 being single pumped. Not all of these bits are shown in FIG. 3.

FIG. 4 schematically illustrates the composition of a HDA frame. As indicated above, streams are transferred over HDA link 21 in a series of frames 50. In FIG. 4, frames 50 could either be outbound frames on SDO 44, or inbound frames on SDI 46.

The first breakout shows the composition of a frame 50. Frame 50 has three major components, a command/response field 52, one or more stream packets 54 and a null field 56 to fill out the frame.

Command/response field 52 is always the first field in a frame and is used for management of HDA link 21 and HDA codec 2. Each outbound frame on SDO 44 has a 40-bit command field. Each inbound stream on SDI 46 has a 36-bit response field. Both the command field in the outbound stream and the response field in the inbound stream contain a 32-bit verb/response structure, as explained later. The remaining eight command bits in the outbound frame and four bits in the inbound frame, are either reserved or special purpose bits. The format of the command/response fields is described in greater detail in relation to FIGS. 5 and 6.

Frame 50 contains a number of stream packets 54 (sometimes called stream payload), shown in FIG. 4 as packet A to packet X. A stream packet is the logical envelope in which data is transferred across HDA link 21. The number of packets in a frame is dependent upon the number of streams to be transmitted across the link, and is limited by the size of the frame i.e. 1000 output bits on SDO 44 and 500 input bits on SDI 46. All data in a single stream packet belongs to a single stream.

The remainder of the bits in frame 50 that are not used for command/response field 52 or for stream packets 54, form the null field 56 and are set to logical zeros. Codecs and controllers are required to always transmit all data for a given frame 50 contiguously (i.e. without gaps), starting with command/response field 52, followed by all stream packets 54 that are to be sent in that frame before transmitting any null field 56. A null field 56 is prohibited between stream packets, or command/response fields.

The second breakout in FIG. 4 shows the composition of one of the stream packets 54 in frame 50. Each stream packet consists of a stream tag 58 and a one or more sample blocks 60, sometimes referred to as the stream payload. In addition, an inbound stream packet may also include a null pad 62 that is used at the end of the sample block in order to make sample block 60 an integral byte length, if necessary.

The stream tag 58 is a label at the beginning of each stream packet 54 that provides an associated stream ID, which identifies the specific stream with which the subsequent sample block is associated. The stream tag format and method of transmission differ for inbound and outbound streams.

Outbound stream tags are 8-bits in length and are transmitted at a double pumped rate on SYNC 42. Outbound stream tags are transmitted on SYNC 42 so as to align with the last 8-bits of the preceding stream packet 54 or command field 52. An outbound stream tag comprises a 4-bit preamble followed by a 4-bit stream ID. Outbound stream tags are transmitted by HDA controller 20 on SYNC 42, whereas the outbound frames are transmitted on SDO 44. The stream packets associated with a given outbound stream tag are transmitted immediately following the end of the outbound stream tag.

Inbound stream tags are 10-bits in length and are transmitted at a single pumped rate on SDI 46, immediately preceding the associated inbound sample block, which is also transmitted on SDI 46. An inbound stream tag consists of a 4-bit stream ID, followed by a 6-bit data length field, which provides the length, in bytes, of all sample blocks within the given inbound stream packet. The stream packets associated with a given inbound stream tag are transmitted immediately following the end of the inbound stream tag.

The third breakout shows that each frame packet 54 can contain a number of sample blocks, shown as block A to block X in FIG. 4. The number of sample blocks present in each packet is determined by the sample rate of the stream. This is the same for both inbound and outbound streams.

In digital audio, all common sample rates are integral multiples (or submultiples) of one of two standard base rates of 48 kHz and 44.1 kHz. The base rate of 48 kHz can be derived by dividing the 24 MHz BCLK signal by 500. The base rate of 44.1 kHz can be derived as an exact 147/160 mathematical multiple of the 48 KHz base rate or as an exact 147/80,000 mathematical multiple of BCLK.

If the sample rate of a stream is twice the base rate i.e. 96 kHz, there will be two sample blocks in a packet. If sample rate of the stream is four times the base rate i.e. 192 kHz, there will be four sample blocks in the packet.

The fourth breakout of FIG. 4 shows the composition of a sample block 60. This is the same for both inbound and outbound streams. Sample block 60 contains a set of one or more samples 64, shown as sample A to sample X in FIG. 4. The number of samples in a sample block is equal to the number of channels in the stream. In other words, a stereo stream with a sample rate of 48 kHz, will have one sample block per frame and that sample block will have two samples, one for the left channel and one for the right channel. All samples within a sample block have the same length or sample size and have the same time reference or sample point. Samples are always transmitted with the most significant bit (MSB) 66 before the least significant bit (LSB) 68, as illustrated in the fifth breakout.

Consider the situation where FIG. 4 illustrates a series of outbound frames 50. An outbound frame starts and ends with the falling edge of successive frame sync markers transmitted on SYNC 42. The first 40 bits of an outbound frame are dedicated for the command field 52 and are used to send commands to HDA codec 2. HDA controller 20 transmits the stream tag 58 for the first outbound packet of the frame on SYNC 42 during the last eight bit times (4 BCLK cycles) of the command field 52. The sample blocks 60 of the first packet are transmitted on SDO 44 immediately following the command field 52. HDA controller 20 transmits stream packets 54 within the frame in a contiguous manner until all packets for that frame have been transmitted. A null field 56 is transmitted for the remaining bits within an outbound frame when the transmission of the stream packets completes before the end of the frame.

Consider the situation where FIG. 4 illustrates a series of inbound frames 50. An inbound frame starts and ends with the falling edge of successive frame sync markers transmitted on SYNC 42. The first 36 bits of an inbound frame are dedicated for the response field 52, which HDA codec 2 uses for sending responses to commands sent by HDA controller 20. HDA codec 2 transmits the first stream packet on SDI 46 immediately following the response field 52. HDA codec 2 transmits inbound packets in a contiguous manner until all packets for that frame have been transmitted.

A stream tag indicating a stream packet length of zero must immediately follow the last stream packet to be transmitted. Such a stream tag marks the completion of data transmission within that frame, and the remaining valid bit positions within the frame are set as the null field 56. This stream tag is called the termination tag, and is not shown in FIG. 4.

FIG. 5 illustrates the format of a 40-bit command field 70 of an outgoing stream on SDO 44. The first eight bits of command field 70 are reserved bits 72 and are transmitted as zeros. The next four bits contain a unique 4-bit codec address (CAd) 74 which is assigned to each codec connected on HDA link 21 during initialization and identifies the target codec. The following eight bits contain the node ID (MD) 76, which identifies a target “node” within the codec.

The concepts of “nodes” and “verbs” in HDA will now be explained. Nodes are logical units or functions in a HDA codec which the HDA controller is able to communicate with using verbs. The HDA codec architecture is arranged in a three level hierarchy, with a root node, function group nodes and widget nodes. The root node provides pointers to the function groups and there is a single root node in each codec attached to the HDA link. Each function group is a collection of directed purpose modules (widgets) all focused to a single application or purpose and that is controlled by a single software function driver. Each of the root node, function groups and widgets are uniquely addressable nodes and are assigned a unique node ID (NID). The concatenation of CAd and NID provides a unique address that allows commands to reference a single specific node within a particular HDA system.

The remaining 20 bits of the command field 70 shown in FIG. 5 are the verb bits 78. A verb in this context generally represents a command to write or read a register. The term “register” is used here in a broad sense to include any form of storage including flip/flops, latches and memories. There are two access types to a verb, a ‘set’ access and a ‘get’ access. The ‘set’ can be thought of as a write, the ‘get’ can be thought of as a read. There are two types or verb, read only and read/write capable.

SDO 44 contains a slot for a single verb (caries one verb envelope) in each frame. In the command field 70, there is no valid bit for verbs. An invalid verb is defined as all zeros sent to NID=0. In other words, if bits 27:0 are all zeros, the verb is invalid. Otherwise, the verb is a valid verb and requires an associated response.

FIG. 6 illustrates the format of a 36-bit response field of an incoming stream on SDI 46. The first bit of response field 80 is the valid bit 82. A 1 (one) in valid bit position 82 indicates that response field 80 contains a valid response, whereas a zero indicates that there is no response. The second bit of response field 80 is the unsolicited response (UnSol) bit 84, which indicates that the response is unsolicited (i.e. generated spontaneously by the codec) rather than in reply to a get verb request. A one in UnSol bit position is meaningful only when valid bit 82 is set indicating that the response is valid.

The next two bits of response field are reserved bits 86, and are transmitted as zeros. The final 32 bits of response field 80 are the response bits 88, which contain the associated response to a particular verb or unsolicited response payload.

Solicited responses are returned by HDA codec 2 in response to a command verb received from the HDA controller. Unsolicited responses are sent by HDA codec 2 independently of any request from the controller. Solicited responses are returned by HDA codec 2 in the subsequent frame, and in the same order that the prompting commands were sent to the codec. Unsolicited responses can be transmitted by HDA codec 2 in any frame where a solicited response is not present. In other words, an unsolicited response must wait for an empty response field before it can be transmitted.

FIG. 7 illustrates the format of an unsolicited response. When an unsolicited response is to be sent in response field 80, the first 6-bits of the response bits 88 form a tag field 90, which is used to indicate where the unsolicited response was generated from. The remaining 26 bits of response bits 88 are the payload 92 of the unsolicited response.

### SUMMARY OF INVENTION

As indicated above, an unsolicited response generated by the codec must wait for an empty response field before it can be transmitted to the controller. This causes the problem that there can be a significant delay between the source of an unsolicited response generating an unsolicited response and a free slot for transmission becoming available on the HDA link.

As there can be any number of unsolicited response sources in a system, and each of the sources can generate unsolicited responses at any time, multiple unsolicited responses can be generated simultaneously. As only one unsolicited response may be sent in any one free transmission slot, there may be multiple unsolicited responses awaiting transmission to the HDA controller. The HDA specification provides no definition for how unsolicited responses should be managed should more than one be awaiting transmission to the HDA controller.

It is therefore desirable to provide a codec with a mechanism for handling multiple unsolicited responses.

According to an aspect of the present invention, there is provided an audio device arranged for communication of data and signalling with a controller, signalling from the device to the controller being made in discrete time slots, the device comprising: a plurality of nodes, each assigned a priority value and each having one or more unsolicited response sources (status report sources) capable of generating an unsolicited response (status report) for transmission to the controller, wherein unsolicited responses (status reports) generated from a particular node are assigned the priority value of that node; and unsolicited response management means operable to hold unsolicited responses (status reports) generated by the plurality of nodes that are awaiting transmission to the controller, wherein when two or more unsolicited responses (status reports) are awaiting transmission to the controller in the unsolicited response management means, the device is arranged to transmit the unsolicited response (status report) with the highest assigned priority value first, in the next free time slot.

The above device is advantageous, as it allows unsolicited responses that may be triggered infrequently, but may require immediate transmission to the controller to be transmitted before other unsolicited responses that are awaiting transmission that do not have as high a transmission priority.

When more than one unsolicited response awaiting transmission in the unsolicited response management means have the same assigned priority value, the device may be arranged to transmit the unsolicited response that was generated first of the unsolicited responses with the same priority value, before transmitting other unsolicited responses with that same priority value.

The device may further comprise priority definition means by which the priority value for each node may be user defined. The priority definition means may be responsive to an instruction communicated via the controller.

Each node may be assigned a unique priority value.

The unsolicited response management means may be a virtual queue, which may be arranged to store unsolicited responses awaiting transmission and order them for transmission according to their assigned priority values. The virtual queue may be a fixed array which may contain an entry associated with every unsolicited response source. Each entry may comprise a trigger status value, a priority value and a trigger order value, wherein the trigger status value may indicate whether or not an unsolicited response has been generated from the particular unsolicited response source, the priority value may indicate the priority assigned to unsolicited responses generated from the particular unsolicited response source, and the trigger order value may indicate the order in which unsolicited responses held in the fixed array were generated.

The device may be arranged to calculate an entry value for of each entry in the fixed array by concatenating the trigger status value, the priority value and the trigger order value. The trigger status value may carry more weight in the calculation of the entry value than the priority value and the priority value may carry more weight in the calculation of the entry value than the trigger order value.

The entry in the table with the lowest value may be transmitted first, in the next free time slot. Alternatively, the entry in the table with the highest value may be transmitted first, in the next free time slot. The entry in the array with the lowest value or the highest value may be found using a search routine.

The fixed array may keep a record of the number of unsolicited responses held in the array. The trigger order value for each unsolicited response held in the fixed array is updated when an unsolicited response is sent to the controller.

The nodes may be responsive to a request from the controller to generate a solicited response, such solicited responses occupying some of said time slots.

The device may be compliant with a serial audio bus standard such as AC'97, SLIMbus or HDA. In particular, it may be an HDA codec for communication with an HDA controller via a HDA link providing said time slots with a capacity of one solicited or unsolicited response per time slot.

A HDA custom verb may be used to set, in the register of a particular node, the priority value for unsolicited responses generated from that node. By “custom verb” is meant a verb outside the standard verb set defined in the HDA specification.

According to another aspect of the present invention, there is provided a method of managing status reports transmitted from a device to a controller, comprising: defining sequential time slots each for transmission of one status report at a time from the device to the controller; assigning a respective priority value to each of a plurality of functional units of the device capable of autonomously generating a status report; temporarily storing each status report autonomously generated by said functional units prior to transmission to the controller; and when two or more status reports are awaiting transmission to the controller, transmitting the status report with the highest assigned priority value first, in the next available time slot.

The device in the above method may be a HDA codec, the controller may be an HDA controller, the time slots may be provided by an HDA link, and the autonomously generated status reports may be unsolicited responses of nodes of the HDA codec.

The HDA controller may request solicited responses from nodes of the HDA codec and the solicited responses may take precedence over the unsolicited responses for transmission in said time slots.

According to another aspect of the present invention, there is provided software for a device, the device arranged to transmit status reports one by one in discrete time slots to a controller, the software when executed by control logic of a device performing the functions of: assigning a respective priority value to each of a plurality of functional units of the device capable of autonomously generating a status report; temporarily storing each status report autonomously generated by said functional units prior to transmission to the controller; and when two or more autonomously generated status reports are awaiting transmission to the controller, transmitting the status report with the highest assigned priority value first, in the next available time slot.

A computer-readable medium is also provided on which is recorded the software of the above aspect.

An electronic apparatus is provided that includes the device defined above. The electronic apparatus may be in the form of a portable computer, including a mobile internet device (MID). The electronic apparatus may be in the form of an audio system. The electronic apparatus may be in the form of a mobile telephone, or personal media player or multifunction device combining these functions. The electronic apparatus may be in the form of an audio or multimedia hub.

As indicated above, an unsolicited response generated by the codec must wait for an empty response field before it can be transmitted to the controller. This causes the problem that there can be a significant delay between the source of an unsolicited response generating an unsolicited response and a free slot for transmission becoming available on the HDA link.

There arises a situation in which an unsolicited response may be generated by an unsolicited response source in the codec and which may not be transmitted before the status of that unsolicited response source has changed. In this case, the unsolicited response that is awaiting transmission to the controller may be no longer valid and will therefore provide the controller with out of date information when it is transmitted. In this case, the codec must then subsequently transmit the current status information to the controller in another unsolicited response. This decreases the bandwidth available on the HDA link for signalling other unsolicited response data from the codec to the controller as multiple unsolicited responses are then required to ensure the controller has the most up-to-date unsolicited response data.

The HDA specification provides no definition for how unsolicited response payload content should be managed should the status of the source of the unsolicited response change between generation and transmission of the unsolicited response.

It is therefore desirable to provide a codec with a mechanism for managing the payload content of unsolicited responses should the status of the source of the unsolicited response change between generation and transmission of the unsolicited response.

According to an aspect of the present invention, there is provided an audio device operable for transmission and reception of audio data and control signals to and from a controller, control signals including status reports from the device being restricted to predetermined transmission timings, the device comprising: a plurality of nodes, each having one or more reporting sources capable of generating a status report for transmission to the controller; status report management means operable to hold status reports generated by the plurality of nodes that are awaiting transmission to the controller pending a next available transmission timing; and updating means, responsive to generation of a second status report by the one or more reporting sources of a particular node at a time when a first status report also generated by the one or more reporting sources of that particular node is being held in the status report management means, to update the first status report held in the status report management means prior to transmission based on the second status report.

The updating means may combine the first and second status reports to form a single status report for transmission to the controller, whereby irrespective of the number of status reports generated up to the next available transmission timing by a particular node, only a single status report may be transmitted to the controller.

Each status report may have a payload and the updating means may be arranged to update the payload of the first status report with the second status report.

The first and second status reports may be generated from the same reporting source in the particular node, the updating means may be arranged to update the payload of the first status report to reflect the new status of said reporting source indicated in the second status report.

The first status report may be generated from a first reporting source in the particular node and the second status report may be generated from a second reporting source in the particular node, the updating means may be arranged to update the payload of the first status report to include both the status of the first reporting source and the status of the second reporting source indicated in the second status report.

The status reports may include solicited reports in response to a request from the controller and unsolicited reports generated autonomously by the reporting sources, said status report management means may be arranged to hold at least the unsolicited reports.

A priority value may be assigned to status reports generated from each of the plurality of nodes based on at least the identity of the node containing the reporting source concerned, and the device may be arranged to transmit the status report with the highest assigned priority value first at the next available transmission timing.

When more than one status report awaiting transmission in the status report management means have the same assigned priority value, the device may be arranged to transmit the status report that was generated first of the status reports with the same priority value, before transmitting other status reports with that same priority value.

The status report management means may be arranged to store, for each status report, a trigger status value, a priority value and a trigger order value, wherein the trigger status value indicates whether or not a status report has been generated from the particular reporting source, the priority value indicates the priority assigned to status reports generated from the particular reporting source, and the trigger order value indicates the order in which status reports held in the fixed array were generated.

The device may be compliant with a serial audio bus standard such as AC'97, SLIMbus or HDA. In particular, it may be an HDA codec for communication with an HDA controller via a HDA link, the HDA link performing said communication in units of HDA frames defining said predetermined timings such that one solicited or unsolicited report per HDA frame may be transmitted from the HDA codec to the HDA controller.

According to another aspect of the present invention, there is provided a method of managing status reports transmitted from an audio device to a controller, comprising: defining a sequence of discrete timings each allowing transmission of one status report at a time from the device to the controller; generating, from one or more reporting sources of any of a plurality of functional units of the device, status reports for transmission to the controller; pending a next available transmission timing, holding status reports generated by the plurality of functional units that are awaiting transmission to the controller; updating, in response to generation of a second or further status report by the one or more reporting sources of a particular node at a time when a first status report also generated by the one or more reporting sources of that particular node is being held, the first status report based on the second or further status report; and transmitting the updated first status report to the controller at the next available transmission timing.

The device in the above method may be compliant with a serial audio bus standard such as AC'97, SLIMbus or HDA. In particular, it may be a HDA codec having nodes as said functional units, the controller may be an HDA controller, the transmission timings may be response slots provided one per HDA frame carried by an HDA link, and the status reports may be unsolicited responses of nodes of the HDA codec.

The HDA controller may request solicited responses from nodes of the HDA codec, the transmitting step comprising waiting for a said transmission timing which is not occupied by any solicited response before transmitting the updated first status report.

According to another aspect of the present invention there is provided software for an audio device, the device arranged to transmit status reports one by one at discrete transmission timings to a controller, the software when executed by control logic of a device performing the functions of: generating, from one or more reporting sources of any of a plurality of functional units of the device, status reports for transmission to the controller; pending a next available transmission timing, holding status reports generated by the plurality of functional units that are awaiting transmission to the controller; updating, in response to generation of a second or further status report by the one or more reporting sources of a particular node at a time when a first status report also generated by the one or more reporting sources of that particular node is being held, the first status report based on the second or further status report; and transmitting the updated status report to the controller at the next available transmission timing.

A computer-readable medium is also provided on which is recorded the software of the above aspect.

An electronic apparatus is provided that includes the device detailed above. The electronic apparatus may be in the form of a portable computer including a mobile internet device (MID), an audio system, mobile telephone, personal media player or audio hub.

Although unsolicited responses are defined in the HDA specification as having a tag and a payload, The HDA specification offers no definition of the payload content of an unsolicited response.

It is therefore desirable to provide a defined structure for the payload content of an unsolicited response.

According to an aspect of the present invention, there is provided a HDA codec for communication with a HDA controller via a HDA link, comprising: a plurality of unsolicited response sources, each capable of generating an unsolicited response for transmission to the HDA controller, the HDA codec arranged to provide each unsolicited response with a tag for identifying to the HDA controller the unsolicited response source from which the unsolicited response was generated, and a payload, and further arranged to insert in the payload at least one unsolicited response flag for informing the HDA controller about a status change of the unsolicited response source.

This present invention provides the advantage of providing the HDA controller with as much information about the current status of the unsolicited response source in the unsolicited response generated from that source. This avoids the need for subsequent reads of the codec verbs to establish the current status of the unsolicited response source which generated the unsolicited response.

The unsolicited response flag may be an unsolicited response status flag capable of indicating any one of a plurality of unsolicited response states and the unsolicited response status flag may be two bits wide, indicating four unsolicited response states.

A first unsolicited response state capable of being indicated by the unsolicited response status flag may be that no change in status of the unsolicited response source has occurred.

A second unsolicited response state capable of being indicated by the unsolicited response status flag may be a state in which the status of the unsolicited response source has changed from a first status to a second status.

A third unsolicited response state capable of being indicated by the unsolicited response status flag may be a state in which the status of the unsolicited response source has changed from a second status to a first status. The first state may be a low state and the second state may be a high state.

A fourth unsolicited response state capable of being indicated by the unsolicited response status flag may be a state in which the status of the unsolicited response source has changed multiple times.

The unsolicited response status flag need not include an indication of the new status of the unsolicited response source, the HDA codec being arranged to indicate said new status by setting a status verb of the unsolicited response source.

The unsolicited response flag may be an unsolicited response update flag indicating that the status of the unsolicited response source has been updated.

The unsolicited response update flag may comprise a single bit which indicates to the HDA controller that one or more changes to the status of the unsolicited response source have occurred and that the HDA controller must read the status register of the unsolicited response source to determine the current status of the unsolicited response source.

The unsolicited response flag may be an unsolicited response event flag for indicating occurrence of an event with respect to the unsolicited response source.

The unsolicited response event flag comprises a single bit which indicates to the HDA controller that an event has occurred at the unsolicited response source that will cause an unsolicited response to be generated.

The payload may comprise a plurality of said unsolicited response flags.

The plurality of unsolicited response flags may consist of any combination of one, more than one or none of unsolicited response status flags, unsolicited response update flags and unsolicited response event flags.

According to another aspect of the present invention, there is provided a communication protocol for use between a HDA codec and a HDA controller communicating via a HDA link, the HDA codec having a plurality of unsolicited response sources each capable of generating an unsolicited response for transmission to the HDA controller, the protocol comprising providing each unsolicited response with a tag for identifying to the HDA controller the unsolicited response source from which the unsolicited response was generated, and a payload, and inserting in the payload an unsolicited response flag for informing the HDA controller about any change of status of the unsolicited response source.

According to another aspect of the present invention, there is provided a method of communicating status changes from an HDA codec to a HDA controller via a HDA link, comprising: providing in the HDA codec a plurality of unsolicited response sources, each capable of generating an unsolicited response for transmission to the HDA controller, providing each unsolicited response with a tag for identifying to the HDA controller the unsolicited response source from which the unsolicited response was generated, and a payload, inserting in the payload an unsolicited response flag for indicating to the HDA controller whether the status of the unsolicited response source has changed.

According to another aspect of the present invention, there is provided software for a codec, the codec managed by a controller and having a plurality of unsolicited response sources each capable of generating an unsolicited response for transmission to the controller, the software when executed by control logic of the codec performing the functions of: providing each unsolicited response with a tag for identifying to the controller the unsolicited response source from which the unsolicited response was generated, and a payload, and inserting in the payload an unsolicited response flag for indicating to the controller whether the status of the unsolicited response source has changed.

A computer-readable medium is also provided on which is recorded the software of the above aspect.

An electronic apparatus is provided that includes the HDA codec detailed earlier. The electronic apparatus may be in the form of a portable computer, including a mobile internet device, audio system, mobile telephone, personal media player, multifunction device combining these functions or an audio hub.

The SDI and SDO data lines of the HDA link between a HDA codec and a HDA controller are used to serially transfer digital audio data between the codec and the controller. The data on the SDI and SDO data lines are clocked by the BCLK pulse that is generated by the HDA controller. The data on SDI, that is data from the HDA codec that is incoming to the HDA controller, is single pumped i.e. is only transmitted on a single edge of the BCLK signal. The data on SDO, that is data that is outbound from the HDA controller to the HDA codec, is double pumped i.e. is transmitted on the rising and falling edges of the BCLK signal. Both the SDI and SDO data lines therefore have a maximum data bit rate and hence bandwidth, which is proportional to the rate of the BCLK signal. The SDO data line has twice the bandwidth of the SDI data line. The HDA controller can transmit 1000 bits per HDA frame to the HDA codec and the HDA codec can transmit 500 bits per frame to the HDA controller.

As both the HDA codec and the HDA controller are capable of rendering many audio streams simultaneously, there is a possibility that in any given HDA frame, there may be too much data that is ready to be transmitted. This is called an oversubscription.

Depending on the configuration of the codec, i.e. the number of nodes in the codec and the capabilities of those nodes, it is possible that the SDO data line may be oversubscribed if all streams are active at their maximum sample rate and maximum data word width. As stated in the HDA specification, it is the responsibility of the HDA controller to actively detect any oversubscription that may occur on the SDO data line and autonomously terminate (drop) streams that are to be sent to the HDA codec to actively manage utilisation of the SDO data line. In other words, the HDA controller must deal with the oversubscription and determine what data streams are output on the SDO data line during any oversubscription.

The HDA specification also states that it is necessary for the HDA codec to actively detect oversubscription that may occur on the SDI line and autonomously terminate streams that are to be sent to the HDA controller to actively manage utilisation of the SDI data line.

However, the HDA specification does not provide any implementation details as to how oversubscription is dealt with on the SDI data line.

It is therefore desirable to provide a HDA codec that can effectively deal with oversubscription on the SDI data line.

It is also desirable to provide a HDA codec that can effectively deal with an error condition on the SDO data line caused, for example, by the HDA controller attempting to push too much data onto the line.

According to an aspect of the present invention, there is provided a HDA codec arranged to transmit a plurality of data streams to a HDA controller via successive inbound frames of a HDA link, comprising: stream oversubscription monitoring means arranged to monitor the sample rate and sample size of the plurality of streams in order to detect whether an oversubscription is likely to occur with respect to a next frame; and unsolicited response generating means for transmitting an unsolicited response to the HDA controller in the event that an oversubscription is likely occur.

According to another aspect of the present invention, there is provided a HDA codec arranged to transmit a plurality of data streams to a HDA controller via successive inbound frames of a HDA link, comprising: stream oversubscription monitoring means arranged to monitor the sample rate and sample size of the plurality of streams in order to detect whether an oversubscription will occur with respect to a next frame; and stream termination means arranged to terminate at least one of the streams to be transmitted in the next frame in the event of an oversubscription.

The stream oversubscription monitoring means may be arranged to detect oversubscription by determining whether a total number of bits, required in the next frame by the plurality of streams, exceeds an available number of bits available in the frame.

When at least one of the data streams may only include a sample every n frames, the stream oversubscription monitoring means may be arranged to assume that the sample will be present in the next frame when determining whether a total number of bits required in the next frame by the plurality of streams, exceeds an available number of bits available in the frame.

Each of the plurality of streams may be assigned a stream ID. Each stream ID may be assigned logically (in numerical order).

When the stream oversubscription monitoring means detects that an oversubscription has occurred, the stream or streams with highest stream ID may be terminated. Since stream IDs are arranged in numerical order, this will normally result in terminating the stream which was most recently started.

Alternatively, when the stream oversubscription monitoring means detects that an oversubscription has occurred, the stream or streams with lowest stream ID may be terminated.

Each of said plurality of data streams may be associated with one of a plurality of converter nodes of the HDA codec, and the converter node whose stream has been terminated may be arranged to generate the unsolicited response for transmission to the HDA controller.

The stream termination means may be arranged to restore to the next frame a stream that has previously been terminated, upon detecting of a non-zero stream ID issued by the HDA controller.

The stream termination means may be arranged to restore a terminated stream only when the stream oversubscription monitoring means detects that no oversubscription will be caused thereby.

When the oversubscription monitoring means detects that an oversubscription will be caused by restoring the terminated stream, the terminated stream may not be restored and this may be notified by sending an unsolicited response to the HDA controller.

The stream oversubscription monitoring means may comprise a state machine that incorporates a look-up-table, the state machine arranged to step through the plurality of streams and calculate a running total of the required number of bits to transmit the plurality of streams.

The look-up-table may include an entry for every possible stream configuration defined under HDA.

After the state machine has stepped through the plurality of streams and the stream termination means has terminated at least one of the streams, the state machine may be arranged to repeat the calculation with the terminated streams omitted, to determine if it is necessary for another stream to be terminated.

The calculation may be performed at the start of each HDA frame, within a response phase thereof.

According to another aspect of the present invention, there is provided a HDA codec arranged to receive a plurality of data streams, each associated with one of a plurality of converter nodes having a defined configuration, from a HDA controller via an SDO signal on a HDA link, comprising: stream error monitoring means for monitoring the sample rate and sample size of the received streams, wherein the HDA codec is arranged to generate an unsolicited response for transmission to the HDA controller, when the stream error monitoring means detects a discrepancy between the configuration of any of the plurality of converter nodes and the data presented to them from the SDO signal.

According to another aspect of the present invention, there is provided a method of detecting oversubscription of an SDI signal generated from a plurality of streams by a HDA codec, comprising the steps of: stepping through the plurality of streams to calculate a running total of the required bandwidth and determining if a maximum bandwidth is exceeded; if the maximum bandwidth is not exceeded, transmitting all enabled streams in the SDI signal; if the maximum bandwidth is exceeded, determining a stream to be terminated from transmission; and repeating the running total calculation with the terminated stream omitted to determine if another stream needs to be terminated.

Each stream in the codec may be assigned a stream ID and said determining step may be performed on the basis of the stream IDs.

According to another aspect of the present invention, there is provided software for a HDA codec, the codec having a plurality of streams each with a stream ID, to be transmitted to a HDA controller, the software when executed by control logic of the codec performing the functions of: adding a bandwidth requirement for each of the streams in succession to calculate a running total of the required bandwidth to determine if an available maximum bandwidth is exceeded; if the maximum bandwidth is not exceeded, transmitting all enabled streams to the HDA controller; if the maximum bandwidth is exceeded, determining a stream to be terminated on the basis of stream ID; and repeating the adding function with the terminated stream omitted to determine if another stream needs to be terminated.

A computer-readable medium is also provided on which is recorded the software of the above aspect.

An electronic apparatus is provided that includes the HDA codec detailed earlier. The electronic apparatus may be in the form of a portable computer, including a mobile internet device, audio system, mobile telephone, personal media player, multifunction device combining these functions or an audio hub.

When arranging streams for transmission over a serial link, there is an issue of how to order the streams within each transmission period (e.g. frame). In HDA for example, the HDA specification is silent on which order inbound streams should be sent on the SDI data line to the HDA controller.

It is therefore desirable to provide a device such as an HDA codec or SLIMbus Component that addresses the above drawback.

According to an aspect of the present invention, there is provided an audio device arranged to transmit a plurality of data streams over a serial link to a controller, each of the plurality of data streams associated with a stream source and assigned a respective stream identification value, the transmission being controlled based on a clock signal, the device comprising: stream enable detection means arranged to determine which of the plurality of streams are enabled and ready for transmission to the controller; a counter arranged to increment a count value at each cycle of the clock signal; and stream ordering means arranged to compare at each incremented count value, the current count value with the stream identification value for each enabled stream, wherein the stream ordering means is arranged, when the current count value matches the stream identification value of a stream, to record the stream source associated with that stream in a transmission sequence.

The counter may be arranged to increment the count value for a predetermined number of cycles of the clock signal and to reset the count value when the predetermined number of cycles of the clock signal have completed.

The device may further comprise storage means for storing the transmission sequence and transmission means for transmitting the plurality of data streams to the controller, the transmission means arranged to refer to the stored transmission sequence to determine the next stream to be transmitted.

The transmission means may be arranged to transmit the streams in a plurality of sequential frames.

The stream enable detection means may be arranged to determine in every frame whether or not each stream is enabled in accordance with whether or not the stream has available data ready to be sent to the controller, and the transmission means may be arranged to transmit each enabled stream once per frame in the order in which it is recorded in the transmission sequence.

The streams may be digital audio streams and whether or not each stream has available data in a given frame may be dependent upon a sample size, sample rate and/or number of channels in the stream.

The storage means may be a stream order matrix which is updated at each clock cycle to include the results of the comparison for each incremented count value, such that after the predetermined number of cycles have completed, the stream order matrix stores the stream sources associated with the plurality of streams in ascending order of stream identification values.

The device may be compliant with a serial audio bus standard such as AC'97, SLIMbus or HDA. In particular, it may be a HDA codec for communication with a HDA controller via a HDA link. In this case, the clock signal is the base clock signal generated by the HDA controller and used by the codec.

According to another aspect of the present invention, there is provided a method of ordering a plurality of digital audio data streams for transmission over a serial link, each of the plurality of data streams associated with a stream source and assigned a unique stream identification value, the transmission being controlled based on a clock signal, the method comprising the steps of: determining which of the plurality of streams are enabled and ready for transmission over the serial link; incrementing a count value at each cycle of the clock signal; comparing, at each incremented count value, the current count value with the stream identification value for each enabled stream; and wherein when the current count value matches the stream identification value of a stream, noting the stream source associated with that stream in a transmission sequence.

The digital audio data streams may be transmitted from a device to a controller and may vary in respect of their sample sizes, sample rates and/or numbers of audio channels.

The device may be compliant with a serial audio bus standard such as AC'97, SLIMbus or HDA. In particular, it may be a HDA codec, the controller may be a HDA controller and the transmission of streams may occur via a HDA link; in this case the transmission sequence may determine the ordering of the streams in each HDA frame transmitted to the controller via the HDA link.

The ordering may be repeated at the start of every HDA frame.

According to another aspect of the present invention, there is provided software for an audio device, the device arranged to transmit a plurality of data streams to a controller, each of the plurality of data streams associated with a stream source and assigned a respective stream identification value, the transmission being made sequentially on a frame-by-frame basis and controlled based on a clock signal, the software when executed by control logic of the device performing the functions of, in each frame: determining which of the plurality of streams are enabled and ready for transmission to the controller; incrementing a count value at each cycle of the clock signal; comparing, at each incremented count value, the current count value with the stream identification value for each enabled stream; and when the current count value matches the stream identification value of a stream, recording the stream source associated with that stream in a storage means to set the order of transmission of the streams in the frame.

A computer-readable medium is also provided on which is recorded the software of the above aspect.

An electronic apparatus is provided that includes the device defined above. The electronic apparatus may be in the form of a portable computer, mobile internet device, audio system, mobile telephone, personal media player, multifunction device combining these functions and/or audio hub.

When combining a number of streams for transmission over a serial link, serialisation is another issue. The HDA specification specifies that streams to be sent over the SDI data line should be serialised and sent one after the other, with no gaps in between. In each HDA frame, the sample block size for each stream can be different and is dependent on the sample rate, the sample size, the number of channels and whether extra source synchronous data is being sent (S/PDIF). The HDA specification provides no solution to the problem of serialising data to be sent over the SDI data line.

It is therefore desirable to provide an implementation to serialise data for transmission on a serial link such as the SDI of HDA.

According to an aspect of the present invention, there is provided an audio device arranged to transmit a plurality of data streams via a serial link to a controller, each stream associated with a stream source and assigned a stream identification value, the transmission being made in units of sample blocks each containing one or more samples of a stream, and controlled based on a clock cycle, the device comprising: stream ordering means arranged to set an order for transmission of the plurality of streams according to their stream identification values so as to allow one of the streams to be determined as a current stream; sample size determination means arranged to determine the sample size of samples in the current stream; sample number determination means arranged to determine the number of samples per sample block in the current stream; data serializing means arranged to serialize data for transmission by requesting a next sample from the associated stream source of the current stream until reaching the number of samples in the sample block and then referring to the stream ordering means to determine the next stream in said order as the current stream; and transmission means arranged to transmit, at each clock cycle, successive bits of data serialized by the data serializing means.

The data serialising means may comprise: a shift register arranged to output bits for transmission one by one at each clock cycle from a transmission end thereof, the shift register loaded with samples justified at the transmission end of the shift register and shifting the samples along the shift register one bit every cycle, such that one bit is outputted from the shift register every clock cycle for transmission to the controller; and a cycle counter arranged to count the number of clock cycles; and a sample counter arrange to count the number of samples reached in the sample block, wherein when the clock cycle count number equals the sample size determined for the current stream by the sample size determination means, if the sample count has not yet reached the number of samples in the sample block, the serialising means requests the next sample from the associated stream source of the current stream to reload the shift register, and if the sample count has reached the number of samples in the sample block, the serialising means requests a sample from the associated stream source of the next stream in said order.

The sample size determination means may be a look up table. The sample number determination means may be a calculating means arranged to receive an indication of sample rate and number of channels from the stream source.

The stream ordering means may be the stream ordering means as defined in the device defined above.

The shift register may be arranged to store streams always left justified, with the left most bit containing valid data, in which case the shift register is arranged to shift the streams along the shift register to the left, one bit every cycle of the clock signal, with the left most bit being output from the shift register.

The device may be compliant with a serial audio bus standard such as AC'97, SLIMbus or HDA. In particular, it may be a HDA codec for communication with a HDA controller via a HDA link as said serial link, the clock signal being a bit clock signal (BCLK) generated by the HDA controller.

According to another aspect of the present invention, there is provided a method of serialising a plurality of sampled data streams for transmission at successive clock cycles, each of the data streams associated with a stream source and assigned a stream identification value, the method comprising the steps of: ordering the plurality of streams according to their stream identification values; obtaining a sample size and a number of samples per sample block of each of the plurality of data streams; determining a current stream to be serialised based on the ordering found in said ordering step; serialising samples from the associated stream source of the current stream until reaching the number of samples in the sample block and then returning to the determining step to determine the next stream in order as the current stream; and transmitting, at each clock cycle, successive bits of data so serialised.

The serialising step may comprise: storing the sample in a shift register with the stream justified at a transmission end of a shift register, and shifting the stream along the shift register one bit every cycle of the clock signal, such that one bit is outputted from the shift register every clock cycle for transmission; and counting the number of clock cycles, and when the clock cycle count number equals the determined sample size, requesting the next sample from the associated stream source.

The method when performed by a HDA codec may be for transmission of streams via a HDA link to an HDA controller.

According to another aspect of the present invention, there is provided software for a programmable audio device, the device arranged to transmit a plurality of data streams containing blocks of audio samples to a controller, each of the plurality of data streams associated with a stream source and assigned a stream identification value, the transmission being controlled based on a clock cycle, the software comprising program code means which, when executed by control logic of the device, performs the functions of: ordering the plurality of streams according to their stream identification values; obtaining a sample size and a number of samples per sample block of each of the plurality of data streams; determining a current stream to be serialised based on the ordering found in said ordering step; serialising samples from the associated stream source of the current stream until reaching the number of samples in the sample block and then returning to the determining step to determine the next stream in order as the current stream; and transmitting, at each clock cycle, successive bits of data serialised by the serialising function.

A computer-readable medium is also provided on which is recorded the software of the above aspect.

An electronic apparatus is provided that includes the device defined earlier. The electronic apparatus may be in the form of a portable computer, mobile internet device, audio system, mobile telephone, personal media player, multifunction device combining these functions and/or audio hub.

When receiving streams over a serial link, there is an issue of how to process streams as they arrive. In HDA for example, the HDA specification is silent on how received streams should be processed once they are received. Streams of different sizes must be processed one after another as they arrive, they can be transmitted in any order and there are no gaps between the streams (i.e. as soon as one ends, the next will start).

It is therefore desirable to provide an implementation that can process streams addressing the above problems.

According to an aspect of the present invention, there is provided a device arranged to receive a serial data signal transmitted from an external controller, the serial data signal formed of a sequence of streams of unknown order, each of the streams assigned a stream identification value by the controller, comprising: recording means arranged to receive notification from the controller of the stream identification values of the streams contained in the serial data signal and to record said stream identification values; comparison means arranged to compare the stream identification value of each incoming stream as it is received in the serial data signal, with the recorded stream identification values; a selector arranged to select stream format settings for the incoming stream when the comparison means determines that the stream identification value of the incoming stream matches a recorded stream identification value; and a deserialiser arranged to deserialise the streams into samples on the basis of the selected stream format settings.

The stream format settings may comprise the number of bits per sample.

The serial data signal may be transmitted in units of frames, in which case the stream format settings further comprise a number of samples of the stream during each frame.

The device may further comprise a look-up table for storing the stream format settings in association with each of the notified stream identification values, wherein the selector is arranged to select the stream format settings from the look up table.

The streams may be arranged in one contiguous sequence in the serial data signal and the selector is arranged instantly to reconfigure the deserialiser when the comparison means determines a change in the stream identification value.

The device may further comprise means for marking the deserialised samples as valid when the stream identification value of the stream matches a recorded stream identification value.

The streams may be digital audio streams and the samples may be audio samples.

The device may be compliant with a serial audio bus standard such as AC'97, SLIMbus or HDA. In particular, it may be a HDA codec and the controller may be a HDA controller, the serial data signal being a SDO signal from the HDA controller.

According to an aspect of the present invention, there is provided a method of receiving a serial data signal formed of a sequence of digital audio streams of unknown order, each of the streams assigned a stream identification value, the method comprising the steps of: receiving notification of the stream identification values of the streams contained in the serial data signal and recording said stream identification values; comparing the stream identification value of each incoming stream as it is received in the serial data signal, with the recorded stream identification values; selecting stream format settings for the incoming stream on the basis of its stream identification value when the comparison means determines that the stream identification value of the incoming stream matches a recorded stream identification value; and deserialising the streams into samples on the basis of the selected stream format settings.

According to another aspect of the present invention, there is provided software for a device, the device arranged to receive a serial data signal formed of a sequence of digital audio streams of unknown order, each of the streams assigned a stream identification value, the software when executed by control logic of the device performing the functions of: receiving notification of the stream identification values of the streams contained in the serial data signal and recording said stream identification values; comparing the stream identification value of each incoming stream as it is received in the serial data signal, with the recorded stream identification values; selecting stream format settings for the incoming stream on the basis of its stream identification value when the comparison means determines that the stream identification value of the incoming stream matches a recorded stream identification value; and deserialising the streams into samples on the basis of the selected stream format settings.

A computer-readable medium is also provided on which is recorded the software of the above aspect.

An electronic apparatus is provided that includes the device defined above. The electronic apparatus may be in the form of a portable computer, mobile internet device, audio system, mobile telephone, personal media player, multifunction device combining these functions and/or audio hub.

According to another aspect of the present invention, there is provided a device arranged to receive a serial data signal formed of a sequence of digital audio streams, each stream having a stream format which may vary between the streams, and wherein the serial data signal defines a bit on every falling and rising edge of a clock cycle, the device comprising: stream format determination means arranged to determine the stream format of each incoming stream as it is received in the serial data signal; and a deserialiser arranged to deserialise the incoming stream into one or more individual samples, comprising a double pumped deserialisation means clocked using said clock cycle to output a pair of bits per clock cycle and a variable sample size deserialisation means to assemble the pairs of bits into samples based on the determined stream format.

The stream format may comprise the number of bits per sample, a number of channels and the sample rate of the stream.

Each stream may contain a sample block comprising at least one sample and the stream format further comprises a number of samples per sample block.

The device may further comprise a sample counter for counting a number of samples assembled from the incoming stream and comparing the counted number of samples with the number of samples per sample block to determine when all samples of the incoming stream have been received.

The variable sample size deserialisation means may be arranged to record the pairs of bits output from the double pumped deserialisation means in a shift register with a variable input point, the position of which depends of the number of bits per sample of the stream, the data in the shift register being shifted by two positions at every clock cycle to allow a complete sample to be assembled.

The device may further comprise a shift counter arranged to count the number of shifts of the data in the shift register, and to determine that a complete sample is assembled when the shift count equals half the bits per sample value determined by the sample format determination means.

The device may further comprise reading means for reading the complete sample in parallel from the shift register. The reading means may be responsive to a notification from the deserialiser that all bits of the sample are present and the output sample is valid.

The device may further comprise means for outputting outside the device a notification from the deserialiser that a sample is not valid.

The or each counter may be arranged to reset when a new stream is received.

The device may be compliant with a serial audio bus standard such as AC'97, SLIMbus or HDA. In particular, it may be a HDA codec connected to a HDA controller, the serial data stream may be received over a HDA bus from the HDA controller, and the clock cycle may be a clock cycle of the base clock (BCLK) received over the HDA bus.

According to another aspect of the present invention, there is provided a method of deserialising, at a device, a serial data signal formed of a sequence of digital audio streams, each stream having a stream format which may vary between the streams, and wherein the serial data signal defines a bit on every falling and rising edge of a clock cycle, the method comprising: starting to receive the serial data signal at the device; determining the stream format of each incoming stream as it is received in the serial data signal; deserialising the incoming stream into one or more individual samples, by a first deserialisation stage clocked using said clock cycle to output a pair of bits per clock cycle and a second deserialisation stage to assemble the pairs of bits into samples based on the determined stream format; and upon completion of deserialising the one or more samples of the stream, repeating the determining step for the next stream in the sequence.

According to another aspect of the present invention, there is provided software for a device, the device arranged to receive a serial data signal formed of a sequence of digital audio streams, each stream having a stream format which may vary between the streams, and wherein the serial data signal defines a bit on every falling and rising edge of a clock cycle, the software when executed by control logic of the device performing the functions of: starting to receive the serial data signal at the device; determining the stream format of each incoming stream as it is received in the serial data signal; deserialising the incoming stream into one or more individual samples, by a first deserialisation stage clocked using said clock cycle to output a pair of bits per clock cycle and a second deserialisation stage to assemble the pairs of bits into samples based on the determined stream format; and upon completion of deserialising the one or more samples of the stream, repeating the determining step for the next stream in the sequence.

A computer-readable medium is also provided on which is recorded the software of the above aspect.

An electronic apparatus is provided that includes the device defined earlier. The electronic apparatus may be in the form of a portable computer, mobile internet device, audio system, mobile telephone, personal media player, multifunction device combining these functions and/or audio hub.

According to another aspect of the present invention, there is provided a device arranged to receive from an external source a serial data signal formed of a sequence of digital audio streams, each stream having a stream format which may vary between the streams, the device comprising: deserialisation means arranged to deserialise each incoming stream into one or more samples; a buffer for receiving a sample from the deserialisation means; and error determining means, coupled to the deserialising means and the buffer to detect an error in the sample and transmit a report to the external source when the error determining means detects an error.

The deserialising means may notify the error determining means when the current sample is not validly deserialised before the deserialisation of the next sample begins.

A current sample may not be validly deserialised when the number of deserialised data bits is not equal to the expected number of bits in the sample.

The deserialisation means may be the deserialiser of the defined above.

The buffer may notify the error determining means when the it underflows or overflows upon receipt of the sample from the deserialising means.

The device may be compliant with a serial audio bus standard such as AC'97, SLIMbus or HDA. In particular, it may be a HDA codec, the external source may be a HDA controller, the serial data signal may be an SDI signal carried on a HDA bus, the clock cycle may be a clock cycle of a HDA bit clock (BCLK) carried on the HDA bus, and the report transmitted to the external source may be an unsolicited response contained in an SDI signal on the HDA bus.

According to another aspect of the present invention, there is provided a method of detecting errors in deserialisation of a serial data signal received from an external source and formed of a sequence of digital audio streams, each stream having a stream format which may vary between the streams, the method comprising steps of: determining the stream format of each incoming stream as it is received in the serial data signal; deserialising each incoming stream into one or more samples in accordance with its determined stream format; buffering samples from the deserialisation means; and detecting an error in the deserialising and/or buffering steps and transmitting a report to the external source upon detecting an error.

The method may further comprise the external source responding to the report by reconfiguring the stream for subsequent deserialisation.

According to another aspect of the present invention, there is provided software for a device, the device arranged to receive a serial data signal received from an external source and formed of a sequence of digital audio streams, each stream having a stream format which may vary between the streams, the software when executed by control logic of the device performing the functions of: determining the stream format of each incoming stream as it is received in the serial data signal; deserialising each incoming stream into one or more samples in accordance with its determined stream format; buffering samples from the deserialisation means; and detecting an error in the deserialising and/or buffering steps and transmitting a report to the external source upon detecting an error.

A computer-readable medium is also provided on which is recorded the software of the above aspect.

An electronic apparatus is provided that includes the device of defined above. The electronic apparatus may be in the form of a portable computer, mobile internet device, audio system, mobile telephone, personal media player, multifunction device combining these functions and/or audio hub.

S/PDIF is a digital audio transmission format, which allows digital audio data and clocking information to be sent between devices. The format is point-to-point and a typical implementation consists of a S/PDIF transmitter and a S/PDIF receiver.

In any digital audio system where S/PDIF digital audio streams are used, the S/PDIF receiver has no control over the sample rate of the recovered S/PDIF receiver data stream. The sample rate is governed by the external system, which generates, encodes and transmits the S/PDIF stream via its S/PDIF transmitter.

In view of this, a S/PDIF receiver must track the sample rate of the incident S/PDIF stream and must recover the clock and data from the incident stream.

In a typical S/PIDF receiver, a lock flag is provided which indicates the S/PDIF receiver confidence in the accuracy of the recovered clock and data. An unlock condition is typically flagged when the recovered clocks or data are determined not to match the clocks and data encoded in the incident S/PDIF stream.

However, there is an issue in that the conventional lock flag may not accurately indicate that the recovered clocks or data match the clocks and data encoded in the incident S/PDIF stream.

It is therefore desirable to provide an improved lock flag.

According to an aspect of the preset invention, there is provided an audio processor for processing at least one S/PDIF audio stream and managed by an external controller, the audio processor comprising: an S/PDIF receiver arranged continually to detect the sample rate of an incident S/PDIF stream and recover a clock and data from the incident S/PDIF stream, integrity judging means adapted continuously to judge the integrity of the S/PDIF stream according to a plurality of criteria and, when judging integrity to be present, asserting a lock flag; and lock flag reporting means arranged to transmit an indication of said lock flag to the controller.

The criteria employed by the integrity judging means may include whether the recovered data reflects the data in the incident S/PDIF stream. The criteria employed by the integrity judging means may include whether the recovered clock reflects the clock in the incident S/PDIF stream. The criteria employed by the integrity judging means may include whether the sample rate is valid and within a specified sample rate tolerance from a nominal centre frequency. The criteria employed by the integrity judging means may include whether an input S/PDIF stream is present.

The integrity judging means may determine that the recovered data reflects the data in the incident S/PDIF stream when a predetermined number of Z frames have been received with the correct X and Y frames in between. For example, the number may be two or three.

The integrity judging means may determine that the recovered data reflects the data in the incident S/PDIF stream by using parity checks. The integrity judging means may determine that the recovered data reflects the data in the incident S/PDIF stream on the basis of preamble order checking. The integrity judging means may determine that the recovered data reflects the data in the incident S/PDIF stream by using bi-phase encoding error checking. The integrity judging means may determine that the recovered clock reflects the clock in the incident S/PDIF stream when a clock recovery block of the S/PDIF receiver reports a stable output clock. The integrity judging means may determine that the recovered clock reflects the clock in the incident S/PDIF stream when a FIFO control loop of the S/PDIF receiver is settled and locked. The integrity judging means may determine that the sample rate is valid and within a specified tolerance of the S/PDIF receiver by comparing the sample rate of the incident stream with a plurality of predetermined sample rates. The integrity judging means may be part of the S/PDIF receiver.

The audio processor may be compliant with a serial audio bus standard such as AC'97, SLIMbus or HDA. In particular, it may be in the form of an HDA codec, the controller being an HDA controller communicating with the HDA codec via an HDA bus, and the HDA codec providing data derived from the incident S/PDIF stream on an inbound stream of said HDA bus. In this case, the lock flag reporting means may provide said indication of the lock flag by transmitting an unsolicited response to the HDA controller, said unsolicited response being generated whenever the lock flag is asserted or de-asserted by the integrity judging means.

The HDA codec may further comprise sample rate detecting means arranged to detect the sample rate of the incident S/PDIF stream and to report a change in the detected sample rate to the HDA controller via an unsolicited response.

The S/PDIF receiver may be responsive to de-assertion of the lock flag to pack the inbound stream for transmission on the HDA bus to the HDA controller, with null data at the last determined sample rate.

According to another aspect of the present invention, there is provided a method for judging S/PDIF audio stream integrity in an audio processor for processing at least one S/PDIF audio stream and managed by an external controller, the method comprising the steps of: continuously detecting the sample rate of an incident S/PDIF stream and recovering a clock and data from the incident S/PDIF stream, continuously judging the integrity of the S/PDIF stream according to a plurality of criteria and, when judging integrity to be present, asserting a lock flag; and transmitting an indication of said lock flag to the controller.

The audio processor may be the form of a HDA codec, the controller may be a HDA controller communicating with the HDA codec via a HDA bus, and the HDA codec may provide data derived from the incident S/PDIF stream on an inbound stream of said HDA bus.

The transmitting step may provide said indication of the lock flag by transmitting an unsolicited response to the HDA controller, said unsolicited response being generated whenever the lock flag is asserted or de-asserted during the judging step.

The method may further comprise the step of detecting the sample rate of the incident S/PDIF stream and reporting a change in the detected sample rate to the HDA controller via an unsolicited response.

According to another aspect of the present invention, there is provided software for an audio processor, for processing at least one S/PDIF audio stream and managed by an external controller, the software when executed by control logic of the codec performing the functions of: continuously detecting the sample rate of an incident S/PDIF stream and recovering a clock and data from the incident S/PDIF stream, continuously judging the integrity of the S/PDIF stream according to a plurality of criteria and, when judging integrity to be present, asserting a lock flag; and transmitting an indication of said lock flag to the controller.

A computer-readable medium is also provided on which is recorded the software of the above aspect.

An electronic apparatus is provided that includes the audio processor referred to above. The electronic apparatus may be in the form of a portable computer, mobile internet device, audio system, mobile telephone, personal media player, multifunction device combining these functions and/or audio hub.

S/PDIF is a digital audio transmission format, which allows digital audio data and clocking information to be sent between devices. The format is point-to-point and a typical implementation consists of a S/PDIF transmitter and a S/PDIF receiver.

In any digital audio system where S/PDIF digital audio streams are used, the S/PDIF receiver has no control over the sample rate of the recovered S/PDIF receiver data stream. The sample rate is governed by the external system, which generates, encodes and transmits the S/PDIF stream via its S/PDIF transmitter.

In view of this, a S/PDIF receiver must track the sample rate of the incident S/PDIF stream and must recover the clock and data from the incident stream.

In a typical S/PIDF receiver, a lock flag is provided which indicates the S/PDIF receiver confidence in the accuracy of the recovered clock and data. An unlock condition is typically flagged when the recovered clocks or data are determined not to match the clocks and data encoded in the incident S/PDIF stream.

It may also be necessary to flush the control system and re-configure it before accepting data at a new sample rate. In a HDA codec for example, the control system is the DMA control system (DMA engine). This flushing is important so that the controller can be fed samples at known sample rates, to prevent undesirable audio effects from occurring with the audio sub-system.

It is desirable to provide an audio device capable of supporting dynamic sample rate changes during S/PDIF receiver operation.

According to an aspect of the present invention, there is provided an audio device (processor) for processing at least one S/PDIF audio stream and managed by an external controller, the audio device comprising: a S/PDIF receiver arranged to receive an incident S/PDIF stream; and sample rate detector means arranged to monitor the sample rate of the incident S/PDIF stream, wherein the S/PDIF receiver is arranged to transmit an indication to the controller when the sample rate detector means detects that the input sample rate of the incident S/PDIF stream has changed.

The sample rate detector means may be part of the S/PDIF receiver.

The audio device may be in the form of a HDA codec, the controller being a HDA controller communicating with the HDA codec via a HDA bus, and the HDA codec providing data derived from the incident S/PDIF stream in an SDI signal of said HDA bus. In this case, the indication transmitted to the controller may be an unsolicited response inserted in said SDI signal.

A converter format verb may be associated with the S/PDIF receiver from which the HDA controller can read the detected sample rate, the S/PDIF receiver being arranged to update the detected sample rate by means of the converter format verb whenever the detected sample rate changes.

The S/PDIF receiver may be arranged to control a sample rate in said SDI signal of said data derived from the incident S/PDIF stream in accordance with the converter format verb.

The sample rate detector means may be arranged to set an input sample rate update flag, such that when the sample rate detector block detects that the input sample rate has changed, an unsolicited response is generated informing the HDA controller of the sample rate change. This may be generated by the S/PDIF receiver or a pin widget node for example.

According to another aspect of the present invention, there is provided a method for processing at least one S/PDIF audio stream by an audio device managed by an external controller, the method comprising the steps of: continuously receiving an incident S/PDIF stream; monitoring the sample rate of the incident S/PDIF stream as it is received; and transmitting an indication to the controller when the monitoring step detects that the sample rate of the incident S/PDIF stream has changed.

According to a further aspect of the present invention, there is provided software for an audio device, for processing at least one S/PDIF audio stream and managed by an external controller, the software when executed by control logic of the audio device performing the functions of: receiving an incident S/PDIF stream; detecting the sample rate of the incident S/PDIF stream at each of a plurality of timings; and transmitting an indication to the controller when the detecting step detects that the input sample rate of the incident S/PDIF stream has changed.

A computer-readable medium is also provided on which is recorded the software of the above aspect.

An electronic apparatus is provided that includes the audio device defined above. The electronic apparatus may be in the form of a portable computer, mobile internet device, audio system, mobile telephone, personal media player, multifunction device combining these functions and/or audio hub.

According to an aspect of the present invention, there is provided an audio device (processor) for processing at least one S/PDIF audio stream in order to supply data derived therefrom to an external controller, the audio device comprising: a S/PDIF receiver arranged to receive an incident S/PDIF stream, to monitor the sample rate and determine integrity of the incident S/PDIF stream, the S/PDIF receiver generating a lock flag when determining integrity of the incident S/PDIF stream after a change in the sample rate; and lock flag reporting means arranged to transmit an indication of the lock flag to the controller; wherein the audio device is arranged, following transmission of said indication of the lock flag to the controller, to withhold supply of said derived data until an acknowledgement is received from the controller.

The audio device may further comprise sample rate reporting means arranged to transmit to the controller an indication of the new sample rate after a change in the sample rate of the incident S/PDIF stream.

The supply of said derived data from the audio device to the controller may be stopped until the controller acknowledges the new sample rate.

The audio device may be in the form of a HDA codec, the controller being a HDA controller communicating with the HDA codec via a HDA bus, and the HDA codec providing said data derived from the incident S/PDIF stream in an SDI signal carried on said HDA bus. In this case, data derived from the S/PDIF audio stream may be assigned a stream identification value by the controller, the codec arranged to re-start supply of said derived data upon receipt of a new valid stream identification value from the controller.

The codec may be responsive to receipt of a command from the controller to stop supply of said derived data until receipt of the new stream identification value, and supply null data instead. The command is in the form of a zero stream identification value.

According to another aspect of the present invention, there is provided a method for processing at least one S/PDIF audio stream by an audio device managed by an external controller, the method comprising the steps of: whilst receiving an incident S/PDIF stream, monitoring its sample rate, determining integrity of the incident S/PDIF stream, and supplying to the controller data derived from the incident S/PDIF stream after integrity has been determined; and following a loss of integrity caused by a change in the sample rate, transmitting a notification to the controller once integrity of the incident S/PDIF stream is again determined, and withholding supply of said derived data until an acknowledgement of said notification is received from the controller.

According to a further aspect of the present invention, there is provided software for an audio device, for processing at least one S/PDIF audio stream and managed by an external controller, the software when executed by control logic of the audio device performing the functions of: whilst receiving an incident S/PDIF stream, monitoring its sample rate, determining integrity of the incident S/PDIF stream, and supplying to the controller data derived from the incident S/PDIF stream after integrity has been determined; and following a loss of integrity caused by a change in the sample rate, transmitting a notification to the controller once integrity of the incident S/PDIF stream is again determined, and withholding supply of said derived data until an acknowledgement of said notification is received from the controller.

A computer-readable medium is also provided on which is recorded the software of the above aspect.

An electronic apparatus is provided that includes the audio device defined above. The electronic apparatus may be in the form of a portable computer, mobile internet device, audio system, mobile telephone, personal media player, multifunction device combining these functions and/or audio hub.

According to an aspect of the present invention, there is provided an audio device (processor) for processing at least one S/PDIF audio stream and managed by an external controller, the audio device comprising: a S/PDIF receiver arranged to receive an incident S/PDIF stream and extract therefrom digital audio data for transmission to the controller; sample rate detector means arranged to detect the sample rate of the incident S/PDIF stream; and lock flag reporting means arranged to generate an indication of a lock condition for transmission to the controller when the integrity of the incident S/PDIF stream is determined, wherein the S/PDIF receiver is arranged, as soon as the lock flag reporting means generates said indication of the lock condition to the controller, to begin transmission of the digital audio data to the controller at the sample rate detected by the sample rate detector means.

The lock condition may be a re-lock condition, after the sample rate detector means has detected a new sample rate.

The lock flag reporting means may be responsive to a change in the sample rate to transmit an unlock condition to the controller, prior to transmitting said indication of the re-lock condition once the new sample rate has been determined.

The audio device may be in the form of a HDA codec, the controller being a HDA controller communicating with the HDA codec via a HDA bus, and the HDA codec providing the digital audio data derived from the incident S/PDIF stream in an SDI signal carried on said HDA bus.

According to an aspect of the present invention, there is provided a method for processing at least one S/PDIF audio stream by an audio device managed by an external controller, the method comprising the steps of: receiving an incident S/PDIF stream; monitoring the sample rate and the integrity of the incident S/PDIF stream; transmitting an indication of a lock condition to the controller whenever the integrity of the incident S/PDIF stream is newly determined after a change in the sample rate; and transmitting digital audio data extracted from the incident S/PDIF stream to the controller at the new sample rate determined in the monitoring step upon transmitting the indication of the lock condition.

According to a further aspect of the present invention, there is provided software for an audio device, for processing at least one S/PDIF audio stream and managed by an external controller, the software when executed by control logic of the audio device performing the functions of: receiving an incident S/PDIF stream; monitoring the sample rate and integrity of the incident S/PDIF stream; and transmitting an indication of a lock condition to the controller whenever the integrity of the incident S/PDIF stream is newly determined following a change in sample rate of the incident S/PDIF stream; and transmitting data of the incident S/PDIF stream to the controller at the new sample rate determined in the monitoring step upon transmitting the indication of the lock condition.

A computer-readable medium is also provided on which is recorded the software of the above aspect.

An electronic apparatus is provided that includes the audio device of the above aspect. The electronic apparatus may be in the form of a portable computer, mobile internet device, audio system, mobile telephone, personal media player, multifunction device combining these functions and/or audio hub.

Production evaluation and testing of codecs is usually performed using automated test equipment. This involves plugging the codec into an audio test board and probing the codec to check various aspects of its operation for the purpose, for example, of testing whether a particular sample of a codec is fully functional prior to shipping to a customer. In the case of testing HDA codecs, in order to probe a conventional HDA codec, it is necessary to link the codec to an external controller in order for the HDA link to become active and allow test data to be transferred along an audio path from an input source to an output source to evaluate codec performance. This is because the HDA specification specifies that all audio paths in the codec must start or end on the HDA link.

Testing a HDA codec is complicated by the need to connect the codec to a controller that is external to the test apparatus, both in terms of the apparatus needed for testing and the interpretation of the test results. Ease of testing is crucial to the development and manufacturing process, and if testing time can be facilitated, significant cost savings can be made.

It is therefore desirable to facilitate the testing of a HDA codec.

According to an aspect of the present invention, there is provided a HDA codec for processing of audio streams and arranged for communication with an external HDA controller via a HDA link, comprising: at least one input stream source; at least one output stream sink; and at least one audio path between said input stream source and said output stream sink, wherein the audio path is arranged such that it does not require interaction with the HDA link.

The present invention provides the advantage of allowing internal custom test paths within the HDA codec that do not start or end at the HDA link. This allows the HDA codec to be tested without the need to connect the codec to an intelligent controller that is external to the test apparatus, hence saving time and effort during testing.

Thus, the audio path is preferably a test path used for evaluating the operation of the codec.

The audio path may be arranged so as to be inaccessible in normal operation of the codec in order to comply with the HDA specification.

Alternatively, the audio path may be enabled for non-HDA uses of the codec during normal operation.

The audio path may directly couple the input stream source with the output stream sink. Where a plurality of input stream sources and/or output stream sinks are present, the audio path may be switchable between any one of the input stream sources and output stream sinks respectively.

A plurality of the audio paths may be provided, allowing simultaneous connections of input stream sources to output stream sinks.

The at least one input stream source may be an ADC or S/PDIF receiver and the output stream sink may be a DAC or S/PDIF transmitter.

The audio path may be defined using custom verbs that are arranged such that the input stream source sinks data to the output stream sink rather than to the HDA link and the output stream sink sources data from the input stream source rather than from the HDA link.

According to another aspect of the present invention, there is provided a method of defining an audio path in a HDA codec, the HDA codec for communication with an external HDA controller via a HDA link, the method comprising the steps of: providing a custom verb at an input stream source to instruct the input stream source to sink data to an output stream sink and not the HDA link; providing a custom verb at the output stream sink to instruct the output stream sink to source data from the input stream source and not the HDA link; and transmitting an audio stream from the input stream source to the output stream sink without requiring interaction with the HDA link.

According to another aspect of the present invention, there is provided a method of testing a HDA codec, the HDA codec for communication with an external HDA controller via a HDA link, the method comprising the steps of: defining an audio path in the codec between an input stream source and an output stream source that it does not interact with the HDA link; and evaluating the audio path using automated test equipment.

According to another aspect of the present invention, there is provided software for a HDA codec, the HDA codec for communication with an external HDA controller via a HDA link, when executed by the control logic of the HDA codec, performs the functions of: providing a custom verb at an input stream source to instruct the input stream source to sink data to an output stream sink and not the HDA link; providing custom verb at the output stream source to instruct the output stream sink to source data from the input stream source and not the HDA link; and transmitting an audio stream from the input stream source to the output stream sink without requiring interaction with the HDA link.

A computer-readable medium is also provided on which is recorded the software of the above aspect.

An electronic apparatus is provided that includes the codec defined above. The electronic apparatus may be in the form of a portable computer, mobile internet device, audio system, mobile telephone, personal media player, multifunction device combining these functions or audio hub.

The electronic apparatus may have telephony function, with the audio path being used for voice back functions.

The HDA specification allows streams to be type-specified as AC3, Float 32 (IEEE 754-1985) and PCM. In other words, any one of these data types may be used to indicate the kind of digital audio data transferred between the HDA controller and the HDA codec.

Float 32 may be regarded as a floating-point variant of PCM. Whilst PCM uses integer (fixed point) sample words, Float 32 represents each sample as a 32-bit floating-point number. The selection of integer (fixed point) and floating point can allow native processing by suitably-capable CPUs and DSPs. However, there is no current way of indicating or commanding that Float 32 data is being sent or received, as it is only possible to flag whether data is PCM or non PCM type (e.g. compressed data) in the HDA stream format structure. Thus, there is a problem of distinguishing floating point data from fixed point PCM data.

The HDA specification provides a way for a codec to notify the HDA controller that it supports the use of floating point data, but no way to command or flag the use of floating point in a particular transmission between the controller and the codec. It is therefore desirable to provide a way of indicating that floating point data is being sent/received.

According to an aspect of the present invention, there is provided a HDA controller arranged for communication of audio data with a HDA codec, the controller arranged to transmit said audio data by providing to the codec: a first indicator arranged to inform the HDA codec whether or not data to be transmitted is PCM data; and a second indicator arranged to inform the HDA codec of the number of bits in each sample of the data to be transmitted, wherein when the first indicator indicates that the data is PCM data and the second indicator indicates that the number of bits in each sample is a prescribed number of bits, the HDA codec is informed that the data is floating point data.

The floating point data may be Float 32 data, where the prescribed number of bits is 32. The first indicator may be a stream type bit (TYPE) defined in HDA and the second indicator may be the bits per sample (BITS) defined in HDA. According to another aspect of the present invention, there is provided a HDA codec arranged to receive audio data from a HDA controller, the controller arranged to transmit said audio data by providing to the codec an indicator to inform the HDA codec of the number of bits in each sample of the data transmitted from the HDA controller, wherein when the indicator indicates that the number of bits in each sample is a prescribed number of bits, the HDA codec is arranged to treat the data as floating point data.

Preferably, the prescribed number of bits is 32. This allows the HDA codec to handle 32-bit data as Float 32 regardless of the TYPE setting by simply assuming that 32-bit data will not be fixed point.

According to another aspect of the present invention, there is provided a method of controlling the data format of data transmission between a HDA codec to a HDA controller, comprising the steps of: setting a first indicator to indicate that data transmitted is PCM data; and setting a second indicator to indicate the number of bits in each sample of the data transmitted, wherein when the first indicator indicates that the data is PCM data and the second indicator indicates that the number of bits in each sample is a prescribed number of bits, the recipient of the data transmitted is informed that the data is floating point data.

Typically, the above method will be employed by the HDA controller when transmitting data to the HDA codec. It may also be employed by the codec to signal floating point data to the controller.

The first indicator may be the stream type bit (TYPE) defined in HDA and the second indicator may be the bits per sample (BITS) defined in HDA.

According to another aspect of the present invention, there is provided software, for a HDA controller, the HDA controller arranged for communication of data with a HDA codec, the software when executed by control logic of a controller performing the functions of: setting a first indicator to indicate to the HDA codec that data transmitted in PCM data; and setting a second indicator to indicate to the HDA codec that the number of bits in each sample of the data transmitted from the HDA controller, wherein when the first indicator indicates that the data is PCM data and the second indicator indicates that the number of bits in each sample is a prescribed number of bits, the HDA codec is informed that the data is floating point data.

A computer-readable medium is also provided on which is recorded the software of the above aspect.

An electronic apparatus is provided that includes the HDA controller and/or the HDA codec as defined above. The electronic apparatus may be in the form of a portable computer, mobile internet device, audio system, mobile telephone, personal media player, multifunction device combining these functions or audio hub.

A HDA codec, like any hardware codec, needs to supply audio output signals in analogue form for use in the physical world, e.g. for listening through speakers or headphones. Typically, this is achieved by a DAC in the codec to generate the analogue signal followed by one or more output analogue amplifier stages. However, various configurations are possible involving digital amplifier stages instead of or in addition to analogue amplifier stages. Any such configuration is referred to below simply as an “audio amplifier”. Ideally, the signal input to the audio amplifier has a signal level which varies symmetrically in time about a zero point (line of zero amplitude), but in some instances a DC offset may be present in the signal.

Suppose that a listener desires to increase the volume level of audio being reproduced from a system containing a HDA codec. He or she achieves this by manipulating a volume control, such as a real or virtual knob or slider provided by the system. This manipulation, in turn, cases the HDA controller to send a command to the HDA codec for altering the gain of the relevant amplifier. When a command to change the gain of an amplifier that is positioned at an output of a HDA codec is given, it is desirable to update the gain at a zero crossing, i.e. a timing where the signal level crosses the zero point. If the update is performed when the signal level is not at the zero point, a discontinuity is introduced in the amplitude of the amplifier output signal. This can cause an audible click (which in the case of repeated gain changes, produces so-called “zipper noise”) that will disturb the listener. On the other hand an analogue signal having a DC offset will have no zero crossing.

Meanwhile, if the HDA codec waits too long to perform the gain update, the system will seem unresponsive to the listener, who in frustration may manipulate the volume control again to initiate a further gain update, eventually causing a large and unnecessary gain change.

It is therefore desirable to provide a HDA codec that can better perform gain control.

According to an aspect of the present invention, there is provided a HDA codec arranged to process audio signals under control of a HDA controller and operating with a clock cycle determined by a clock signal from the HDA controller, the codec comprising: an audio amplifier arranged to amplify an input audio signal; and gain updating means for varying the gain of the amplifier upon request from the HDA controller by performing a gain update of the audio amplifier, and arranged to wait a predetermined number of clock cycles before performing the gain update while a signal level of the input audio signal is not at a zero cross point, whereby if the signal level of the input audio signal reaches a zero cross point during said predetermined number of clock cycles, the gain updating means performs the gain update, otherwise the gain updating means performs the gain update upon completion of said predetermined number of clock cycles.

The predetermined number of clock cycles may be a predetermined number of cycles of the HDA bit clock (BCLK) supplied by the HDA controller over an HDA bus.

The HDA codec may further comprise means for informing the gain updating means when the signal level is at a zero cross point. The zero cross point may not be the exact position at which the signal level reaches zero. It may be any signal level within a threshold level of the zero cross point.

The means for informing may be a zero cross detector, which may be arranged to monitor the signal level of the input audio signal.

The gain updating means may be controlled by a HDA custom verb.

The audio amplifier may include at least one analogue input stage. The audio amplifier may include at least one digital input stage.

According to another aspect of the present invention, there is provided a method of gain control in a HDA codec which processes audio signals under control of a HDA controller and operates with a clock cycle determined by a clock signal from the HDA controller, the method comprising: using an amplifier, amplifying an input audio signal; detecting a value representative of the signal level of the input audio signal; and varying the gain of the amplifier upon request from the HDA controller, the varying step being performed as soon as the signal level of the input audio signal level reaches a zero crossing; characterised in that, if no zero crossing is reached within a predetermined number of clock cycles, the varying step is performed upon completion of said predetermined number of clock cycles.

According to another aspect of the present invention, there is provided software for a HDA codec which processes audio signals under control of a HDA controller and operates with a clock cycle determined by a clock signal from the HDA controller, the codec using an amplifier to amplify an input audio signal, the software when executed by control logic of the codec performing the functions of: detecting a value representative of a signal level of the input audio signal; and varying the gain of the amplifier upon request from the HDA controller, the varying step being performed as soon as the signal level of the input audio signal level reaches a zero crossing; characterised in that, if no zero crossing is reached within a predetermined number of clock cycles, the varying step is performed upon completion of said predetermined number of clock cycles.

A computer-readable medium is also provided on which is recorded the software of the above aspect.

An electronic apparatus is provided that includes the HDA codec defined above. The electronic apparatus may be in the form of a portable computer, mobile internet device, audio system, mobile telephone, personal media player, multifunction device or audio hub.

Meanwhile, a codec may be required to provide analogue output signals in a number of different forms including a line out, headphone out, and so on from a single output port.

The signal level and load requirements of a line out output and headphone output are very different. A line out output requires a relatively high signal level of 2 Vrms, but with a load impedance on the order of tens of kohms, the output power is in the μW range. On the other hand, a headphone output requires a lower signal level of around 0.8 Vrms or less but as the load impedance is much lower at 16-32 ohms, the maximum power requirement is much higher, of the order of 30 mW.

There is therefore an issue of how to provide suitable signals in both a headphone out mode and a line out mode, given the different signal level and load requirements of the two modes.

According to an aspect of the present invention, there is provided a codec arranged to supply an analogue output signal from an output port comprising: digital signal processing means arranged for processing an audio signal in the digital domain to generate a digital output signal; digital to analogue conversion means arranged for converting the digital output signal to an analogue signal; analogue signal processing means arranged for generating said analogue output signal from said analogue signal and outputting the analogue output signal to the output port; wherein the analogue output signal is provided in either a headphone mode or a line out mode, the line out mode having a higher signal level and the headphone mode having a lower signal level, wherein the codec is responsive to a headphone enable bit, received from an external controller, to set the headphone mode, the headphone mode being provided by applying a fixed attenuation to the output signal.

In the headphone mode, the maximum output signal level may be limited to around 0.8 Vrms and in the line out mode, the maximum signal level may be limited at a higher level of around 2 Vrms.

The headphone mode may be provided by digital signal processing means applying a fixed attenuation in the digital domain. In this case, the analogue signal processing means may have a configuration which is unchanged between the line out mode and the headphone mode. The fixed attenuation may be substantially 8 dB attenuation.

The limiting in the headphone mode can be obtained using an existing attenuator function already provided for other purposes. There is no need to further reconfigure the codec in any other way, such as by switching an analogue amplifier stage out of circuit.

According to another aspect of the present invention, there is provided a method of supplying an analogue output signal from a codec in either of a line out mode or a headphone mode from the same output port, comprising the steps of: converting a digital audio sample into an analogue signal for supply from said output port; and setting a level of an analogue output signal in the port at a first level in the line out mode, and at a second level in the headphone mode, the second level being made lower than the first level by applying a fixed attenuation in the digital domain, wherein the codec is responsive to a headphone enable bit from an external controller to set the headphone enable mode.

According to another aspect of the present invention, there is provided software for a codec, the software when executed by control logic of the codec controlling a digital signal processing means of the codec to apply a fixed attenuation in the digital domain to a signal used to form an analogue output to an output port of the codec, in response to detection of a low level output mode of the output port, in response to a headphone enable bit received from an external controller.

A computer-readable medium is also provided on which is recorded the software of the above aspect.

An electronic apparatus is provided that includes the codec defined above. The electronic apparatus may be in the form of a portable computer, mobile internet device, audio system, mobile telephone, personal media player, multifunction device combining these functions or audio hub.

As already mentioned, a hardware codec typically has a number of analogue inputs for supplying signals to ADCs. The ADCs may be required to handle a wide variety of input signals from various sources including line in and microphone inputs, and microphones alone come in many different types each with different signal characteristics and power requirements. There is consequently a need to design an ADC for a codec having a flexible input configuration. The codec/controller arrangement defined in HDA provides a mechanism to change the configuration dynamically.

According to a first aspect of the present invention, there is provided a HDA codec having at least one ADC with an input stage, the input stage comprising: first and second input terminals for connection of a microphone therebetween; first and second differential amplifiers each with respective first and second inputs, the respective first inputs being selectably connected to a reference potential, the second input of the first differential amplifier being selectably coupled to the second input terminal, and a second input of the second differential amplifier being selectably coupled to the first input terminal; and a microphone boost buffer selectably coupled between the first and second input terminals; and switching means applied to the first and second input terminals, the microphone boost buffer, and the differential amplifier inputs, such that the input stage is dynamically configurable in any of a plurality of input configurations.

The switching means may be arranged to be switched by a command received by the HDA codec from a HDA controller.

The HDA codec may further comprise a programmable gain amplifier stage having inputs respectively coupled to outputs of the first and second differential amplifiers; and a microphone bias source selectably coupled to an input of the programmable gain amplifier stage.

The plurality of input configurations may be a differential non-inverting input configuration, a differential inverting input configuration, a single-ended inverting input configuration and an impedance sense configuration.

The differential inverting configuration may be a pseudo differential input configuration.

The impedance may be measured in the impedance sense configuration, by sensing current drawn by the microphone bias source.

A further aspect of the invention provides an audio system comprising the above codec, the audio system comprising an input port coupled to said first and second input terminals.

According to another aspect of the present invention, there is provided a method of configuring the input stage of the HDA codec described above, said input stage being the input stage of an ADC in an audio system, said audio system having a jack socket for receiving a jack plug of an external apparatus, the method comprising the steps of: setting an impedance sense configuration of the input stage and performing an impedance sense to provide an indication of impedance of the external apparatus; and re-configuring the input stage in dependence upon said indication.

The method may further comprise the step of detecting presence of a jack plug inserted into said jack socket, prior to said impedance sense step.

When the impedance sense is complete the result may be recorded in a register of the HDA codec for interrogation by a HDA controller. The HDA controller may identify the external apparatus based on interrogation of the register, and may select an appropriate configuration for the input stage.

Embodiments of the present invention provide a flexible input stage for an ADC, capable of being dynamically configured to operate in any one of a number of operating modes depending on the type of source (e.g. line in, unbalanced microphone, balanced microphone) connected to the inputs.

### BRIEF DESCRIPTION OF DRAWINGS

Embodiments of the present invention will now be described, by way of example, with reference to the accompanying drawings, of which:

FIG. 1 illustrates a prior art HDA hardware configuration in a PC chipset environment;

FIG. 2 schematically illustrates a connection between a HDA codec and HDA controller via a HDA link;

FIG. 3 illustrates the demarcation of a prior art HDA frame;

FIG. 4 schematically illustrates the composition of a prior art HDA frame;

FIG. 5 illustrates the format of a command field of an outgoing stream on SDO;

FIG. 6 illustrates the format of a response field of an incoming stream on SDI;

FIG. 7 illustrates the format of an unsolicited response;

FIG. 8 schematically illustrates a codec according to an example of the present invention;

FIG. 9 illustrates an example of an unsolicited response priority queue;

FIG. 10 illustrates an example of a queue control matrix used for managing multiple unsolicited responses;

FIG. 11 schematically illustrates a codec according to an example of the present invention;

FIG. 12 illustrates an example of the unsolicited response update according to an example of the present invention;

FIG. 13 schematically illustrates the format of an unsolicited response in an example;

FIG. 14 schematically illustrates a HDA codec in an example;

FIG. 15 schematically illustrates a HDA codec in accordance with another example;

FIG. 16 schematically illustrates a HDA codec in accordance with a further example;

FIG. 17 is a table showing an example of the stream set up of HDA codec of FIG. 16;

FIG. 18 illustrates a state machine employed in a HDA codec according to an example;

FIG. 19 shows a table illustrating the calculations of the state machine shown in FIG. 18 for the streams described in FIG. 17;

FIG. 20 schematically illustrates a HDA codec according to another example;

FIG. 21 illustrates a codec in accordance with an example of the present invention;

FIG. 22 is a table showing an example of the stream set up of the HDA codec of FIG. 21;

FIG. 23 shows the stream order calculation of the streams shown in FIG. 22 and the resultant stream order matrix;

FIG. 24 schematically illustrates a codec 560 in accordance with another example of the present invention;

FIG. 25 shows the sequence of states when serialising the data of the streams in accordance with an example of the present invention;

FIG. 26 schematically illustrates a codec;

FIG. 27 is a table showing stream configuration

FIG. 28 is diagram showing the flow of streams of FIG. 27 through the codec of FIG. 26;

FIG. 29 schematically illustrates a codec;

FIG. 30 schematically illustrates the deserialiser of FIG. 29;

FIG. 31 schematically illustrates a codec;

FIG. 32 schematically illustrates an audio processor;

FIG. 33 schematically illustrates an audio processor;

FIG. 34 schematically illustrates an audio processor;

FIG. 35 illustrates an example of the operation of audio processor of FIG. 34;

FIG. 36 schematically illustrates an audio processor;

FIG. 37 illustrates an example of the operation of audio processor of FIG. 36;

FIG. 38 schematically illustrates an example configuration of a HDA codec;

FIG. 39 schematically illustrates a test path arranged in a HDA codec;

FIG. 40 schematically illustrates a HDA codec;

FIG. 41 schematically illustrates a HDA codec;

FIG. 42 shows a table listing possible input configurations;

FIG. 43 illustrates the input stage of an ADC (not shown);

FIG. 44 illustrates a configurable input stage;

FIG. 45 illustrates the input stage of FIG. 44 in a differential non-inverting configuration;

FIG. 46 illustrates the input stage of FIG. 44 in a differential inverting configuration;

FIG. 47 illustrates the input stage of FIG. 44 in a single ended inverting configuration;

FIG. 48 shows a table listing possible input configurations and how the input stage of FIG. 44 is configured in each input configuration;

FIG. 49 shows an impedance sense configuration of the input stage of FIG. 44;

FIG. 50 illustrates an impedance sweep configuration of the input stage of FIG. 44;

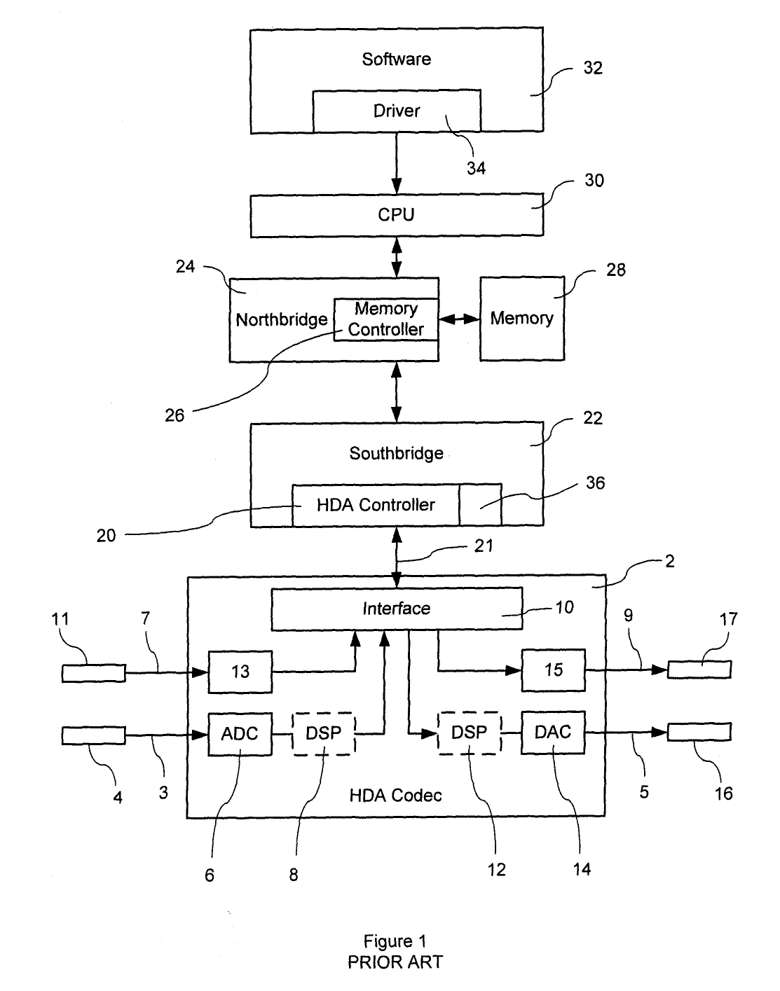

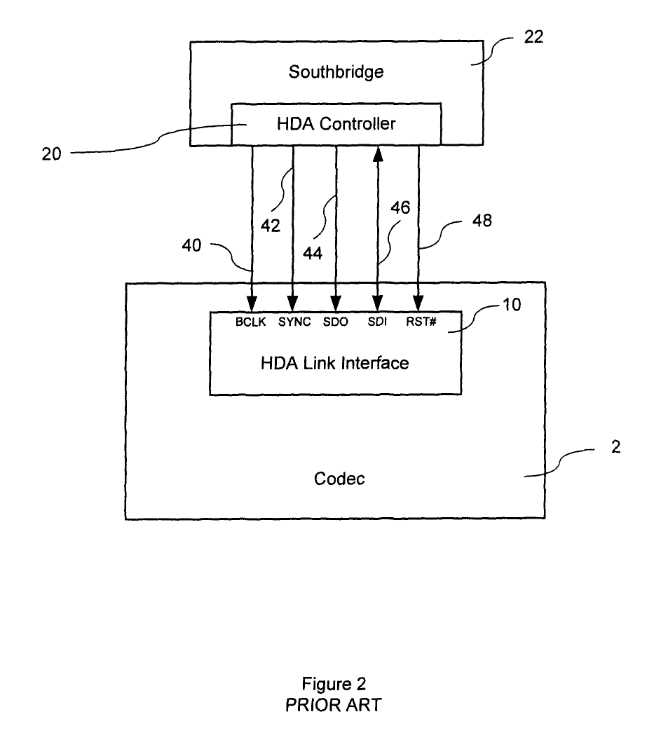

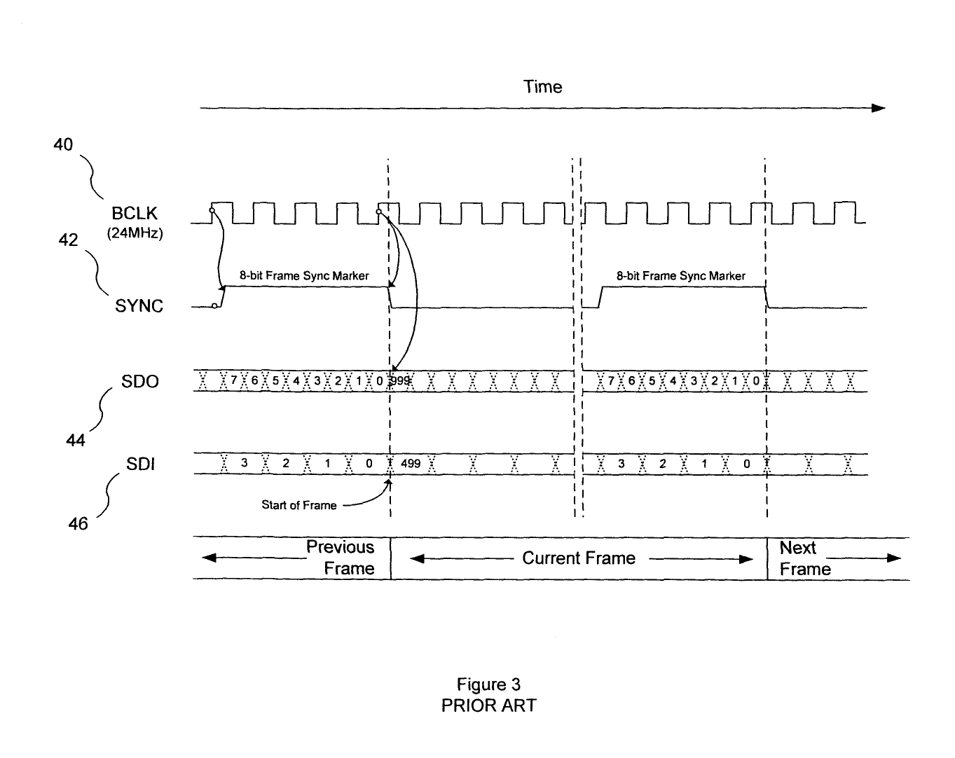

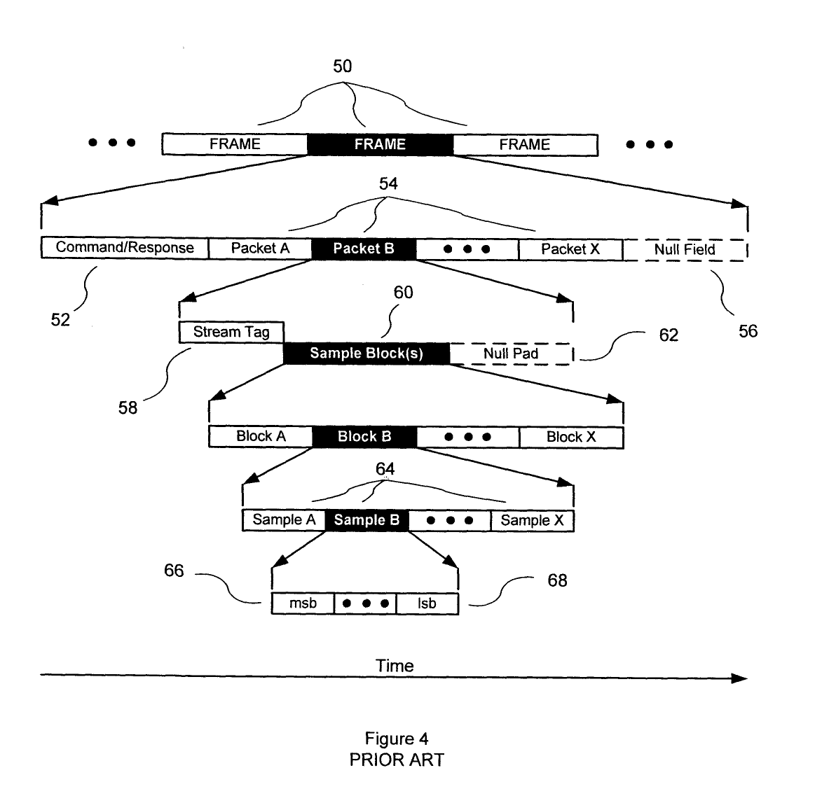

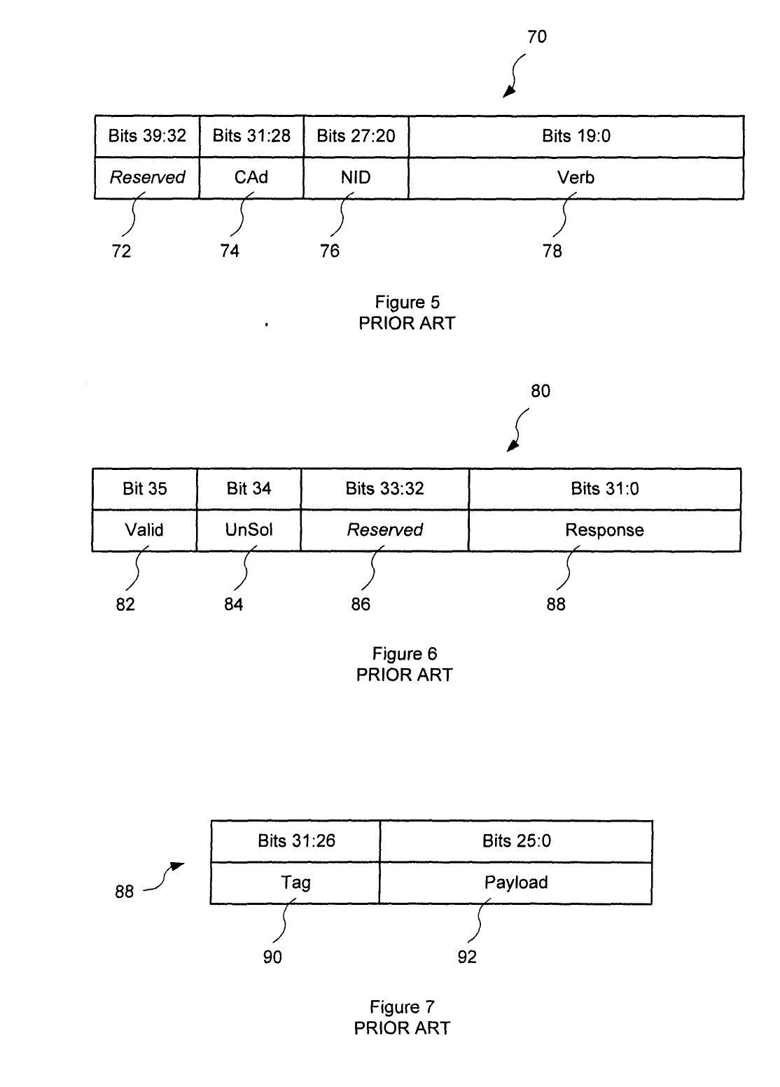

### DETAILED DESCRIPTION OF INVENTION

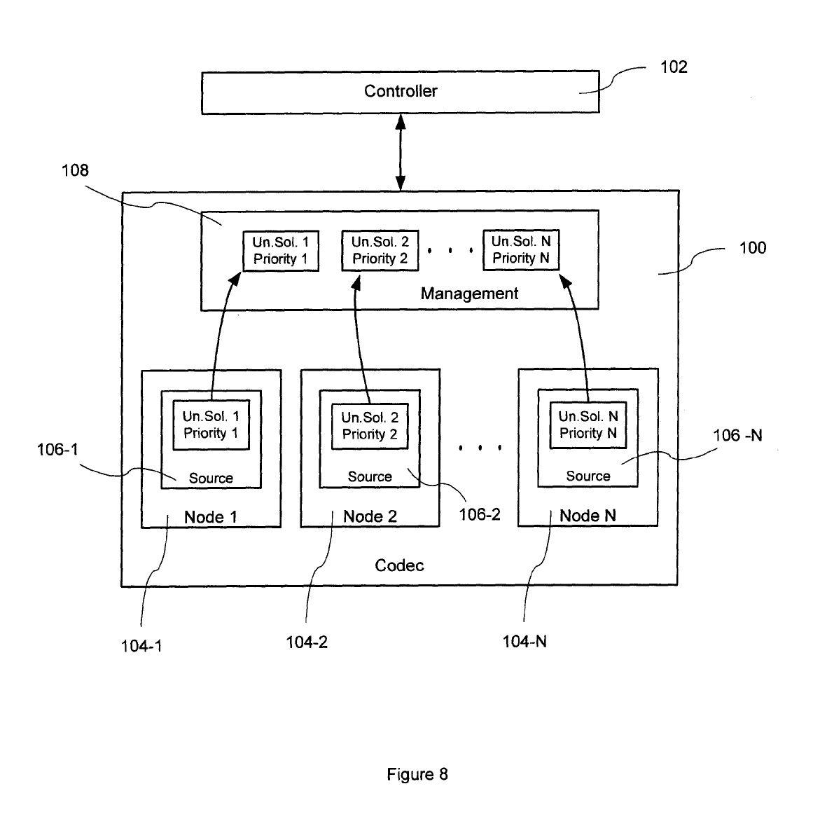

FIG. 8 illustrates a codec 100 in accordance with an example of the present invention. Codec 100 is arranged for communication of data and signalling with a controller 102.

As will be apparent to the person skilled in the art, codec 100 may be a HDA codec, the controller may be a HDA controller, and the communication may occur via a HDA link. Alternatively, codec 100 may be any codec, audio or otherwise or any other device having an interface that communicates with a controller in discrete time slots and is capable of generating status reports, such as SLIMbus or AC'97. For example, the device may be a SLIMbus Component having at least one Function device and in serial communication with another Component having a Manager device, via respective SLIMbus interface devices. In the context of this description, “codec” refers to any device or circuitry which is physically distinct from the controller; it should be noted however, that codecs need not be exclusively hardware based. Typically, driver software is used to control functional blocks of the codec under supervision of the controller. The following description will describe an example in which codec 100 is a HDA codec.

Codec 100 comprises a plurality of nodes 104-1 to 104-N. Each of the nodes 104-1 to 104-N has one or more unsolicited response sources 106-1 to 106-N (only one shown per node). According to an example of the present invention, codec 100 is arranged with each node assigned a priority value, such that when an unsolicited response source generates an unsolicited response, it is assigned the priority value of the node from which it was generated. All unsolicited responses that are generated from a particular node are assigned the same priority value of that node.

Each unsolicited response source 106-1 to 106-N is capable of generating an unsolicited response at any time. There is therefore the possibility that multiple unsolicited responses may be generated simultaneously. Furthermore, as unsolicited responses can only be sent in a free response field of an inbound frame (i.e. no solicited response has been requested by the controller 102) and only one unsolicited response can be sent in each frame, multiple unsolicited responses may be awaiting transmission to the controller 102 at any one time.

Codec 100 further comprises unsolicited response management means 108 which are arranged to store/manage unsolicited responses generated by the nodes 104-1 to 104-N that are awaiting transmission to the controller 102. Unsolicited response management means 108 is arranged to sort the unsolicited responses that are awaiting transmission based on their assigned priority values, and arrange for the unsolicited response with the highest priority value to be transmitted first, in the next available response slot.

The priority of each of the nodes can be set depending on user preference. In other words, the priority values of each node can be set by the software engineer (hardware integrator) writing the driver to set the desired priority values. Each node may be set a unique priority value. Alternatively, some of the nodes may be assigned a common priority value.

If more than one unsolicited response awaiting transmission in the unsolicited response management means 108, has the same assigned priority value, the unsolicited response management means 108 is arranged to sort those unsolicited responses based on the order in which they were triggered/generated.

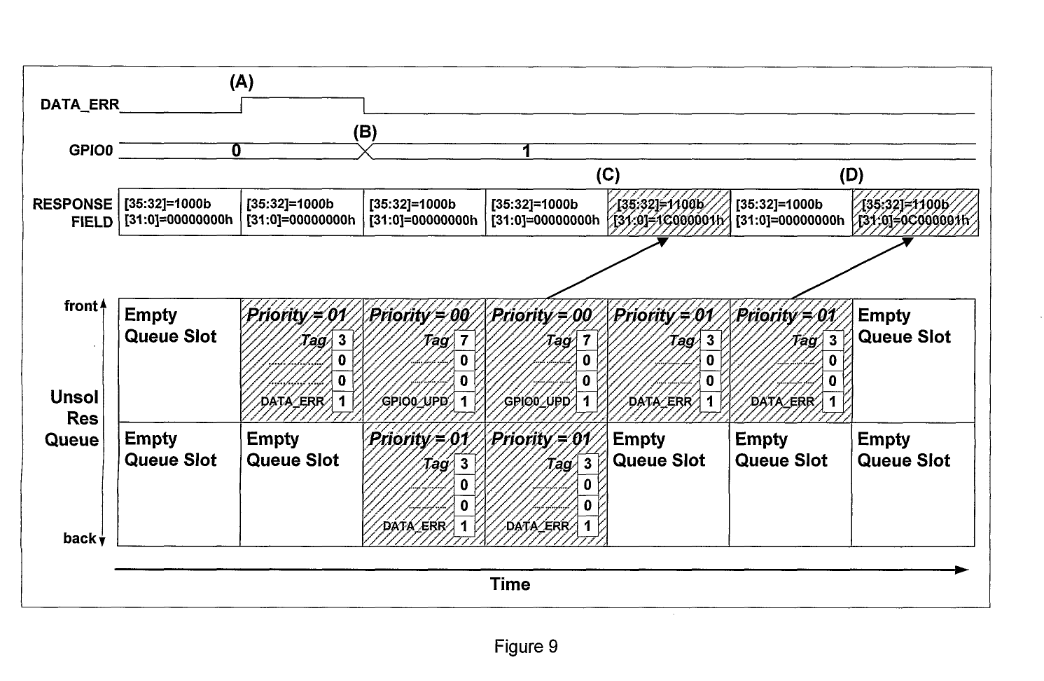

FIG. 9 illustrates, by way of example, how the unsolicited response management means 108 of codec 100 manages unsolicited responses that are awaiting transmission to the controller 102 by using an unsolicited response queue. This unsolicited response queue may be a virtual queue; in other words, it need not involve actual queuing of signals/data in a buffer or the like.

Consider the situation where codec 100 contains two different nodes 104-1 and 104-2 with unsolicited response sources 106-1 and 106-2 which are independent and which generate unsolicited responses. In this example, the first node is an S/PDIF receiver (S/PDIF Rx) node and the second node is a GPIO (general purpose I/O) node. The second node is assigned a higher priority than the first node, because in this example it is more important to notify the controller about events occurring on the GPIO node than those occurring on the S/PDIF Rx node.

An example of an event at the GPIO node (part of AFG) would be the receipt of a signal from an external amplifier indicating an overheat condition. It is important to be able to signal such a condition to the HDA controller, and hence to higher-level parts of the system.

As can be seen from FIG. 9, at time (A) a DATA_ERR flag asserts from S/PDIF Rx node and an unsolicited response (tag ID of 03) is generated and queued awaiting a free transmission slot. At time (B), the GPIO0 input changes to a 1 and hence the GPIO0_UPD flag asserts and an unsolicited response (tag ID of 07) is generated and queued. The unsolicited response sources are independently activated before either is able to be transmitted to the controller. At time (C), a slot becomes available on the HDA link for sending an unsolicited response.

FIG. 9 illustrates response fields of frames prior to time (C) containing null responses. These null responses are valid (solicited) responses and as such, no unsolicited response transmission is possible in these frames.

When a slot becomes available on the HDA link for sending an unsolicited response, the unsolicited response at the front of the transmission queue, i.e. the unsolicited response with the highest priority (smallest priority value), in this case the unsolicited response with tag ID of 07, is transmitted to the controller. At time (D), a second slot becomes available for sending an unsolicited response, and the unsolicited response at the front of the transmission queue, in this case the unsolicited response with tag ID of 03, is transmitted to the controller.

As will be apparent to the skilled person, the example shown in FIG. 9 can be adapted to manage unsolicited responses from any number of unsolicited response sources and the unsolicited response queue can be of any length.

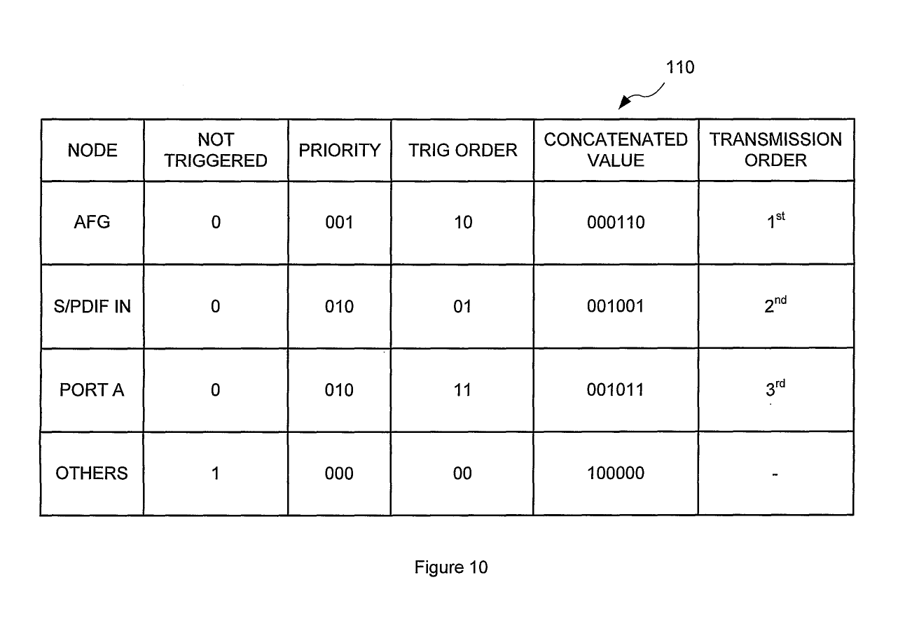

FIG. 10 illustrates an example of an unsolicited response queue. FIG. 10 shows a queue control matrix 110 that is used by the unsolicited response management means 108 in the codec 100 in order to determine which unsolicited response should be sent first, if multiple unsolicited responses are awaiting transmission to the controller 102.

The queue control matrix 110 shows three entries that represent unsolicited response sources that have been triggered (AFG, S/PDIF IN and PORT A) and a single entry representing any remaining unsolicited responses that have not been triggered in the example shown. Here, PORT A is a headphone output driver. Though not shown in FIG. 10, the queue control matrix 110 may contain an entry corresponding to every one of the unsolicited response sources in the codec 100.

FIG. 10 illustrates an example in which three nodes are enabled to generate unsolicited responses. These are the AFG (audio function group) node, the SPDIF IN node and the PORT A node (for example, an analogue audio output). In this example, the AFG node is assigned a high priority, with a priority value of 1, the S/PDIF node is assigned a lower priority, value 2, and the PORT A node is also assigned the priority value of 2.

Consider the situation where the following events occur in order in the codec, which trigger separate unsolicited responses to be generated from their respective nodes:

(1) An external device (e.g. TOSlink connector) is plugged in to the SPDIF input port.

(2) GPIO 1 is set high by an external circuit.

(3) The SPDIF receiver declares lock.

(4) An external device is plugged in to Port A (e.g. headphones).

Events 1 and 3 cause unsolicited responses to be generated by the SPDIF IN node. Event 2 causes unsolicited responses to be generated by the Audio Function Group node. Event 4 causes an unsolicited response to be generated by the PORT A node.

If these unsolicited responses are generated when there are no available slots to send immediate responses, the unsolicited responses will be queued until transmission slots are available to transmit them to the controller 102.

FIG. 10 shows the queue control matrix when all these unsolicited responses are waiting to be sent to the controller.

As can be seen in FIG. 10, the entries associated with the AFG node, S/PDIF node and PORT A node are indicated as triggered (NOT Triggered value of 0) and each entry has its associated priority value. The trigger order value is assigned based on the order in which the unsolicited responses are generated. Hence, since event 1 occurred first, the entry associated with the S/PDIF IN node is assigned the trigger order of 1 and as event 2 occurred second, the entry associated with the AFG node is assigned the trigger order of 2 and so on.

If a free response slot now becomes available, the unsolicited response management means 108 must decide which response to send first. This is done by stepping through all the entries in the queue control matrix 108 and recording the entry with the lowest value. The value of each entry is determined by concatenating (joining end to end) the NOT Triggered, Priority, and Trig Order values. Not Triggered (i.e. the value 0 indicating triggered) is more significant than Priority which is more significant than Trig Order. FIG. 10 shows the concatenated value of each entry in the table. As can be seen, the entry associated with the AFG node has the smallest concatenated value, so is positioned first in the transmission order. The entry associated with the S/PDIF IN node has the next smallest concatenated value, so is positioned second in the transmission order followed by the entry associated with the PORT A node.

This method is advantageous as the concatenation involves joining the NOT Triggered, Priority, and Trig Order values together and reading a value, such that no calculation is necessary to determine the entry with the lowest value.

In this example, the AFG node has the lowest value, so it will be sent first. The responses will then be sent in the order of the AFG unsolicited response first, the S/PDIF unsolicited response second, and the PORT A unsolicited response third.

When an unsolicited response is transmitted to the controller, a value of the queue depth and all the Trig Order values in the queue order matrix are decremented. NOT Triggered is also reset to 1 for the entry corresponding to the unsolicited response that was transmitted. It is necessary to update the Trig Order values after each response is sent in order to ensure that the queue control matrix is up to date.

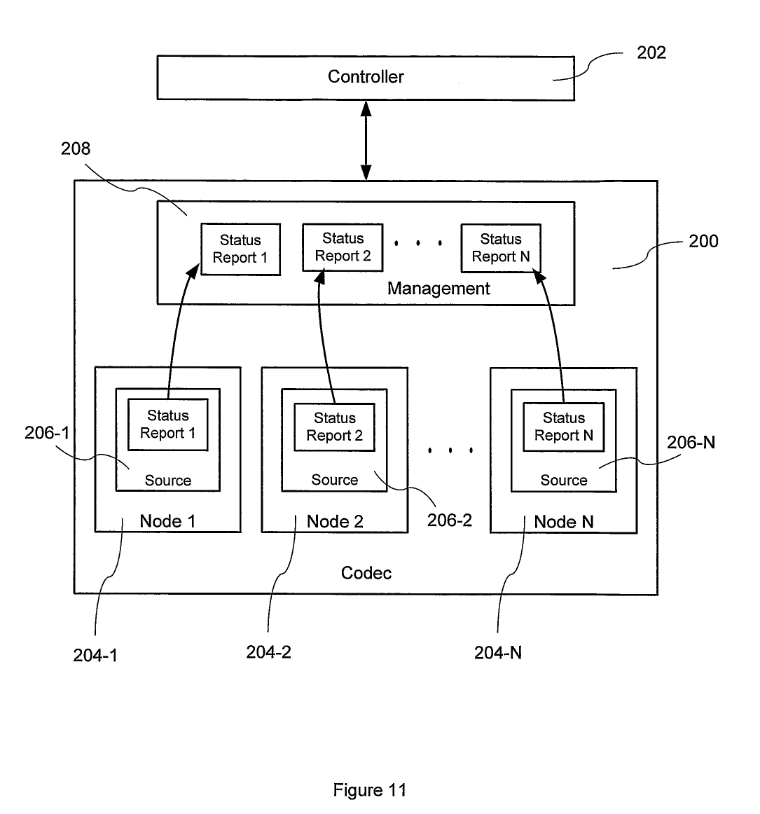

FIG. 11 illustrates a codec 200 according to an example. Codec 200 is arranged for communication of data and signalling with a controller 202.

As will be apparent to the person skilled in the art, codec 200 may be a HDA codec, the controller may be a HDA controller, and the communication may occur via a HDA link. Alternatively, codec 200 may be any codec, audio or otherwise or any other device that communicates serially with a controller in discrete time slots and is capable of generating status reports, such as SLIMbus or AC'97. For example, the device may be a SLIMbus Component in serial communication with another SLIMbus Component via respective SLIMbus interface devices. The following description will describe an example in which codec 200 is a HDA codec.

Codec 200 comprises a plurality of nodes 204-1 to 204-N. Each of the nodes 204-1 to 204-N has one or more reporting sources 206-1 to 206-N (only one shown per node). In a HDA codec, the reporting sources will include unsolicited response sources. There may be other nodes (not shown) which are not capable of reporting.

Each unsolicited response source 206-1 to 206-N is capable of generating status reports (these are called unsolicited responses in HDA) at any time. There is therefore the possibility that multiple unsolicited responses may be generated simultaneously. Furthermore, as unsolicited responses can only be sent in a free response field of an inbound frame (i.e. no solicited response has been requested by the controller 202) and only one unsolicited response can be sent in each frame, multiple unsolicited responses may be awaiting transmission to the controller 102 at any one time. Furthermore, the status of an unsolicited response source may have changed between the time an unsolicited response is generated and when it is transmitted to the controller 202.

Codec 200 further comprises an unsolicited response updating means 208 arranged to manage/update unsolicited responses generated by the nodes 204-1 to 204-N that are awaiting transmission to the controller 202. Updating means 208 is arranged to sort the unsolicited responses that are awaiting transmission, and update waiting unsolicited responses where appropriate.

Updating means 208 acts to update and refresh unsolicited responses that are awaiting transmission in the transmission queue in order to ensure that the data is as accurate and ‘fresh’ as possible when transmitted to controller 202. In other words, unsolicited responses that are awaiting transmission to the controller are updated to reflect the current status of the unsolicited response source from which they were generated.

When an unsolicited response is generated and queued, only one unsolicited response is generated from that node while the unsolicited response is in the transmission queue, irrespective of how many updates (from individual trigger sources within the node which generated the unsolicited response) to the payload data have occurred while the unsolicited response is in the transmission queue.

This increases bandwidth available on the HDA link for signalling other unsolicited response data from the codec 200 to the controller 202, as multiple unsolicited responses are not required to ensure that the controller has the most up-to-date unsolicited response data, and one updated unsolicited response contains all the unsolicited response payload data for a particular node.

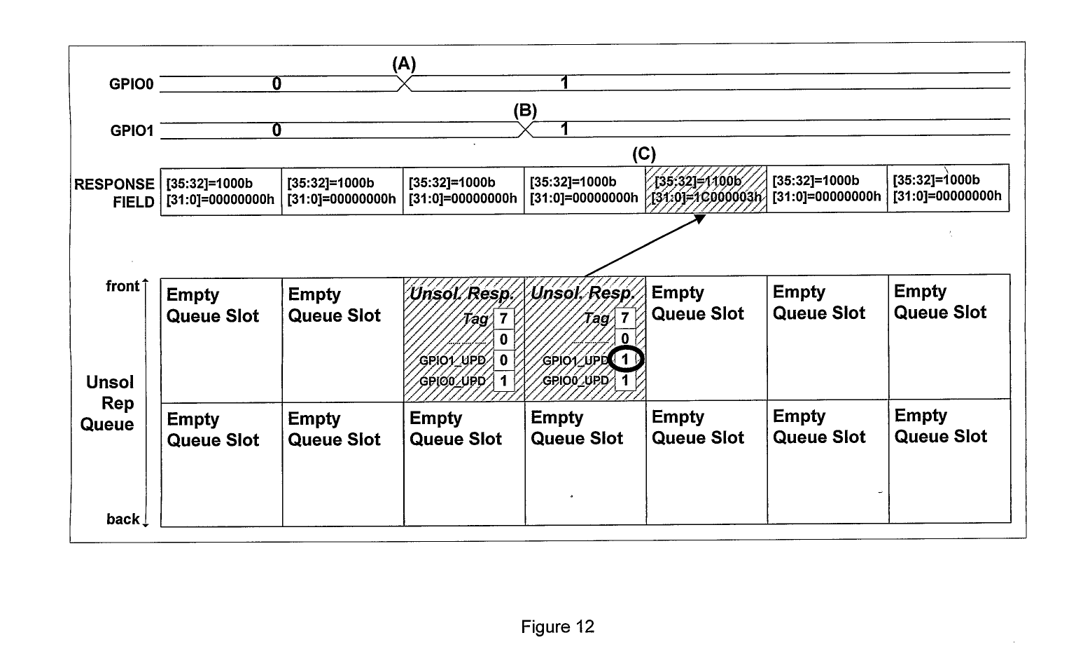

FIG. 12 illustrates, by way of example, how the update means 208 of codec 200 manages and updates unsolicited responses that are awaiting transmission to the controller 102 by using an unsolicited response queue. This unsolicited response queue may be a virtual queue.

Consider the situation where codec 200 contains two unsolicited response sources GPIO0 and GPIO1. These two unsolicited response sources are independent but their statuses are communicated via unsolicited responses generated from the same node.

As can be seen from FIG. 12, at time (A) the GPIO0 input changes to a 1 and hence the GPIO0_UPD flag asserts and an unsolicited response (tag ID of 07h) is queued. At the time (B), GPIO1 input changes to a 1 before a free slot becomes available on the HDA link for sending an unsolicited response. As both GPIO0 and GPIO1 belong to the same node, the queued unsolicited response is updated in the transmission queue to also reflect the latest status of the GPIO1 pin. At time (C), a transmission slot becomes available for sending an unsolicited response and the updated unsolicited response is transmitted with the latest payload data, reflecting the changes in status of both GPIO0 and GPIO1.

As will be apparent, any number of updates may be made to the queued unsolicited response. Also, though not shown in FIG. 12, if the GPIO input changed back to 0 before the transmission of the queued unsolicited response, the queued unsolicited response would be updated to reflect the current status of the GPIO0 input.

Another example of the operation of the codec according to the present invention follows.

Consider a codec in which three nodes are enabled to generate unsolicited responses, these being the audio function group (AFG) node, the SPDIF IN node and the PORT A node and the following events occur in the codec in the following order, which trigger separate unsolicited responses to be generated from their respective nodes:

(1) An external device (e.g. TOSlink cable) is plugged in to the SPDIF input port.

(2) GPIO 1 is set high by an external circuit.

(3) The SPDIF receiver declares lock.

(4) An external device is plugged in to Port A (e.g. headphones).

(5) GPIO 1 is set low by an external circuit

Events 1 and 3 cause unsolicited responses to be generated by the SPDIF IN node. Events 2 and 5 cause unsolicited responses to be generated by the AFG node. Event 4 causes an unsolicited response to be generated by the PORT A node.

If these unsolicited responses are generated when there are no available slots to send immediate responses, the unsolicited responses will be queued until transmission slots are available to transmit them to the controller 202.

In this example, the following responses will be sent to the controller:

| | Payload information |
|---|---|
| AFG | GPIO 1, status update, both rising and falling edges |
| SPDIF IN | Jack insert detected and/or S/PDIF lock |
| PORT A | Jack insert detected |

Thus, although there were five events, only three unsolicited responses are sent to the controller, because two of the responses are updated while held in the queue:
AFG GPIO1 status flag changed from rising edge only, to both edges detected (i.e. GPIO 1 is set high and is then set low); and
SPDIF IN had two separate event flags set high.

The updating means as described above may be used in combination with the unsolicited response management means as described in relation to FIGS. 8 to 10, as will be apparent to the skilled person.

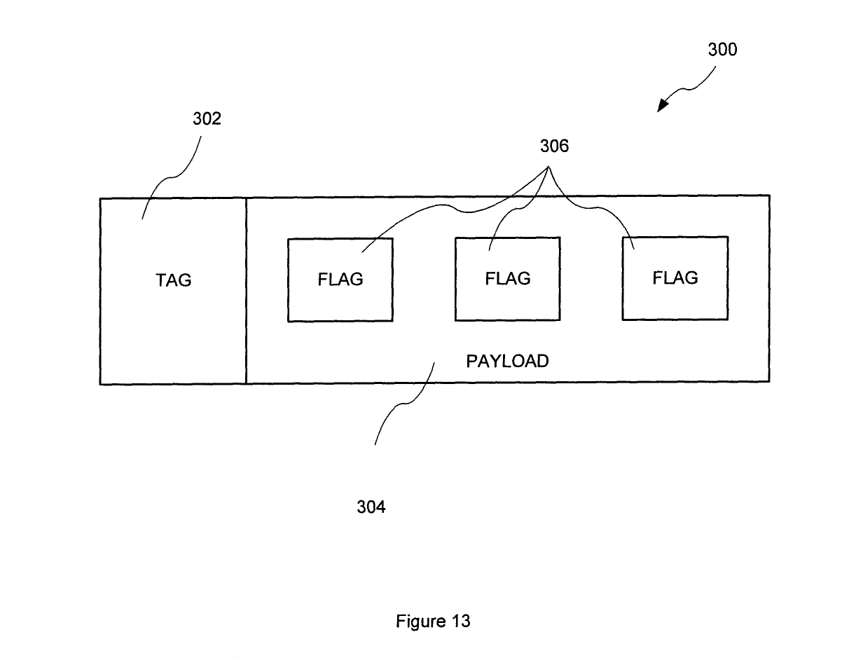

FIG. 13 schematically illustrates the format of an unsolicited response 300 according to an example. Unsolicited response 300 comprises a tag 302, which is used to indicate which unsolicited response source the unsolicited response was generated from. Unsolicited response 300 further comprises a payload 304, which contains one or more unsolicited response flags 308 for informing the HDA controller about the status change of the unsolicited response source(s).

The or each unsolicited response flag 306 is integrated in the unsolicited payload content 306. The purpose of the unsolicited response flag 306 is, to indicate as much information as possible to the HDA controller to avoid the requirement for further subsequent status reads of the HDA codec verbs, in order to establish the current status of the codec due to an event which generated the unsolicited response.

A state change of an unsolicited response source will trigger an unsolicited response to be generated from that source. However, it is possible that a state change can occur more than once while an unsolicited response is awaiting transmission to the HDA controller.

Various kinds of unsolicited response flag may be provided. A first unsolicited response flag 306 that may be provided is an unsolicited response status flag. The unsolicited response status flag is a 2-bit flag that is capable of indicating four possible unsolicited response states.

One of the unsolicited response states of the unsolicited response status flag is used to indicate to the HDA controller there has been no change in status of the unsolicited response source from which the unsolicited response is generated. In other words, in the context of multiple status flags, this state indicates to the HDA controller that the unsolicited response source did not generate the unsolicited response.

A second unsolicited response state of the unsolicited response status flag is used to indicate to the HDA controller that that there has been a change in status of an unsolicited response source from which the unsolicited response was generated from a first state to a second state. In other words, this state indicates to the HDA controller that the status of the unsolicited response source has changed a low state to a high state. This flag is capable of informing the HDA controller that a change in status of the unsolicited response source has occurred and what that change in status is, i.e. low state to high state.

A third unsolicited response state of the unsolicited response status flag is used to indicate to the HDA controller that there has been a change in status of the unsolicited response source from which the unsolicited response is generated from a second state to a first. In other words, this state indicates to the HDA controller that the status of the unsolicited response source has changed from a high state to a low state. This flag is capable of informing the HDA controller that a change in status of the unsolicited response source has occurred and what that change in status is, i.e. high state to low state.

A fourth unsolicited response state of the unsolicited response status flag is used to indicate to the HDA controller that there have been multiple changes in status of the unsolicited response source and that the HDA controller is required to read the associated flag status register of the unsolicited response source in order to assess the current status of the unsolicited response source. In other words, this state indicates to the HDA controller that the status of the unsolicited response source has changed multiple times before the unsolicited response has been transmitted to the HDA controller, and that the HDA controller will have to perform further status reads of the HDA codec verbs if it wishes to establish the current status of the codec.

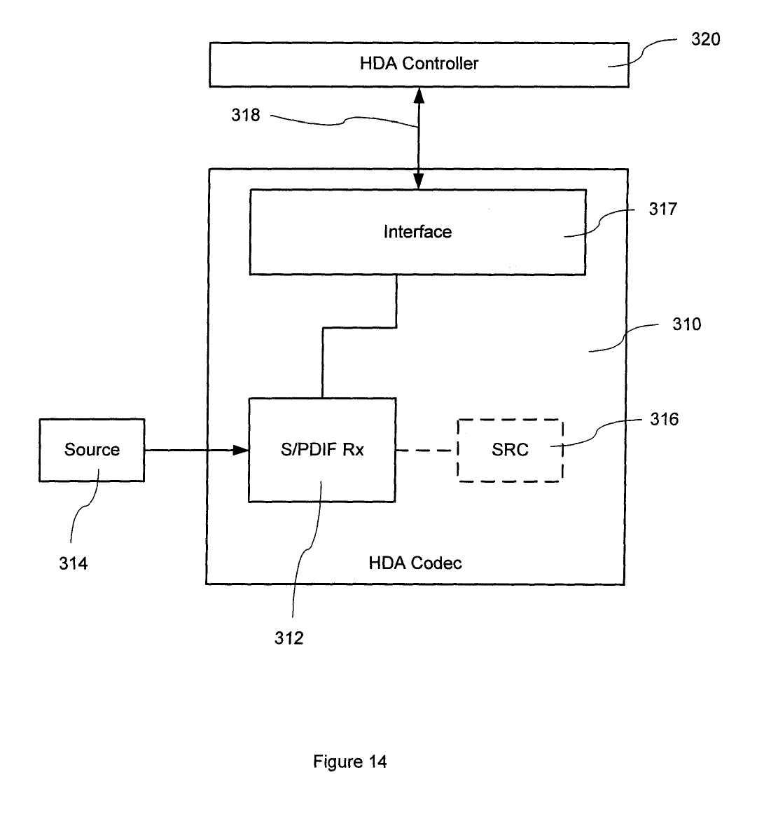

FIG. 14 schematically illustrates a HDA codec 310 in accordance with an example. HDA codec 310 comprises a S/PDIF receiver 312 for receiving an audio data stream from an audio source 314. The S/PDIF receiver 312 is connected via a HDA link interface 317 to a HDA link 318. The S/PDIF receiver 312 may optionally be connected via a sample rate converter 316 to a HDA link 318. The HDA link 318 facilitates serial communication of data from the HDA codec 310 to a HDA controller 320 and vice versa. As will be apparent to the skilled person, though not shown in FIG. 14, HDA codec 310 may also contain a plurality of analogue to digital converters and digital to analogue converters all with associated digital signal processing units which are capable of rendering audio data for transmission to or reception from HDA codec 310.

S/PDIF receiver 312 receives an audio signal from the audio source 314 at a particular sample rate. When S/PDIF receiver 312 determines that the accuracy of the recovered clock and data from the incident S/PDIF audio stream is within specified tolerances (i.e. sample rate of recovered clock within 1% or 2% of nominal sample rate of incident S/PDIF stream), S/PDIF receiver 312 indicates a lock flag condition, indicating S/PDIF receiver confidence in the accuracy of the clock and data.

In an example, when the S/PDIF receiver 312 indicates a lock flag condition, the S/PDIF receiver 312 is arranged to generate an unsolicited response that contains an unsolicited response status flag. For example, this unsolicited response status flag may be a SF_SPDIN flag, which reports the lock status of the S/PDIF receiver to the HDA controller 320.

Consider the situation where the S/PDIF receiver 312 locks. An unsolicited response is generated and queued with an unsolicited response status flag indicating that status of the S/PDIF receiver 312 (unsolicited response source) has changed from a low state to a high state (the second unsolicited response status flag state described above). When this unsolicited response is transmitted to the HDA controller, the HDA controller 320 is informed that the S/PDIF receiver has locked.

In this example, HDA controller 320 is informed of the lock condition of S/PDIF receiver 312, without the need for the HDA controller 320 to request a solicited response to read the associated status verb of the S/PDIF receiver. This is advantageous, as it reduces traffic transmitted over the HDA link 318, and allows more free transmission slots for the transmission of any unsolicited responses that are awaiting transmission.

Consider the situation where S/PDIF receiver 312 enters an unlock condition, while the original unsolicited response is still awaiting transmission to the HDA controller 320. In this situation, the unsolicited response status flag in the waiting unsolicited response will be updated to the state indicating that there have been multiple changes in status of the unsolicited response source and that the HDA controller will need to read the associated flag status register of the unsolicited response source in order to assess the current status of the unsolicited response source (the fourth unsolicited response status flag state described above). In this case the HDA controller 320 will have to read the associated status verb of the S/PDIF receiver 312 in order to determine the actual status of the S/PDIF receiver 312 as multiple lock flag transitions may have occurred.

A second unsolicited response flag 306 that may be provided is an unsolicited response update flag. The unsolicited response update flag is a single bit flag that is capable of indicating to the HDA controller that there have been one or more changes to the value of a status register of an unsolicited response source. The status register of the unsolicited response source must then be read by the HDA controller in order for the HDA controller to determine the current register value and the status of the unsolicited response source.

Consider the HDA codec 310 shown in FIG. 14. If the S/PDIF receiver 312 detects that the S/PDIF receiver channel status data has changed, S/PDIF receiver 312 updates the S/PDIF receiver channel status data in its register and generates an unsolicited response update flag for transmission to the HDA controller 320 within an unsolicited response informing the HDA controller 320 that said updating has occurred. For example this unsolicited response update flag is a UF_CSUD_DC Channel Status Update flag, which when asserted indicates to the HDA controller 320 that the S/PDIF receiver channel status data has been updated and the HDA controller 320 must then read the appropriate channel status registers of the S/PDIF receiver 312 in order to determine the updated data.

A third unsolicited response flag 306 that may be provided is an unsolicited response event flag. The unsolicited response event flag is a single bit flag that is capable of indicating to the HDA controller that an event has occurred. The occurrence of an event in the HDA codec triggers the generation of an unsolicited response from the unsolicited response source associated with the source of the event. The unsolicited response event flag acts to report the event source to the HDA controller.

Consider the HDA codec 310 shown in FIG. 14. S/PDIF receiver 312 receives an S/PDIF audio stream from source 314. S/PDIF receiver 312 recovers this data for transmission to HDA controller 320 via HDA link 318. If the HDA codec 310 comprises a plurality of additional signal sources (not shown in FIG. 14), trying to transmit data through HDA link 318, there may arise a situation where an oversubscription (overflow condition) occurs in a frame on the SDI signal of the HDA link 318. This is because each frame of the SDI signal only contains 500 bits of data. In this situation, the HDA specification requires that one or more streams be omitted (dropped from the frame) to bring the number of bits within the prescribed length. Should an oversubscription occur in the HDA codec 310, and it becomes necessary to drop the stream from S/PDIF receiver 312, S/PDIF receiver 312 generates an unsolicited response with a unsolicited response event flag for transmission to the HDA controller 320 informing the HDA controller of the dropped stream. For example this unsolicited response event flag is a EF_STREAM_DROP flag, which when asserted indicates that a stream has been dropped due to oversubscription of the SDI HDA link data line.

As will be apparent to the skilled person, an unsolicited response may be configured to contain any of the unsolicited response status flag, unsolicited response update flag and unsolicited response event flag. An unsolicited response may contain only one of any of the flags. Alternatively, an unsolicited response may contain any number of unsolicited response flags that may be any combination of the unsolicited response status flag, unsolicited response update flag and unsolicited response event flag.

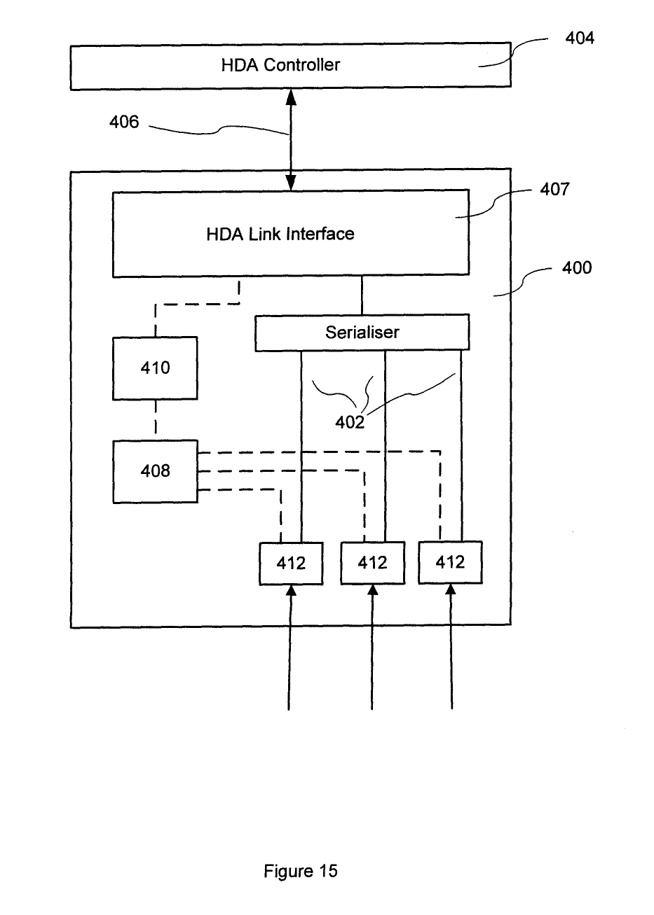

FIG. 15 schematically illustrates a HDA codec 400 in accordance with an example. HDA codec 400 is arranged to transmit a plurality of data streams 402 to a HDA controller 404 via a HDA link 406 and HDA link interface 407. The HDA codec 400 comprises stream oversubscription monitoring means 408 that is arranged to monitor the sample rate and sample size of the plurality of streams in order to detect whether an oversubscription is likely to occur in a next HDA frame. HDA codec 400 further comprises unsolicited response generating means 410 that are arranged to generate an unsolicited response for transmission to the HDA controller 404 via HDA link 406 when the stream oversubscription monitoring means 408 detects that a stream oversubscription is likely to (may) occur.

The stream oversubscription monitoring means 408 are arranged to detect oversubscription by determining whether the total number of bits required in the next HDA frame by the plurality of data streams 402 exceeds the total number of bits available on the SDI data line. A stream with a sample rate that is less than the native sample rates of 44.1 kHz or 48 kHz, will not present a sample for transmission every frame. For example, if a stream has a sample rate of 24 kHz, a sample will only be provided for transmission every other frame. If a stream is present with a sample rate less than the native rates, when determining if an oversubscription will occur, the stream oversubscription monitoring means 428 assumes that a sample will be present for that stream in the next frame, regardless of whether or not it will be. The oversubscription monitoring means 428 are therefore operable to determine whether or not an oversubscription may (is likely to) occur in a next frame.

If the stream oversubscription monitoring means 408 determines the total number of bits required by the plurality of data streams 402 is likely to exceed 464 bits (500 bits minus the 36 bits required for the response field) then the unsolicited response generating means 410 are arranged to generate an unsolicited response for transmission to the HDA controller 404, informing the HDA controller 404 of the oversubscription.

When the stream oversubscription monitoring means 408 determines that the number of bits required in the next HDA frame by the plurality of data streams 402 exceeds the total number of bits available on the SDI data line, the HDA codec 400 is arranged to terminate one of the plurality of streams 402 from the next frame in order to prevent the oversubscription. The codec 400 determines which of the plurality of streams to terminate based on a stream ID value that is assigned by the HDA controller 404 to each of the plurality of streams 402. The stream ID values are assigned based on priority or logically assigned to the plurality of streams 402 by the HDA controller 404 based on the order in which each stream starts. The stream ID values may be assigned in a numerical sequence (1, 2, 3, . . . ) such that the stream that has started most recently is assigned the highest stream ID value.

The HDA codec 400 is arranged to drop the stream with the highest assigned stream ID value. Alternatively, the HDA codec 400 may be arranged to drop the stream with the lowest assigned stream ID value. The stream with the highest or lowest stream ID value may be found using a search routine, or by direct comparison of the stream IDs.

Each of the plurality of streams 402 is associated with one of a plurality of converter nodes 412. The converter nodes may typically be ND converters but the term is also intended to apply to the other sources of a stream such as a S/PDIF receiver. When one of the plurality of streams is determined to be dropped, the converter node 412 that is associated with the dropped stream is arranged to generate an unsolicited response for transmission to the HDA controller 404, indicating to the HDA controller 404 that the associated stream has been dropped from the frame. In this way, the controller can be alerted to any loss of data caused by dropping the stream from the next frame.

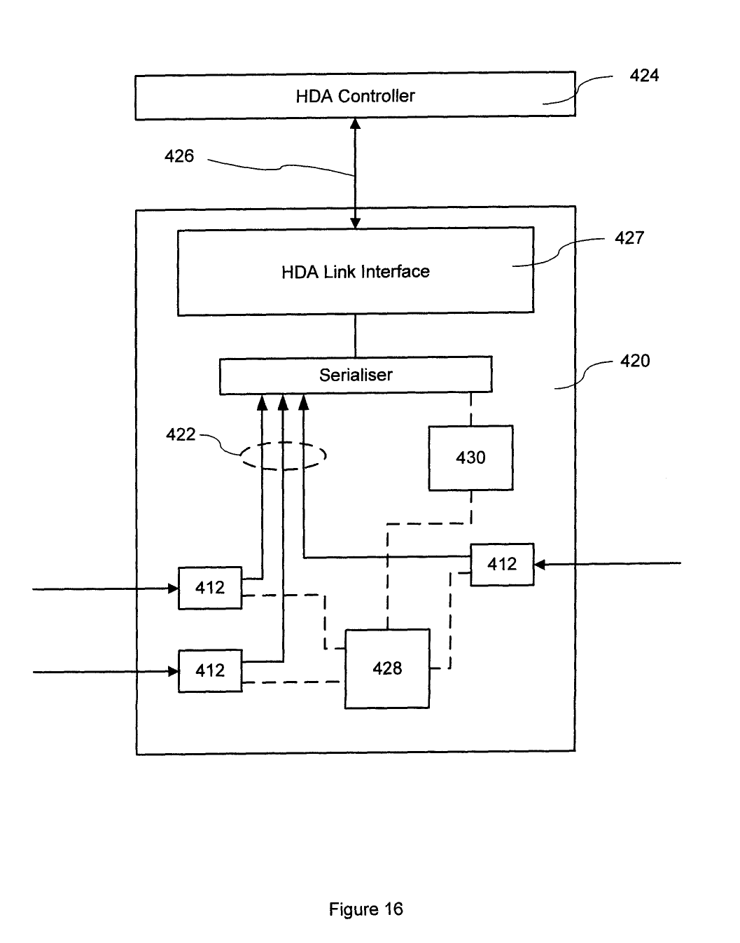

FIG. 16 schematically illustrates another example, in which a codec 420 is arranged to transmit a plurality of data streams 422 to a HDA controller 424 via a HDA link 426 and HDA link interface 427. The HDA codec 420 comprises stream oversubscription monitoring means 428 that are arranged to monitor the sample rate and sample size of the plurality of streams in order to detect whether an oversubscription will occur. HDA codec 420 further comprises stream termination means 430, which are arranged to terminate at least one of the plurality of streams 422 to be transmitted in the next HDA frame in the event that the stream oversubscription monitoring means 428 determines that an oversubscription has occurred. The stream termination means 430 are arranged to terminate one or more of the plurality of streams 422 from the next HDA frame.

The stream oversubscription monitoring means 428 are arranged to detect oversubscription by determining whether the total number of bits required in the next HDA frame by the plurality of data streams 422 exceeds the total number of bits available on the SDI data line. If the stream oversubscription monitoring means 428 determines the total number of bits required by the plurality of data streams 422 exceeds 464 bits (500 bits minus the 36 bits required for the response field of a SDI HDA frame) then the stream termination means 430 of codec 420 are arranged to terminate one or more of the plurality of streams 422 from the next frame in order to prevent the oversubscription. A stream with a sample rate that is less than the native sample rates of 44.1 kHz or 48 kHz, will not present a sample for transmission every frame. For example, if a stream has a sample rate of 24 kHz, a sample will only be provided for transmission every other frame. If a stream is present with a sample rate less than the native rates, when determining if an oversubscription will occur, the stream oversubscription monitoring means 428 assumes that a sample will be present for that stream in the next frame, regardless of whether or not it will be. The oversubscription monitoring means 428 are therefore operable to determine whether or not an oversubscription may (is likely to) occur in a next frame.

The stream termination means 430 determines which of the plurality of streams to drop based on a stream ID value that is assigned by the HDA controller 424 to each of the plurality of streams 422. The stream ID values are assigned based on priority or logically assigned to the plurality of streams 422 by the HDA controller 424. The stream ID values may be assigned in a numerical sequence such that the stream that has started most recently is assigned the highest stream ID value.

The HDA codec 420 is arranged to terminate the stream with the highest assigned stream ID value. In this case, the stream that has started most recently will be terminated.

Alternatively, the HDA codec 420 may be arranged to drop the stream with the lowest assigned stream ID value. The stream with the highest or lowest stream ID value may be found using a search routine or direct comparison of the stream IDs.

The stream termination means 430 are arranged to restore to the next SDI HDA frame a stream that has previously been terminated, upon the HDA controller 424 assigning a non-zero stream ID value to that stream. However, the stream termination means 430 will only restore the terminated stream when the stream oversubscription monitoring means 428 determines that the restoration will cause no oversubscription. If the oversubscription monitoring means 428 determines that the restoration will cause an oversubscription, the stream will not be restored, and an unsolicited response will be generated for transmission to the HDA controller 424, notifying the HDA controller 424 of this.

In an example, the stream oversubscription monitoring 428 comprises a state machine that incorporates a look-up-table that is arranged to step through the plurality of streams 422 and calculate a running total of the required number of bits for transmission of the plurality of stream 422 in an SDI HDA frame.

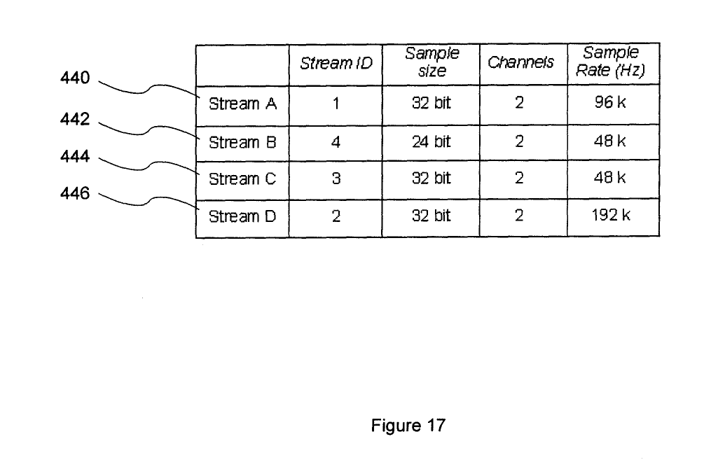

FIG. 17 is a table showing an example of the stream set up of HDA codec 420 of FIG. 16, in which four streams are present.

The first stream 440 is associated with a stream source A and has been assigned a stream ID value of 1 by the HDA controller 424. It has a sample size of 32 bits, has 2 channels and a sample rate of 96 kHz.

The second stream 442 is associated with a stream source B and has been assigned a stream ID value of 4 by the HDA controller 424. It has a sample size of 24 bits, has 2 channels and a sample rate of 48 kHz.

The third stream 444 is associated with a stream source C and has been assigned a stream ID value of 3 by the HDA controller 424. It has a sample size of 32 bits, has 2 channels and a sample rate of 96 kHz.

The fourth stream 446 is a S/PDIF stream and is associated with a stream source D and has been assigned a stream ID value of 2 by the HDA controller 424. It has a sample size of 32 bits, has 2 channels and a sample rate of 192 kHz.

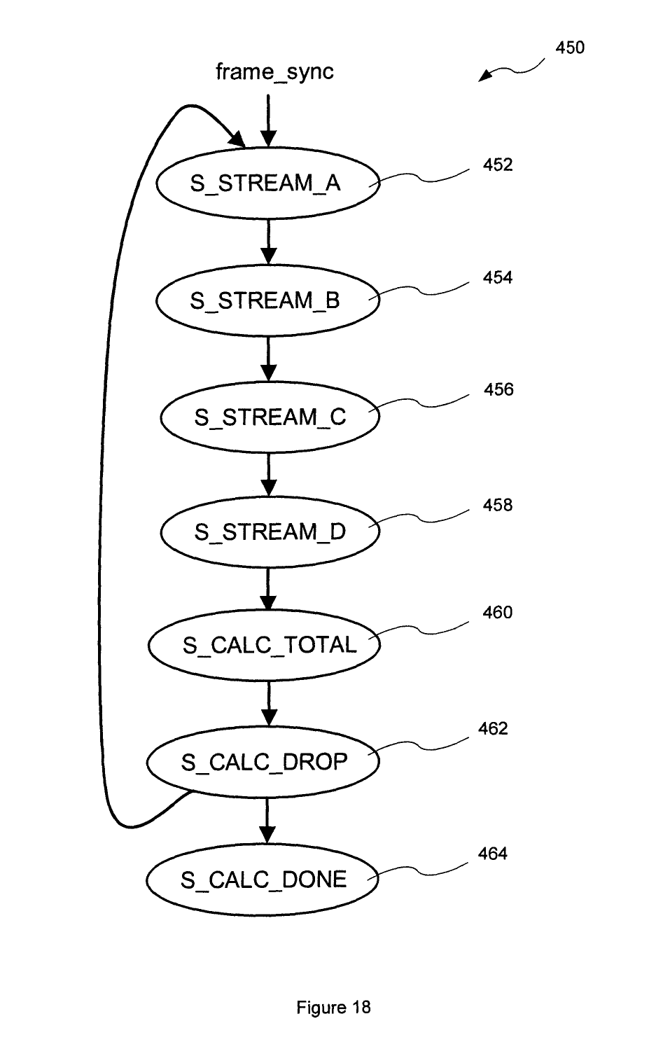

FIG. 18 illustrates a state machine 450 according to an example, which is arranged to step through the streams shown in FIG. 17. As stated previously, the frame sync marker that is transmitted from the HDA controller 424 to the HDA codec 420 on the SYNC data line of the HDA link 426 indicates the start of a new HDA frame. At the start of a new frame, state machine 450, at step 452, clears the running total in the stream termination means 430 and latches the format data for stream A. The stream termination means 430 consults a look-up-table in order to quickly determine the number of bits required to transmit stream A in the SDI HDA frame. The look-up-table contains an entry (number of bits per frame) associated with every possible stream configuration (combination of sample size, number of channel and sample rate) that is supported by the HDA codec 420. Due to the processing capacity of the codec relative to the controller, use of a look-up-table is advantageous as it reduces the number of calculations that need to be performed by the codec.

At step 454, the state machine 450 adds the stream size for stream A to the running total, and stores (records) the format data for stream B. The stream termination means 430 uses the format data to interrogate the look-up-table in order to quickly determine the number of bits required to transmit stream B in the SDI HDA frame.

At step 456, the state machine 450 adds the stream size for stream B to the running total, and latches the format data for stream C. The stream reducing means 430 consults the look-up-table in order to quickly determine the number of bits required to transmit stream C in the SDI HDA frame.

At step 458, the state machine 450 adds the stream size for stream C to the running total, and latches the format data for stream D. The stream reducing means 430 consults a look-up-table in order to quickly determine the number of bits required to transmit stream D in the SDI HDA frame.

At step 460, the state machine 450 adds the stream size for stream D to the running total.

At step 462, it is determined if the running total exceeds the maximum number of bits allowed for a SDI HDA frame. If the maximum number is not exceeded, all of the streams are transmitted. If the maximum number is exceeded, the stream with the highest stream ID value is determined and dropped. The stream with the highest stream ID value may be determined by using twelve comparators.

If the state machine 450 is on a first pass, the calculation is repeated in order to determine if it is necessary for another stream to be terminated. As stream D is a S/PDIF stream, it is necessary to add stream D to the running total again, in order to check that there is enough room for transmission of stream D. This is because stream D is allocated twice its nominal required space, in order to take into account any deviations in the actual size of the S/PDIF signal from the expected size of the S/PDIF signal. That is, a S/PDIF stream having a given nominal sample rate may vary somewhat in practice from the nominal sample rate, such that more data than expected is generated at some times due to the sample rate of the S/PDIF stream being determined by the S/PDIF source.

If the state machine 450 is not on a first pass, the state machine continues to step 464, in which the streams that are required to be terminated are terminated and the state machine waits for a new frame sync marker.

The state machine calculation is performed by the stream termination means at the start of each HDA frame. The calculation must complete during the response phase of the frame (the time taken for the response field to be transmitted), in order to ensure no oversubscription occurs for that frame.

As will be apparent to the person skilled in the art, the state machine shown in FIG. 18 could be modified to step through more streams that may be active in a codec than given in the above example, by adding further addition steps to the running total. For example, the state machine may perform any number of additional passes or iterations to check for oversubscription and as will be apparent to the skilled person, the invention is not limited to two passes.

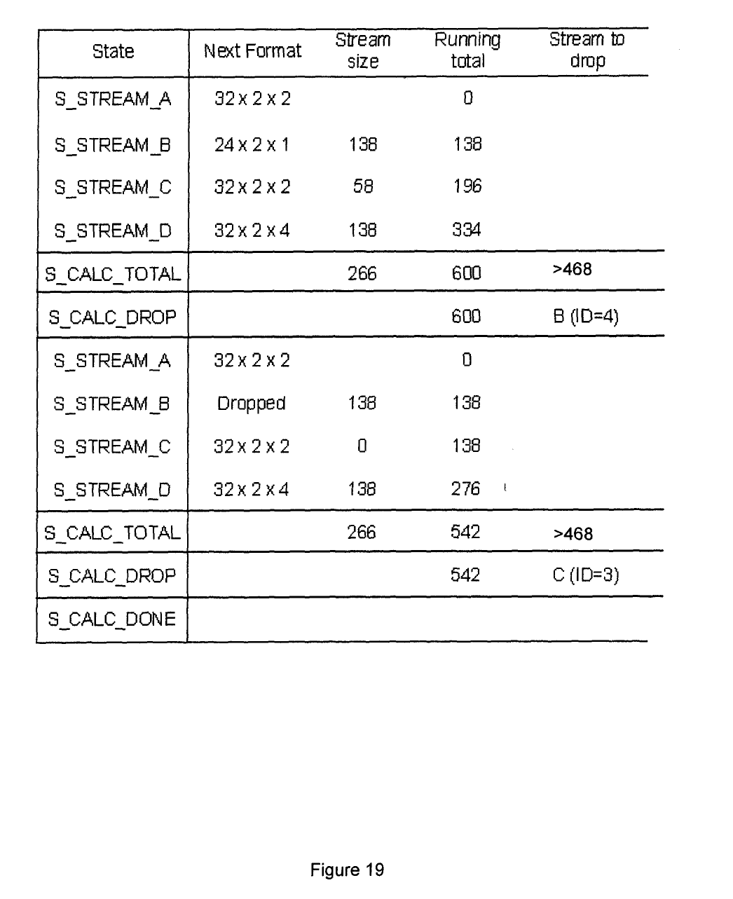

FIG. 19 shows a table illustrating the calculations of the state machine shown in FIG. 18 for the streams described in FIG. 17. It should be noted that the native sample rates of a HDA frame are 48 kHz and 44.1 kHz. Therefore, a sample rate of 96 kHz will require twice the normal bandwidth and a sample rate of 192 kHz will require four times the normal bandwidth. It should also be noted that each stream must start with a 10 bit header, which must also be included in the bandwidth calculation along with data bits and that there are 500 bits available in each frame, of which 36 are needed for the response field, leaving 464 bits for sample and header data.

FIG. 19 illustrates the state machine of FIG. 18 as it steps through the streams adding to the running total. The next format column shows the look-up table calculations and the stream size column shows the stream size value that is retrieved from the look-up table for each particular stream. In an alternative configuration, the codec itself may perform the stream size calculations rather than retrieving the values from a look-up table.

As can be seen in FIG. 19, on a first pass, there is an oversubscription, and the stream reducing means 430 selects stream B to drop as it has the highest stream ID value.

On the second pass, as the running total still exceeds the 464 bit limit, the stream reducing means 430 selects stream C to drop as it has the highest stream ID value of the remaining streams.

The calculations may be performed in multiples of 2 (i.e. based on half the actual number of bits), in order to reduce the complexity of the calculations, as streams are always of an even size.

In a modification to the state machine described in relation to FIGS. 18 and 19, an additional checking step may be included immediately before the S_CALC_DONE step 464. This additional checking step includes determining if the running total, after the S_CALC_DROP step 462 has been performed, is less than 464 bits (500 bits available on SDI minus the 36 bits for the response field). In the example shown in FIG. 19, this additional check may be performed only once (i.e. after the second S_CALC_DROP step), or twice (i.e. after each S_CALC_DROP step).

In addition to the above problem of oversubscription on SDI, a similar issue exists with respect to SDO except that, by definition, an HDA codec cannot receive data in excess of the maximum SDO capacity (1000 bits/frame). Thus, an “overload” of SDO manifests itself by errors in the data received by the codec.

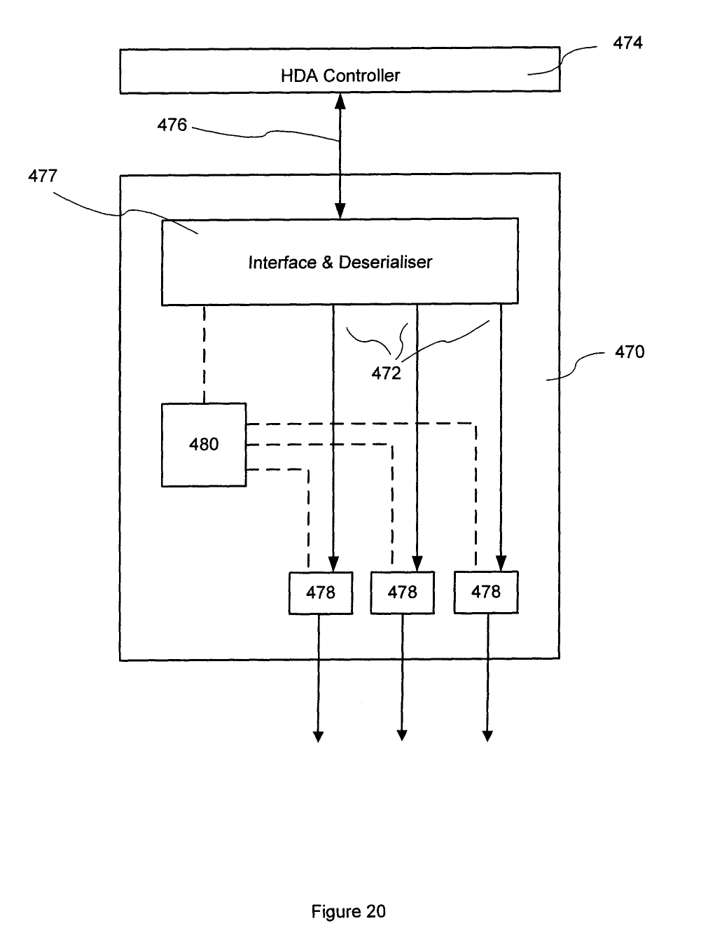

FIG. 20 schematically illustrates a HDA codec 470 that is arranged to receive a plurality of data streams 472 from a HDA controller 474 via an SDO signal on a HDA link 476 connected to an interface and deserialiser 477. Each of the plurality of data streams 472 is associated with one of a plurality of converter nodes 478, each having a defined configuration.

HDA codec 470 also comprises stream error monitoring means 480 for monitoring the sample rate and sample size of the received streams 472. The HDA codec 470 is arranged to generate an unsolicited response for transmission to the HDA controller 474, when the stream error monitoring means 480 detects a discrepancy between the configuration of any of the plurality of converter nodes 478 and the data presented to them from the SDO signal on the HDA link 476. In other words, in addition to the oversubscription protection offered by the HDA controller 474, HDA codec 470 includes hardware that will generate an unsolicited response for transmission to the HDA controller 474, should the stream error monitoring means 480 detect any discrepancies between what it was expecting to receive and what was actually received.

The HDA codec 470 may be arranged such that each converter node 478 can generate an unsolicited response if the stream error monitoring means 480 detects any discrepancy between what that node was configured to receive and what was actually received. In other words, each converter node 478 can generate an unsolicited response if it is ‘starved’ of data due to HDA link undersubscription, or if too much data is provided due to HDA link oversubscription. The HDA controller 474 is then made explicitly aware that an issue exists in the HDA codec 470.

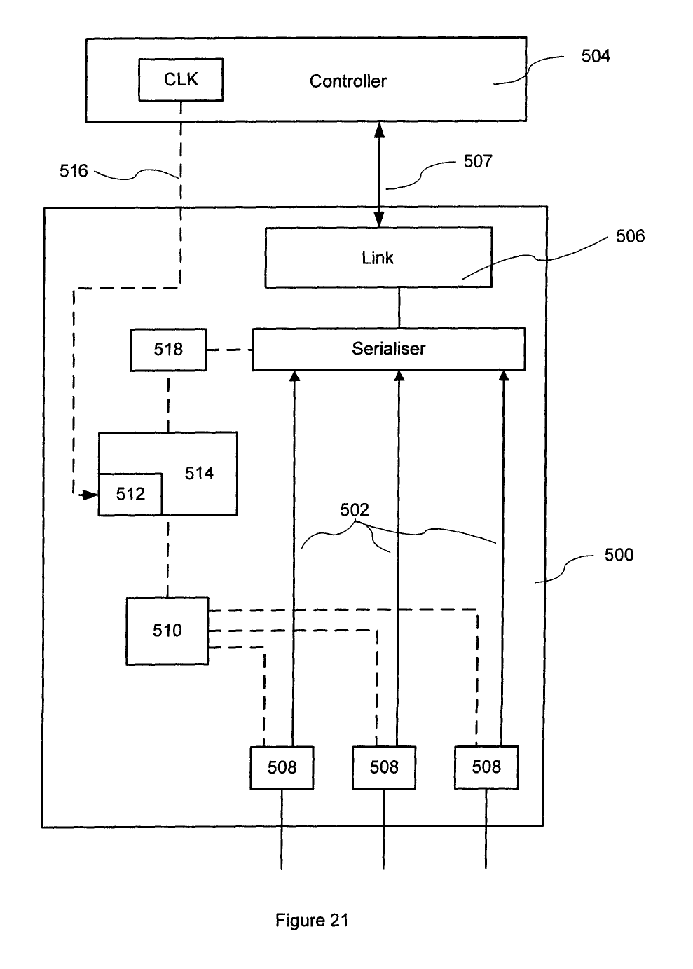

FIG. 21 illustrates a codec 500 in accordance with an example of the present invention. Codec 500 is arranged to transmit a plurality of data streams 502 to a controller 504 via a serial interface 506 and serial bus 507. The transmission is controlled based on a clock signal 516 which is shown separately which may be carried by bus 507. Each of the data streams 502 is associated with a stream source 508 and each is assigned an identification value by the controller 504.

As will be apparent to the person skilled in the art, codec 500 may be a HDA codec, the controller may be a HDA controller, and the communication may occur via a HDA link. Alternatively, codec 500 may be a SLIMbus component or any codec, audio or otherwise that communicates with a controller in discrete time slots and is capable of generating status reports. The following description will describe an example in which codec 500 is a HDA codec, streams 502 are audio streams, controller 504 is a HDA controller, serial interface 506 is a HDA link interface, serial bus 507 is a HDA link and stream sources 508 are audio sources such as converter nodes processing analogue inputs of the codec.

Codec 500 comprises stream enable detection means 510 arranged to determine which of the plurality of streams are enabled and ready for transmission to the controller 504. A stream is enabled and ready for transmission to the controller, when the buffer (FIFO) of the converter (not shown in FIG. 21) associated with each stream has sufficient data for transmission of a sample.

A counter 512 is provided within codec 500 that is arranged to increment a count value at each cycle of the clock signal 516 from the controller 504. In this example, clock signal 516 is the base clock signal (BCLK) signal generated by the controller.

The codec further comprises stream ordering means 514 arranged to compare at each incremented count value, the current count value with the identification value assigned to each of the plurality of streams 502. In this example, the identification value is the stream identification value that is assigned by the controller 504. The controller 504 may assign the identification value arbitrarily or logically in numerical sequence.

When the current count value matches the stream identification value of a stream, the stream ordering means 514 is arranged to record the stream source associated with that stream in a transmission sequence. The ordering means 514 stores the transmission sequence in storage means 518 and transmits the plurality of data streams 502 to the controller 504, by referring to the stored transmission sequence to determine the next stream to be transmitted.

The counter 512 increments the count value for a predetermined number of cycles of the clock signal, and resets the count value when the predetermined number of cycles of the clock signal have completed. This allows a new count to be started for every frame.

The codec transmits the streams in a plurality of sequential frames and transmits each enabled stream once per frame in the order in which it is recorded in the transmission sequence.

The storage means 518 is a stream order matrix in an example of the present invention, which is updated at each clock cycle to include the results of the comparison for each incremented count value. After the predetermined number of cycles have completed, the stream order matrix stores the stream sources associated with the plurality of streams in ascending order of stream identification values.

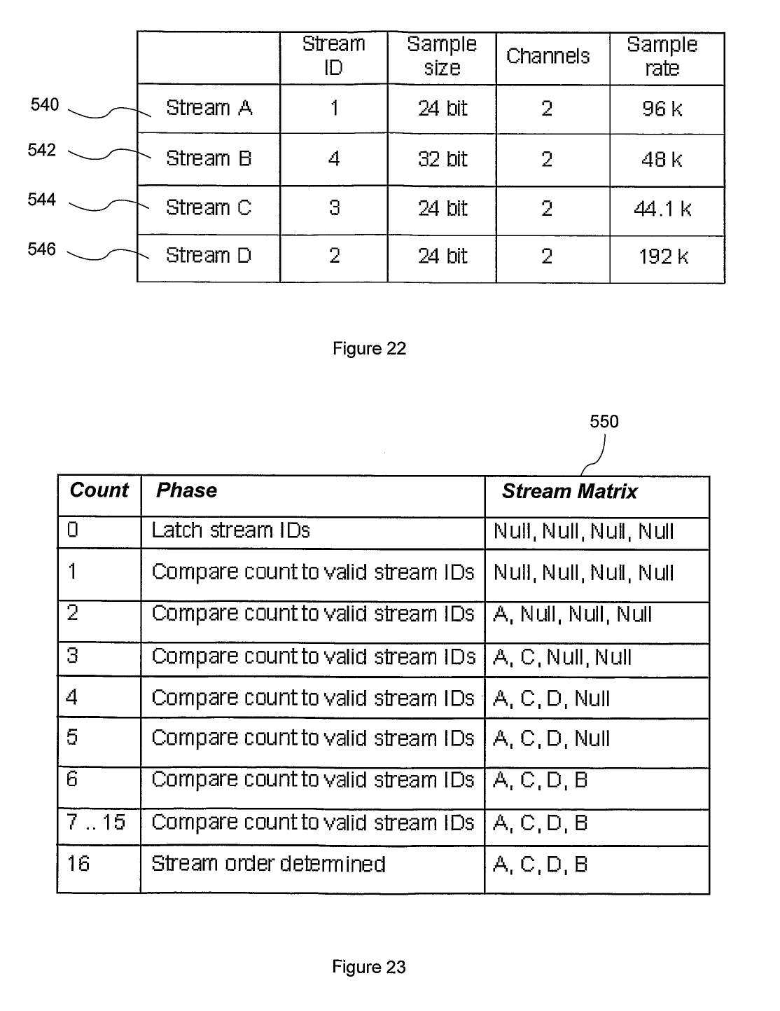

FIG. 22 is a table showing an example of the stream set up of codec 500 of FIG. 21, in which four streams are present.

The first stream 540 is associated with a stream source A and has been assigned a stream ID value of 2 by the HDA controller 504. It has a sample size of 24 bits, has 2 channels and a sample rate of 96 kHz.

The second stream 542 is associated with a stream source B and has been assigned a stream ID value of 6 by the HDA controller 504. It has a sample size of 16 bits, has 2 channels and a sample rate of 48 kHz.

The third stream 544 is associated with a stream source C and has been assigned a stream ID value of 3 by the HDA controller 504. It has a sample size of 24 bits, has 2 channels and a sample rate of 44.1 kHz.

The fourth stream 546 is associated with a stream source D and has been assigned a stream ID value of 4 by the HDA controller 504. It has a sample size of 24 bits, has 2 channels and a sample rate of 48 kHz.

FIG. 23 shows the stream order calculation of the streams shown in FIG. 22 and the resultant stream order matrix 550.

As can be seen in FIG. 23, the count is incremented from 0 to 16. At the count 0, the stream identification values (IDs) are latched. That is, the stream ordering means 514 makes a note of the stream identification values of the enabled streams. The stream ordering means 514 steps through each count, comparing the current count value with each of the stream IDs.

When the count value reaches 2, the stream ordering means determines that the ID value of stream A matches the current count and so records the stream source A in the stream matrix 550.

When the count value reaches 3, the stream ordering means determines that the ID value of stream C matches the current count and so records the stream source C in the stream matrix 550.

When the count value reaches 4, the stream ordering means determines that the ID value of stream D matches the current count and so records the stream source D in the stream matrix 550.

When the count value reaches 6, the stream ordering means determines that the ID value of stream B matches the current count and so records the stream source B in the stream matrix 550.

The resultant stream order matrix is determined when the count reaches 16, at which point in this example the determined stream order is A, C, D, B. It should be noted that 16 is the highest stream ID permitted by the HDA specification.

The codec 500 will transmit the streams to the controller 504 via the serial link 506, by referring to the stream order matrix to see which stream should be transmitted next.

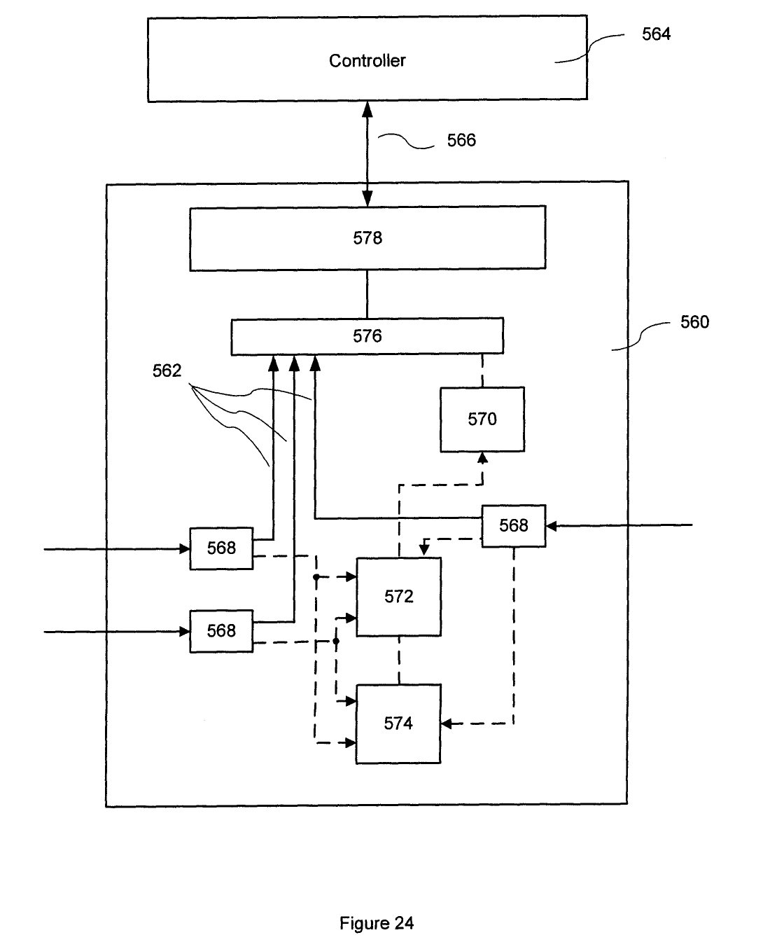

FIG. 24 schematically illustrates a codec 560 in accordance with another example of the present invention. Codec 560 is arranged to transmit a plurality of data streams 562 to a controller 564 via a serial bus 566 connected to a serial interface 578 in the codec. The transmission is controlled based on a clock signal (not shown in FIG. 24). Each of the data streams 562 is associated with a stream source 568 and each is assigned an identification value by the controller 564. Transmission from the codec 560 to the controller 564 is made in units of a sample block, each containing one or more samples of a stream.

As will be apparent to the person skilled in the art, codec 560 may be a HDA codec, the controller 564 may be a HDA controller, the serial bus may be a HDA link 566 and the serial interface may be a HDA link interface. Alternatively, codec 560 may be any codec, audio or otherwise that communicates with a controller in discrete time slots and is capable of generating status reports, for example a SLIMbus Component. The following description will describe an example in which codec 560 is a HDA codec, streams 562 are audio streams, controller 564 is a HDA controller, serial bus 566 is a HDA bus and stream sources 568 are audio sources.

The codec 560 comprises stream ordering means 570, sample size determination means 572, sample number determining means 574, data serialising means 576 and a HDA link interface (transmission means) 578.

The stream ordering means 570 are arranged to set an order for transmission of the plurality of streams 562 according to their assigned identification values. This ordering may be performed using the stream ordering means as described in relation to FIGS. 21 to 23, or may be any other ordering means. The stream ordering means 570 allows one of the plurality of streams to be to be determined as a current stream for transmission.

The sample size determination means 572 is arranged to determine the sample size of the current stream. The sample size determination means 572 may be a look up table, with entries associated with every possible combination of sample size, number of channels and sample rate supported by the codec 560. The sample size determination means 574 is shown referring to each stream source 568 for the sample size, but this information may be held centrally within the codec.

The sample number determining means 574 determines the number of samples per sample block in the current stream. The sample number determining means 574 determines this by investigating the configuration of the converter associated with the current stream. This may be by looking at the MULT and CHAN values in the converter configuration, the MULT value indicating the sample base rate multiple and the CHAN value indicating the number of channels. Again, these values may be stored centrally.

The data serialising means 576 serialise (arrange serially) data for transmission to the controller 564, by requesting a next sample from the associated stream source of the current stream until reaching the number of samples in the sample block and then referring to the stream ordering means to determine the next stream in said order as the current stream. In other words, the data serialising means 576 requests samples from the stream source of the current stream until the number of samples determined by the sample number determining means 574 is reached. At this point, the data serialising means 576 knows that the current sample has finished and obtains the next stream in transmission order determined by the stream ordering means 570. This next stream is determined to be the new current stream for serialisation.

The HDA link interface 578 is arranged to transmit, at each clock cycle, successive bits of the data serialised by the data serialising means 576 over HDA link 566.

In an example of the present invention, the data serialising means 576 comprises a shift register arranged to output bits for transmission one by one at each clock cycle from a transmission end. The shift register is loaded with samples justified at the transmission end of the shift register and is arranged to shift the samples along the shift register one bit every cycle. The result of this is that one bit is outputted from the shift register every clock cycle for transmission to the controller 564.

A cycle counter is also provided that is arranged to count the number of clock cycles; and a sample counter is provided arranged to count the number of samples reached in the sample block. When the clock cycle count number equals the sample size determined for the current stream by the sample size determination means 572, if the sample count has not yet reached the number of samples in the sample block, the data serialising means 576 requests the next sample from the associated stream source of the current stream to reload the shift register, and if the sample count has reached the number of samples in the sample block, the data serialising means 576 requests a sample from the associated stream source of the next stream in order determined by the stream ordering means 570.

The shift register may be arranged to store streams always left justified, with the left most sample containing valid data, in which case the shift register is arranged to shift the streams along the shift register to the left, one bit every cycle of the clock signal, with the left most bit being output from the shift register.

Consider the situation where the stream set up of codec 560 is as shown in FIG. 22. In other words, codec 560 has four valid streams.

The first stream 540 is associated with a stream source A and has been assigned a stream ID value of 2 by the HDA controller 564. It has a sample size of 24 bits, has 2 channels and a sample rate of 96 kHz.

The second stream 542 is associated with a stream source B and has been assigned a stream ID value of 6 by the HDA controller 564. It has a sample size of 16 bits, has 2 channels and a sample rate of 48 kHz.

The third stream 544 is associated with a stream source C and has been assigned a stream ID value of 3 by the HDA controller 564. It has a sample size of 24 bits, has 2 channels and a sample rate of 44.1 kHz.

The fourth stream 546 is associated with a stream source D and has been assigned a stream ID value of 4 by the HDA controller 564. It has a sample size of 24 bits, has 2 channels and a sample rate of 48 kHz.

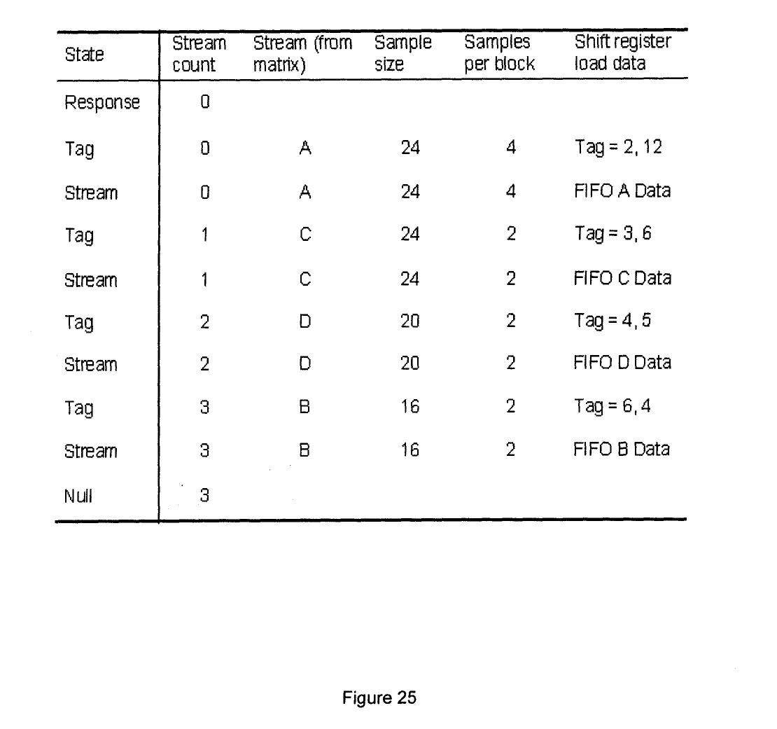

FIG. 25 shows the sequence of states when serialising the data of the streams shown in FIG. 22 in accordance with an example of the present invention.

Before any stream has been transmitted, the stream order is determined by the stream ordering means 570. If all streams have sufficient data ready for transmission, and the streams are ordered according to ascending stream ID the stream order will be A, C, D, B.

Stream A is determined to have 4 samples per block by the sample number determining means 574 as it has 2 channels at twice the base sample rate.

After transmitting the stream tag for stream A, a sample is requested from the buffer (FIFO) of the stream source associated with stream A, and that sample is placed in the shift register. The sample is placed in the shift register justified up to (starting from) the transmission end of the shift register, in this example, the left end of the shift register.

Every clock cycle the contents of the shift register are shifted to the left and the leftmost bit is output from the shift register and transmitted by the HDA link 578. At the same time, the shift counter counts the number of shifts that have occurred. When the shift count equals the sample number size, a new sample is requested from the buffer (FIFO) of the stream source associated with stream A and the sample count is incremented. When the sample count equals the number of samples in the sample block, a sample is requested from the buffer (FIFO) of the stream source associated with the next stream in the order, in this case stream C, and that sample is placed in the shift register. As with stream A, transmission of stream C starts with the transmission of its stream tag and the process repeats until all streams have been transmitted.

This process is shown in FIG. 25, in which it can be seen that the streams are transmitted serially, with no gaps in between. As can be seen in FIG. 25, the tag of each stream contains the stream ID value and the data length (in bytes).

When all of the streams have been sent in a frame, any remaining space in the frame is packed with null data.

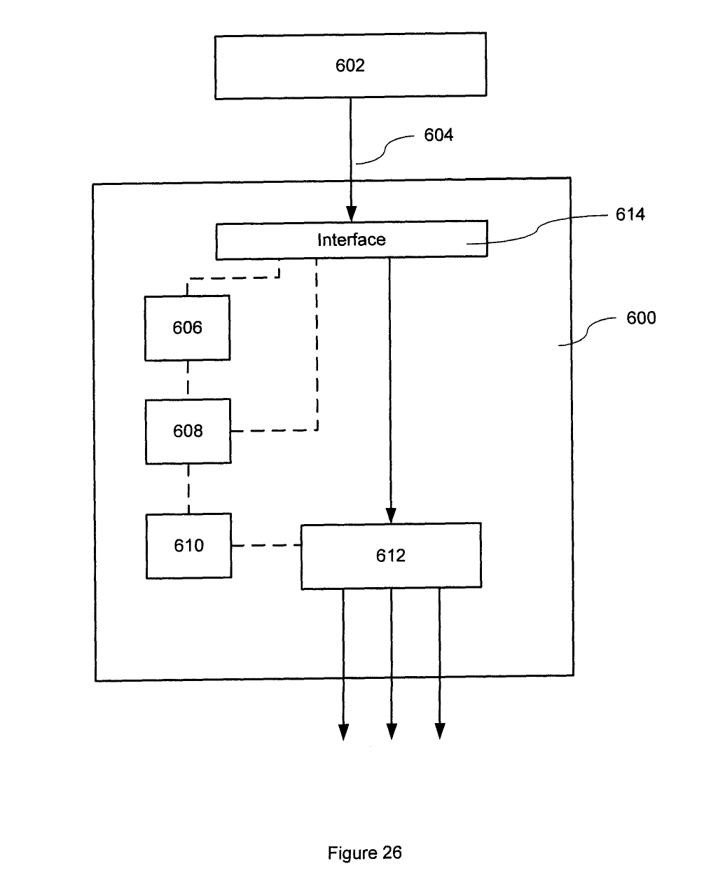

FIG. 26 schematically illustrates a codec 600 that is arranged to receive serial data from an external controller 602 over a serial bus 604. The serial data is formed of a sequence of streams, each of the streams assigned a stream identification value by the controller 602. The streams arrive at an interface 614 of the codec 600 in an unknown order.

The codec 600 comprises recording means 606 that are arranged to receive notification from the controller 602 of the stream identification values that are assigned to the streams that are to be transmitted. This notification is transmitted to the codec 600 over the serial bus 604.

Comparison means 608 are provided that are arranged to compare the stream identification value of each incoming stream as it is received in the serial data signal with the stream identification values recorded by the recording means 606.

If the comparison means determines that the identification value of the current incoming stream matches one of the recorded stream identification values, a selector 610 is arranged is arranged to select stream format settings for that incoming stream. The selector 610 selects the format settings for that incoming stream from a look-up-table that stores the stream format settings in association with each of the notified stream identification values.

The received incoming streams are deserialised by a deserialiser 612 on the basis of the stream format settings that are selected by the selector 610. The stream format settings provide information on the number of bits that are in each sample of the stream. The deserialiser is therefore able to use this information to deserialise the incoming streams into samples.

Deserialised samples are marked as valid when the stream identification value of the stream matches a recorded stream identification value.

As will be apparent to the person skilled in the art, codec 600 may be a HDA codec, the controller may be a HDA controller, and the communication may occur via a HDA link. As already mentioned, however, codec 600 may alternatively be an AC'97 or SLIMbus compliant device, any codec, audio or otherwise that communicates with a controller in discrete time slots over a serial bus and is capable of generating status reports. In this context, “codec” refers to any device or circuitry which is physically distinct from the controller; it should be noted however, that codecs need not be exclusively hardware based. Typically, driver software is used to control functional blocks of the codec under supervision of the controller. The following will describe an example in which codec 600 is a HDA codec.

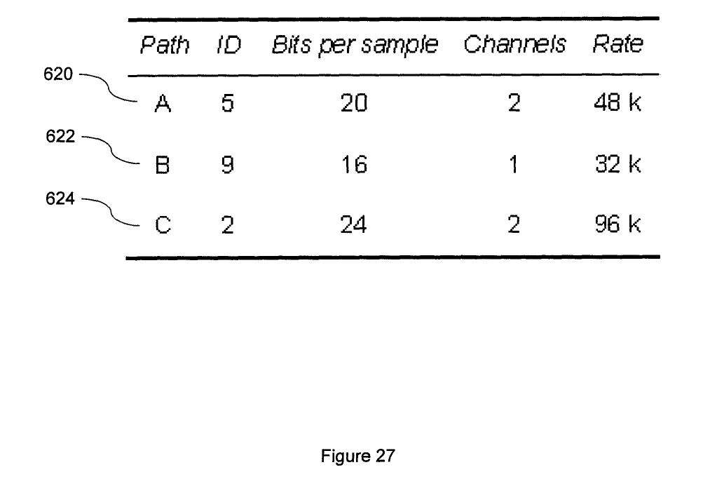

Consider codec 600 to be receiving three streams from the controller 602. Each stream is destined for a separate audio source (not shown) in the codec 600. FIG. 27 is a table showing the stream configuration of these three audio streams, A, B and C.

The first stream 620 is associated with a stream source A and has been assigned a stream ID value of 5 by the HDA controller 602. It has 20 bits per sample, has 2 channels and a sample rate of 48 kHz.

The second stream 622 is associated with a stream source B and has been assigned a stream ID value of 9 by the HDA controller 604. It has 16 bits per sample, has 1 channel and a sample rate of 32 kHz.

The third stream 624 is associated with a stream source C and has been assigned a stream ID value of 2 by the HDA controller 602. It has 24 bits per sample, has 2 channels and a sample rate of 96 kHz.

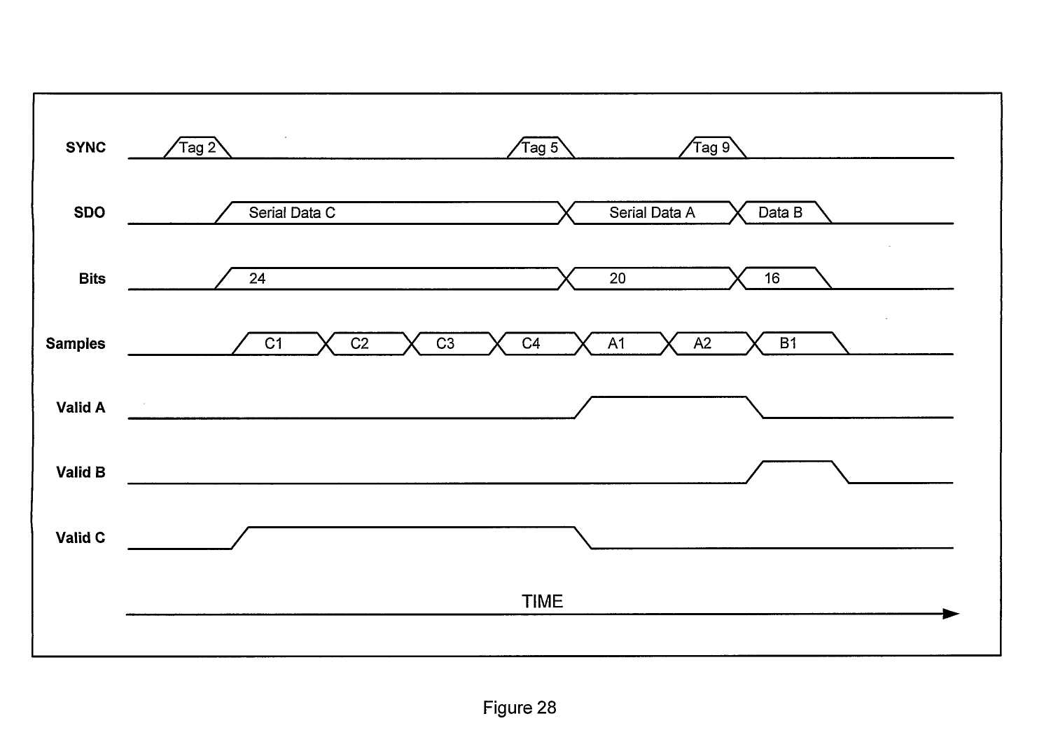

FIG. 28 is diagram showing the flow of the streams A, B and C of FIG. 27 through the codec of FIG. 26.

Firstly, though not shown in FIG. 28, recording means 606 will receive notification of the stream identification values, i.e. A=5, B=9, C=2.

As can be seen in FIG. 28, the first stream tag (which contains the identification value) to be received via the SYNC wire of bus 604 has an identification value of 2. This indicates that stream C is being sent first from the controller 602.

On receiving the stream tag value of 2, the comparison means 608 compares the stream tag value of 2 with stream tag values recorded by the recording means 606. In this case, there is a match, so the selector is arranged to select stream format settings for that stream from a look-up table. The selector 610 selects the stream format setting that the stream C has 24 bits per sample.

The deserialiser 612 can then deserialise stream C into four samples (shown as C1, C2, C3 and C4).

The next stream tag to arrive is the tag with identification value of 5. This indicates that stream A will be received next. Stream A is deserialised into two samples A1 and A2, immediately after stream C has finished being deserialised.

The final tag to arrive is the tag with identification value of 9. This indicates that stream B will be received next. Stream B is deserialised into one sample B1, immediately after stream C has finished being deserialised.

The deserialiser 612 is an instantly reconfigurable deserialiser block. It allows a stream to begin being deserialised at the exact moment the previous stream stops.

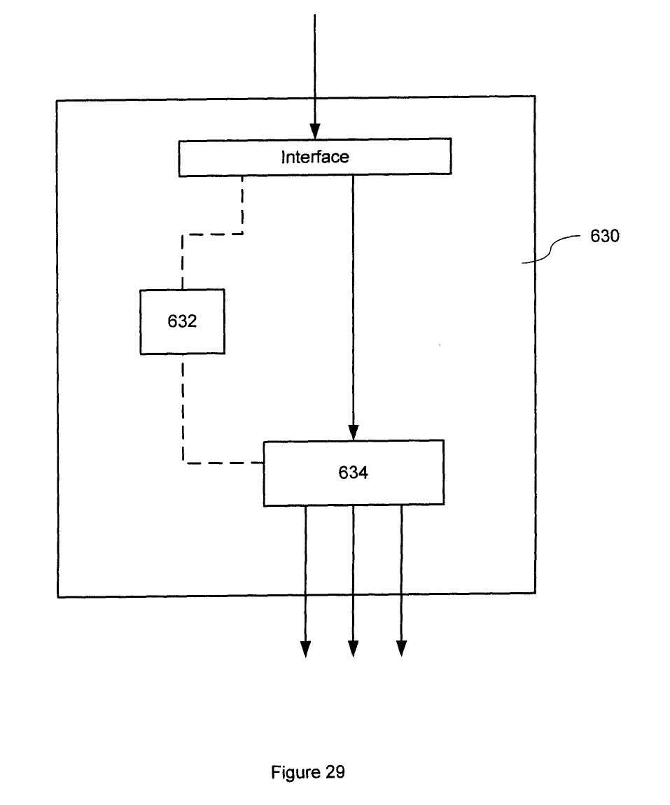

FIG. 29 schematically illustrates a codec 630 that is arranged to receive serial data that is formed of a sequence of digital audio streams. Each audio stream may have a different stream format. Each stream contains a sample block that has at least one sample. The serial data signal defines a bit falling on every falling and rising edge of a clock cycle. In other words, the serial data signal is double pumped.

The codec 630 comprises stream format determination means 632 that are arranged to determine the stream format of each incoming stream as it is received in the serial data signal. The stream format includes information on the number of bits per sample, the number of channels, the sample rate of the sample and the number of samples per sample block.

The determined stream format is used by a deserialiser 634 in order to deserialise the incoming streams into one or more individual samples.

As will be apparent to the person skilled in the art, codec 630 may be a HDA codec, the controller may be a HDA controller, and the communication may occur via a HDA link. Alternatively, codec 630 may be any codec, audio or otherwise that communicates with a controller in discrete time slots and is capable of generating status reports. In this context, “codec” refers to any device or circuitry, which is physically distinct from the controller; it should be noted however, that codecs need not be exclusively hardware based. Typically, driver software is used to control functional blocks of the codec under supervision of the controller. The following will describe an example in which the codec 630 is a HDA codec.

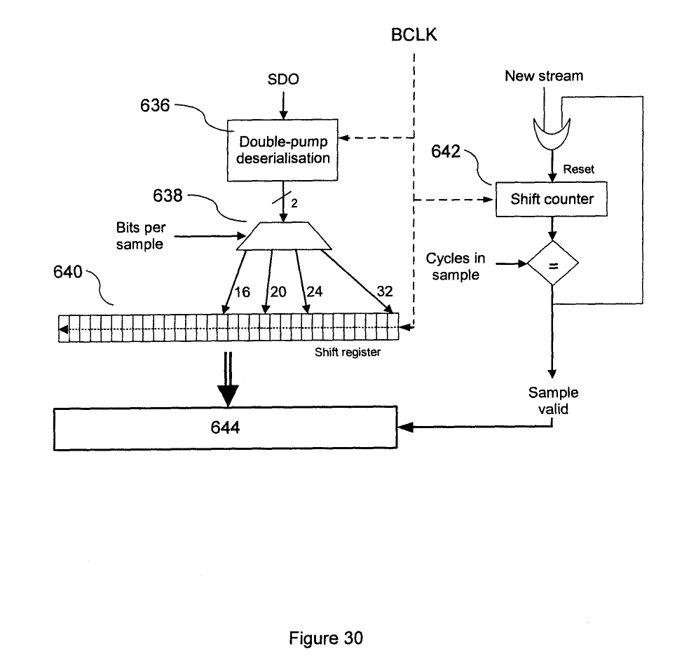

FIG. 30 schematically illustrates the deserialiser of FIG. 29. The deserialiser comprises a double pumped deserialisation means 636 and a variable sample size deserialisation means 638.

The double pumped deserialisation means 636 is controlled by the clock cycle of the controller, and is operable to receive a serialised data stream, in this case an outbound HDA SDO data stream, and deserialise it into bit pairs. In other words, a pair of bits per clock cycle are output from the double pumped deserialisation means 636.

The variable sample size deserialisation means 638 is arranged to assemble the pairs that are output from the double pumped deserialisation means 636 into samples based on the stream format determined by the stream format determination means 632 of FIG. 29. The bits per sample value of the stream format is input into the variable sample size deserialisation means 638. The bits per sample value controls the position in a shift register 640, in which the variable sample size deserialisation means 638 places the pairs of bits. In other words, the variable sample size deserialisation means 638 are arranged to record the pairs of bits output from the double pumped deserialisation means 636 in a shift register 640 with a variable input point. The position of the input point depends of the number of bits per sample of the stream. The data, when placed in the shift register 640 is shifted by two bit positions at every clock cycle in order to allow a complete sample to be assembled in the shift register 640.

A shift counter 642 is provided, that is arranged to count the number of shifts of the data in the shift register 640, in order to determine when a complete sample is assembled. The shift counter 642 determines that a complete sample has been assembled when the shift count equals half the bits per sample value determined by the sample format determination means. This is because the data is placed in the shift register 640 in data pairs (two bits at a time).

When a complete sample is determined to be stored in the shift register 640, reading means 644 are arranged to read the complete sample in parallel from the shift register 640. Alternatively, the sample may be read from the register 640 by any other suitable function block in the codec. The reading means is responsive to a notification from the deserialiser that all bits of the sample are present and the output sample is valid. The reading means may be a FIFO for example. The complete sample can then be processed as a whole within the codec.

The codec further comprises a sample counter (not shown) for counting a number of samples assembled from the incoming stream and comparing the counted number of samples with the number of samples per sample block to determine when all samples of the incoming stream have been received.

When it is determined that a new stream has arrived, the shift counter is arranged to reset.

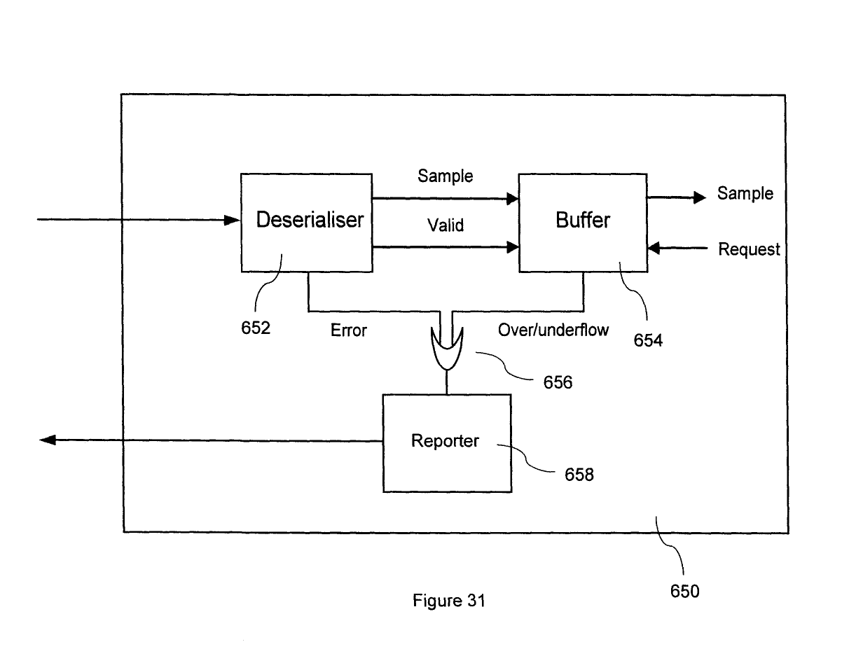

FIG. 31 schematically illustrates a codec 650, which is arranged to receive from an external source a serial data signal formed of a sequence of digital audio streams, each stream having a stream format which may vary between the streams. Codec 650 comprises deserialisation means 652 that are arranged to deserialise each incoming stream into one or more samples.

A buffer 654 is provided for receiving a sample that is output from the deserialisation means 652. Buffer 654 is any buffer that is downstream from the deserialiser, and may be a buffer of a data source of the codec 650.

Error determining means 656 are coupled to the deserialisation means 652 and to the buffer 654, in order to detect any error in the sample. If an error in the sample is detected by the error determining means 656, a report may be generated for transmission to the external source. The report may be generated by reporting means 568.

As will be apparent to the person skilled in the art, codec 650 may be a HDA codec, the controller may be a HDA controller, and the communication may occur via a HDA link. Alternatively, codec 650 may be any codec, audio or otherwise that communicates with a controller in discrete time slots and is capable of generating status reports. In this context, “codec” refers to any device or circuitry, which is physically distinct from the controller; it should be noted however, that codecs need not be exclusively hardware based. Typically, driver software is used to control functional blocks of the codec under supervision of the controller. The following will describe an example in which the codec 650 is a HDA codec.

In the case of codec 650 being a HDA codec, the input to deserialisation means 652 is an outbound SDO audio signal and the report that is generated is an unsolicited response that is generated by an unsolicited response manager.

If a stream is configured to run at 48 kHz, but actually arrives at 44.1 kHz, the deserialisation means 652 will not notice this error if the bits per sample value is the same. However, the buffer 654 will soon underflow, and the error determining means 656 will detect the error and generate an unsolicited response.

If a stream is configured to run at 44.1 kHz, but actually arrives at 48 kHz, again the deserialisation means 652 will not notice this error if the bits per sample value is the same. However, the buffer 654 will soon overflow, and the error determining means 656 will detect the error and generate an unsolicited response.

If two streams are configured, but the first one arrives with the wrong sample size, the buffer 654 will not notice any errors, but the deserialisation means 652 will notice that samples are not validly deserialised before the deserialisation of the next sample begins, and the error determining means 656 will detect the error and generate an unsolicited response. A sample is not validly deserialised when the number of deserialised data bits is not equal to the expected number of bits in the sample.

The deserialisation means 652 may be the deserialisation means of the codec as described in relation to FIGS. 29 and 30. Alternatively, the deserialisation means 652 may be any suitable deserialiser.

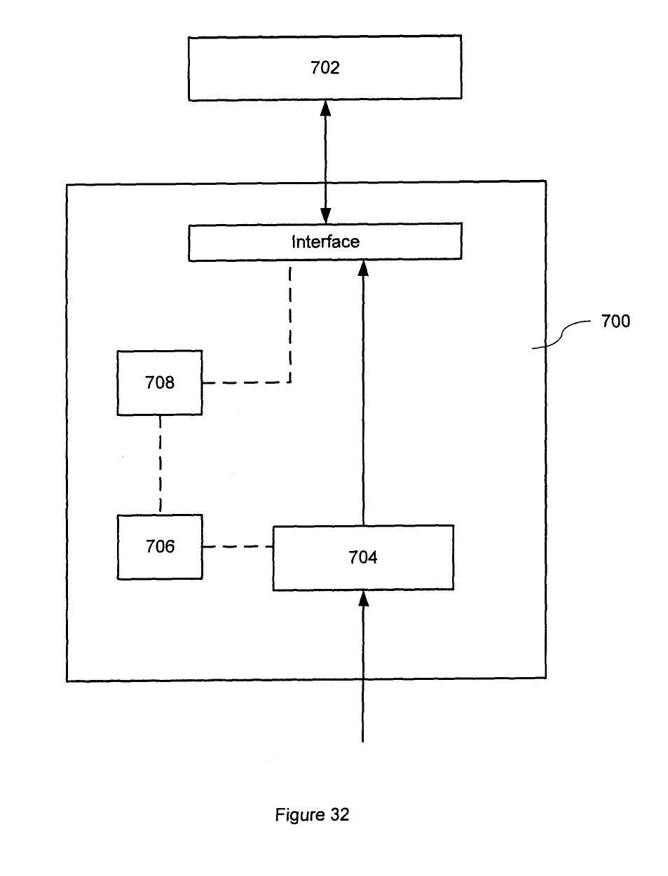

FIG. 32 schematically illustrates an audio processor 700 that is arranged to process at least one S/PDIF audio stream, the codec being managed by an external controller 702. The audio processor comprises an S/PDIF receiver 704 that is arranged to arranged to track the sample rate of an incident S/PDIF stream and recover a clock and data from the incident S/PDIF stream.

The audio processor 700 comprises integrity judging means 706 that judge the integrity of the S/PDIF stream according to a plurality of criteria. There are four criteria that are employed by the integrity judging means 706.

The first criterion is whether the recovered data reflects the data in the incident S/PDIF stream. The integrity judging means 706 determines that the recovered data reflects the data in the incident S/PDIF stream when a predetermined number of Z frames have been received with the correct X and Y frames in between, e.g. a plurality of expected frames have been received. The predetermined number may be two or three or more. The integrity judging means 706 may also determine that the recovered data reflects the data in the incident S/PDIF stream by using parity checks, on the basis of preamble order checking and/or bi-phase encoding error checking.

The second criterion is whether the recovered clock reflects the clock in the incident S/PDIF stream. The integrity judging means 706 determines that the recovered clock reflects the clock in the incident S/PDIF stream when a clock recovery block of the S/PDIF receiver reports a stable output clock. The integrity judging means may also determine that the recovered clock reflects the clock in the incident S/PDIF stream when a FIFO control loop of the S/PDIF receiver is settled and locked.

The third criterion is whether the sample rate is valid and within a specified tolerance of the S/PDIF receiver. The integrity judging means 706 determines that the sample rate is valid and within a specified tolerance of the S/PDIF receiver by measuring the difference between the clock of the incident S/PDIF stream and a nominal centre frequency. If the difference is within a specified tolerance, usually 1 or 2%, the sample rate is indicated as valid. The measurement is performed using a high frequency oversampling clock of the order of 100 MHz.

The fourth criterion is whether an input S/PDIF stream is present.

The integrity judging means 706 may be integral to the S/PDIF receiver, or alternatively, the integrity judging means 706 may be integral to another part of the audio processor.

When the judging means judges that integrity of the recovered S/PDIF stream is present, i.e. one or more of the criteria is satisfied, a lock flag is asserted. In this example, all of the four criteria must be satisfied in order for the judging means to judge that integrity of the S/PDIF stream is present.

Lock flag reporting means 708 are arranged to transmit an indication of said lock flag to the controller 702.

The audio processor 700 may be a codec. The codec 700 may be a HDA codec, the controller may be a HDA controller, communicating with the HDA codec via an HDA link, and the HDA codec providing data derived from the incident S/PDIF stream on an inbound stream of said HDA link. Alternatively, codec 700 may be any codec, audio or otherwise that communicates with a controller in discrete time slots and is capable of generating status reports. For example, codec 700 may be a SLIMbus component. In this context, “codec” refers to any device or circuitry, which is physically distinct from the controller; it should be noted however, that codecs need not be exclusively hardware based. Typically, driver software is used to control functional blocks of the codec under supervision of the controller.

In the case that audio processor 700 is a HDA codec, the codec further comprises a sample rate detector arranged to detect the sample rate of the incident S/PDIF stream and to report a change in the detected sample rate to the HDA controller via an unsolicited response. If the sample rate detector detects a change in the incident sample rate, and the criteria that are employed by the integrity judging means 706 are no longer satisfied, the integrity judging means 706 will flag an unlock condition. The unlock condition indicates that the S/PDIF receiver does not have confidence in the accuracy of the recovered clock and data.

Upon de-assertion of the lock flag, and assertion of the unlock condition, the S/PDIF receiver can be configured to pack the inbound stream for transmission on the HDA bus to the HDA controller, with null data at the last determined sample rate. This is to prevent corrupted data from being transmitted.

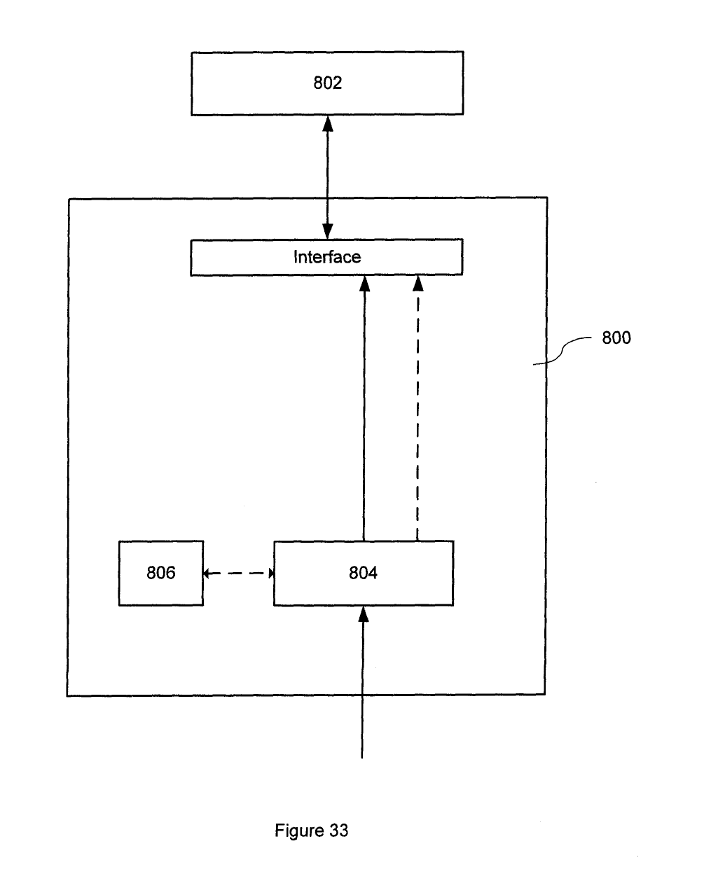

FIG. 33 schematically illustrates a device 800 that is arranged to process at least one incident S/PDIF audio stream, the device being managed by an external controller 802. The device may be an audio processor or the like. The audio processor comprises an S/PDIF receiver 804 that is arranged to arranged to track the sample rate of an incident S/PDIF stream and recover a clock and data from the incident S/PDIF stream.

Audio processor 800 further comprises sample rate detector means 806 that are arranged to monitor the sample rate of the incident S/PDIF stream. If the sample rate detector means detects that the sample rate of the incident S/PDIF stream changes, the S/PDIF receiver 804 is arranged to transmit an indication to the controller that the sample rate has changed.

The sample rate detector means 806 may be part of the S/PDIF receiver, or alternatively, the sample rate detector means 806 may be integral to another part of the audio processor 800.

The audio processor 800 may be a codec. The codec 800 may be a HDA codec, the controller may be a HDA controller, communicating with the HDA codec via an HDA link, and the HDA codec providing data derived from the incident S/PDIF stream on an inbound stream of said HDA link. Alternatively, codec 800 may be any codec, audio or otherwise that communicates with a controller in discrete time slots and is capable of generating status reports. In this context, “codec” refers to any device or circuitry, which is physically distinct from the controller. Typically, driver software is used to control functional blocks of the codec under supervision of the controller.

In the case that audio processor 800 is a HDA codec, the indication transmitted to the controller is an unsolicited response inserted in said SDI signal. Also, a stream verb may be associated with the S/PDIF receiver 804 from which the HDA controller can read the detected sample rate. The S/PDIF receiver 804 may be operable to update the detected sample rate by means of the stream verb whenever the detected sample rate changes. The stream verb may be the S/PDIF receiver stream verb, which is implemented as read-only and may be written automatically by the S/PDIF receiver 804 upon detection of a new sample rate. Alternatively, a pin widget verb may be employed, detection of the S/PDIF stream being used as a form of pin widget detect.

The converter format verb (S/PDIF receiver converter format verb) can be used to communicate the incident S/PDIF sample rate to the controller 802 i.e. the controller 802 can read the stream verb. In normal operation, the HDA controller would write the stream verb, not read it. This use by the codec of the converter format verb to flag the sample rate to the controller is therefore a new use for an existing control within a HDA codec.

Furthermore, the sample rate of the stream in the SDI signal transferred on the HDA bus can be controlled automatically by the S/PDIF receiver 804 via the stream verb. By using the S/PDIF receiver converter format verb in this way, the HDA bus sample rate can be automatically controlled relative to the recovered incident S/PDIF stream.

In the case that audio processor 800 is a HDA codec, the sample rate detector means 806 may be arranged to set an input sample rate update flag, such that when the sample rate detector means 806 detects that the input sample rate has changed, the S/PDIF receiver 804 is instructed by the input sample rate update flag to generate an unsolicited response informing the HDA controller 804 of the sample rate change.

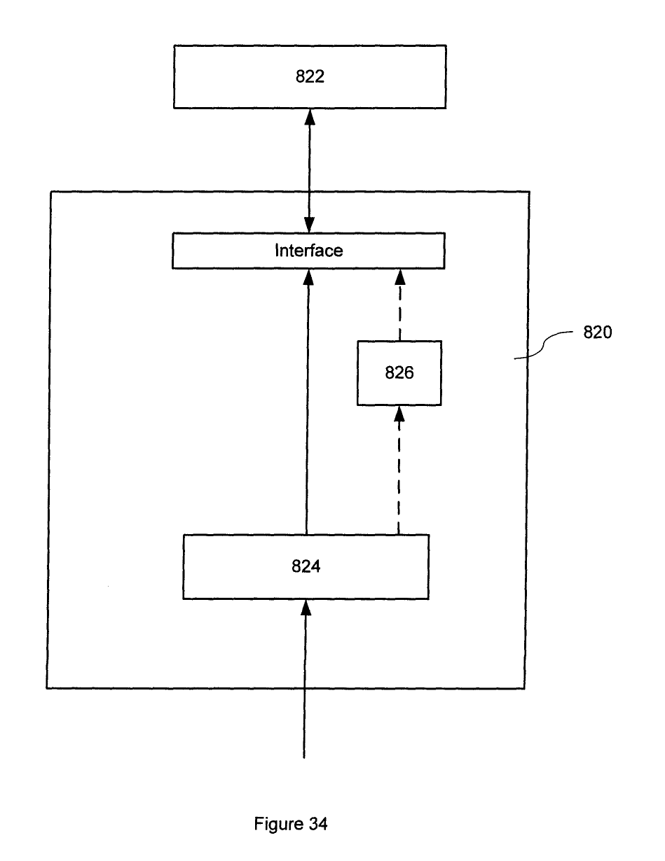

FIG. 34 schematically illustrates an audio processor 820 that is arranged to process at least one incident S/PDIF audio stream, and process that stream to supply data derived from the S/PDIF stream to an external controller 822. A S/PDIF receiver 824 in audio processor 820 receives the incident S/PDIF stream. The S/PDIF receiver 824 has a sample rate monitor (not shown) that is arranged to monitor the sample rate of the incident S/PDIF stream, and sample rate reporting means that are arranged to transmit to the controller 822 an indication of the new sample rate after a change in the sample rate of the incident S/PDIF stream.

The S/PDIF receiver 824 also has integrity judging means (not shown) for determining the integrity of the incident S/PDIF stream. A lock flag is generated by the S/PDIF receiver 824 when the integrity of the incident S/PDIF stream is determined after a change in the sample rate.

The lock flag is reported to the controller 822 by lock flag reporting means 826. The sample rate monitor and lock flag generator and the lock flag reporting means may be the sample rate monitor and lock flag generator as described in relation to FIG. 32. Alternatively, they may be different units capable of performing the same functions.

Following transmission of the indication of the lock flag to the controller 822 by the lock flag reporting means 826, the audio processor 820 withholds supply of data that is derived from the incident S/PDIF stream to the controller 822 until the audio processor 820 receives an acknowledgement from the controller 822. In other words, the supply of the recovered data derived from the incident S/PDIF stream from the audio processor 820 to the controller 822 is stopped (null data is provided) until the controller 822 acknowledges the new sample rate. This is to prevent the controller mis-processing the data in its DMA engine.

The audio processor 820 may be a codec. The codec 820 may be a HDA codec, the controller may be a HDA controller, communicating with the HDA codec via an HDA bus, and the HDA codec providing data derived from the incident S/PDIF stream on an inbound stream (SDI) of said HDA bus. Alternatively, codec 820 may be a Component in a SLIMbus system, or any codec, audio or otherwise that communicates with a controller in discrete time slots and is capable of generating status reports. In this context, “codec” refers to any device or circuitry, which is physically distinct from the controller. Typically, driver software is used to control functional blocks of the codec under supervision of the controller.

In the case that the audio processor 820 is a HDA codec, data that is derived from the incident S/PDIF audio stream is assigned a stream identification value by the controller 822, and the codec is arranged to re-start supply of said derived data upon receipt of a new stream identification value from the controller 822. In other words, the receipt of a new stream identification value from the controller constitutes the controller acknowledging the new sample rate to the codec. The acknowledgement stream identification value may be a non-zero stream identification value.

Conversely, the codec is responsive to receipt of a command from the controller 822 to stop supply of said derived data until the receipt of the acknowledgement stream identification value. The command from the controller may be to write the stream identification value to zero, instructing the codec to terminate the stream.

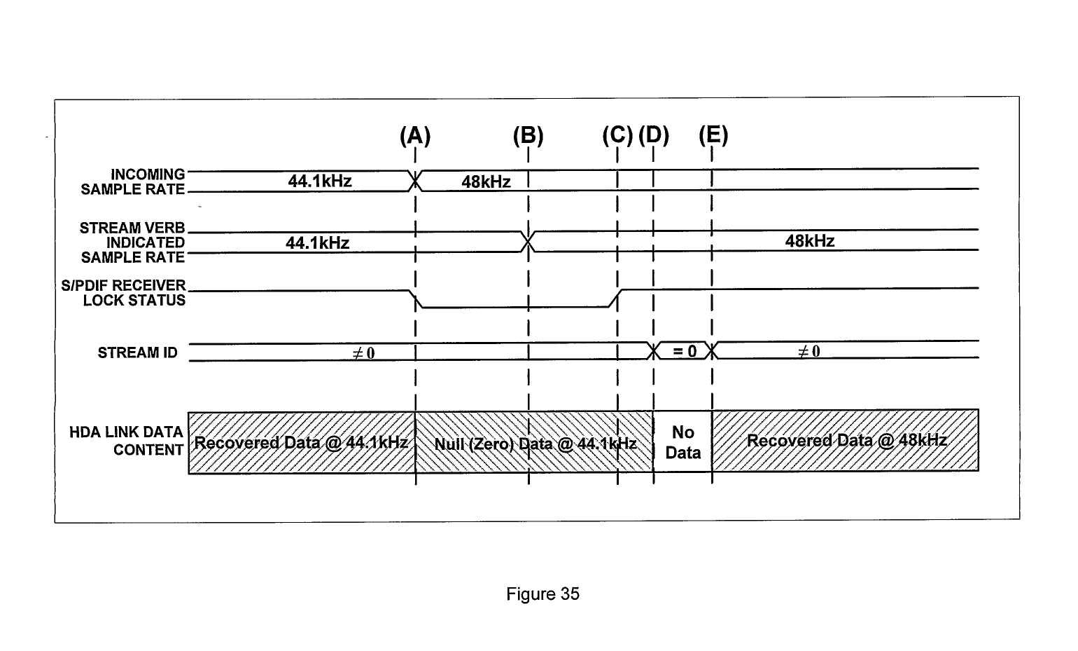

FIG. 35 illustrates an example of the operation of audio processor 820 of FIG. 34. In FIG. 35, audio processor 820 is a HDA codec that is in communication with a HDA controller 822. In this example, if the sample rate of the incident S/PDIF stream is changed during operation from 44.1 kHz to 48 kHz. The following events occur.

At position (A), the incident S/PDIF sample rate is changed from 44.1 kHz to 48 kHz. The S/PDIF receiver immediately indicates an unlock condition to the HDA controller via the ‘lock’ status flag and unsolicited response. The HDA link stream from the S/PDIF receiver is packed with null (zero) data.

At position (B), the sample rate detector block determines the new sample rate and sends an unsolicited response to the HDA controller to indicate that a new sample rate has been detected. At this time the converter format verb can be read by the controller to determine the new sample rate if required.

At position (C), when the ‘lock’ flag indicates that the S/PDIF receiver has locked an unsolicited response is sent to the HDA controller.

At position (D), the HDA controller responds by initiating the handshake procedure which consists of writing the stream ID to zero. This stops data transfer on the HDA link and allows the HDA controller data DMA control system to be flushed and hence prepared for the data at the new sample rate.

At position (E), when the HDA controller is ready to receive data at the new sample rate, the controller writes the stream ID to a non-zero value. The CODEC then transmits data to the HDA controller on the HDA link at the new sample rate.

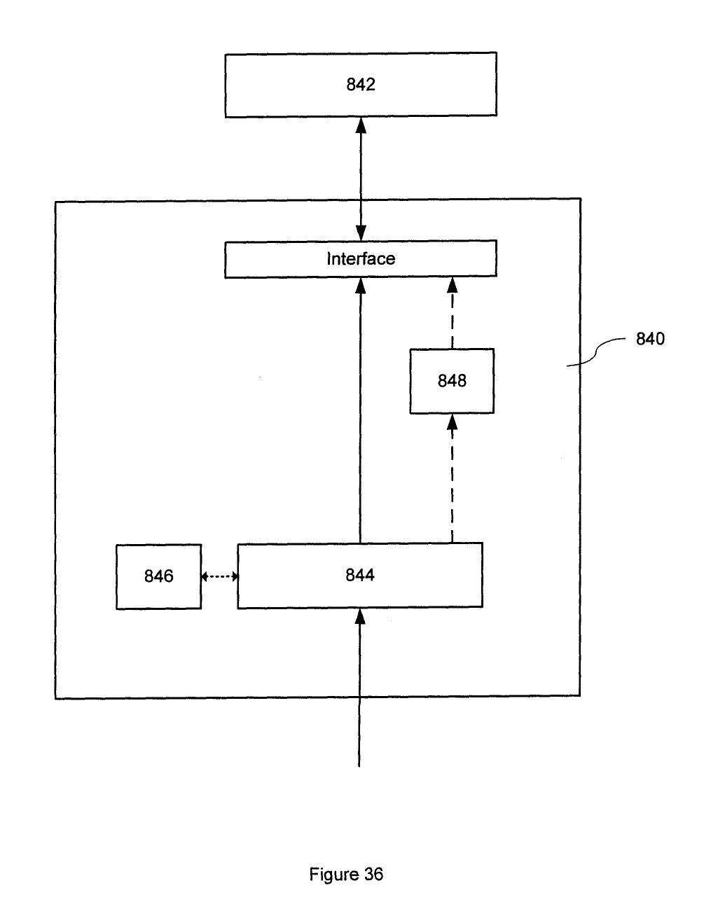

FIG. 36 schematically illustrates an audio processor 840 that is arranged to process at least one incident S/PDIF audio stream, and process that stream to supply data derived from the S/PDIF stream to an external controller 842. A S/PDIF receiver 844 in audio processor 840 receives the incident S/PDIF stream. The audio processor 840 has a sample rate detector means 846 that are arranged to detect the sample rate of the incident S/PDIF stream.

The S/PDIF receiver 824 also has integrity judging means (not shown) for determining the integrity of the incident S/PDIF stream. A lock flag is generated by the S/PDIF receiver 844 when the integrity of the incident S/PDIF stream is determined after a change in the sample rate.

The lock flag is reported to the controller 842 by lock flag reporting means 848. The sample rate monitor and lock flag generator and the lock flag reporting means may be the sample rate detector means and lock flag generator as described in relation to FIG. 32. Alternatively, they may be different units capable of performing the same functions.

Following transmission of the lock flag status to the controller 842 by the lock flag reporting means 848, the audio processor 840 is arranged, as soon as the lock flag reporting means transmits an indication of the lock condition to the controller, to begin transmission of the digital audio data to the controller 842 at the sample rate detected by the sample rate detector means 844. In other words, upon receiving a lock condition, the S/PDIF receiver 840 pushes the recovered data on to the controller 842.

The above described lock condition may be a re-lock condition. That is, a new lock condition after the sample rate detector means 846 has detected a new sample rate.

The audio processor 820 may be a codec. The codec 820 may be a HDA codec, the controller may be a HDA controller, communicating with the HDA codec via an HDA bus, and the HDA codec providing data derived from the incident S/PDIF stream on an inbound stream (SDI) of said HDA bus. Alternatively, codec 820 may be a SLIMbus Component or any device that communicates with a controller in discrete time slots and is capable of generating status reports. In this context, “codec” refers to any device or circuitry, which is physically distinct from the controller. Typically, driver software is used to control functional blocks of the codec under supervision of the controller.

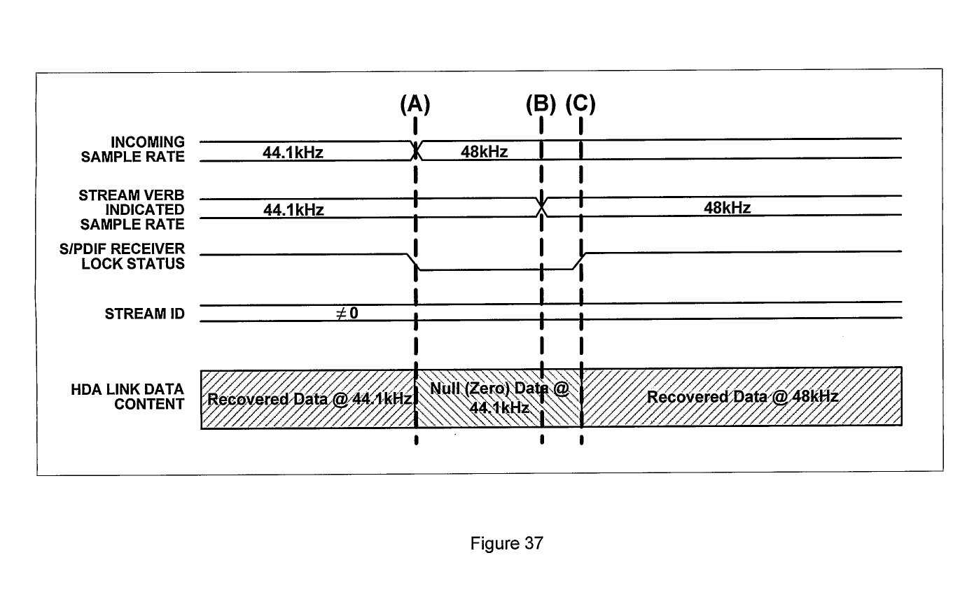

FIG. 37 illustrates an example of the operation of audio processor 840 of FIG. 36. In FIG. 36, audio processor 840 is a HDA codec that is in communication with a HDA controller 842. In this example, if the sample rate of the incident S/PDIF stream is changed during operation from 44.1 kHz to 48 kHz. The following events occur.

At position (A), the input S/PDIF sample rate is changed from 44.1 kHz to 48 kHz. The S/PDIF receiver immediately indicates an unlock condition to the HDA controller via the ‘lock’ status flag and unsolicited response. The HDA link stream is packed with null (zero) data.

At position (B), the sample rate detector block determines the new sample rate and sends an unsolicited response to the HDA controller to indicate that a new sample rate has been detected. At this time the stream verb can be read to determine the new sample rate if required.

At position (C), when the ‘lock’ flag indicates that the S/PDIF receiver has locked an unsolicited response is sent to the HDA controller and the HDA link stream is packed with data at the new sample rate.

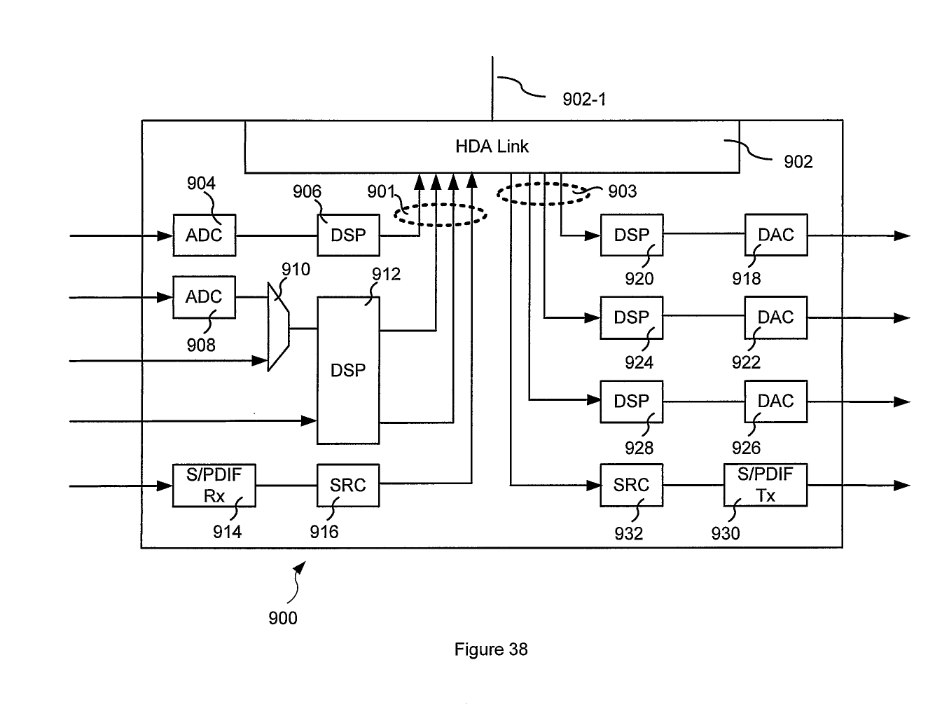

FIG. 38 schematically illustrates an example of a HDA codec 900, showing various functional blocks (nodes) within the codec as explained below. It should be noted that the figure is conceptual in nature; the various functional blocks need not all be provided as discrete circuits in the codec. Indeed, some of them may be implemented by software executed by a general-purpose CPU or DSP. In addition to the functional blocks, FIG. 38 schematically shows various audio paths 901, 903 for routing of digital audio within the codec and to and from an interface in the form of HDA link 902. HDA link interface 902 is connected to the HDA link 902-1, which is used as the end point or start point for all audio paths within the codec 900, as specified by the HDA specification. As already described above, HDA link is connected to an HDA controller for controlling codec 900 and any other HDA codecs that may be provided in the same system.

Each audio path is associated with particular kinds of nodes, referred to here as stream sources/sinks, which generally connect the codec to the outside world. Input audio paths 901 start at input stream sources and end at the HDA link, and output audio paths 903 start at the HDA link and end at output stream sinks. Normally, audio data is only transferred and processed in digital form within the codec, and is only converted to analogue when necessary to provide an analogue output. For present purposes, routes taken by digital audio data within the codec are regarded as forming the audio paths, and not the analogue or digital inputs and outputs of the codec. The audio paths will usually carry stereo, mono or multichannel data, though they are shown as single lines for simplicity.

In the example shown in FIG. 38, four input audio paths 901 are provided that end with the HDA link. The first input audio path is from ADC 904 via its associated DSP 906. This first audio path may for example be for transport of data sampled by ADC 904 from a line-in source.

The second and third input audio paths are from ADC 908 via multiplexor 910 and DSP 912. The input to ADC 908 may for example be from an analogue microphone and provides one input to multiplexor 910. The other input to multiplexor 910 may for example be from a digital microphone array. The multiplexor 910 provides one input to DSP 912. The second input to DSP 912 may for example be provided directly from the digital microphone array.

The fourth input audio path is from S/PDIF receiver 914 via sample rate converter 916. This fourth audio path may for example be used to carry surround sound data derived from a set top box that has a S/PDIF output for multichannel transmission.

The example shown in FIG. 38 shows four output audio paths 903 that start from the HDA link. The first output audio path is to a DAC 918 via DSP 920. The first output audio path may for example be used to provide an output to headphones.

The second output audio path is to a DAC 922 via DSP 924. The third output audio path is to a DAC 926 via DSP 928. The analogue outputs from DACs 922 and 926 may for example be output to respective pairs of stereo speakers with associated amplifiers.

The fourth output audio path is to a S/PDIF transmitter 930 via a sample rate converter 932. The fourth output audio path may for example be used to provide a digital audio output to an AV receiver for multichannel decoding.

When performing testing and evaluation on HDA codec 900, it is necessary to link the codec to the HDA controller in order for the HDA link to become active and allow test data to be transferred along an audio path from an input source to an output source to evaluate codec performance. This is because all audio paths in the codec start or end on the HDA link interface 902/HDA bus 902-1, as specified by the HDA specification. As described above, the HDA controller is typically provided as part of a Southbridge in a PC chipset; thus, linking the codec to an HDA controller may involve using a laptop computer for example in addition to a test board. This complicates and lengthens the testing procedure.

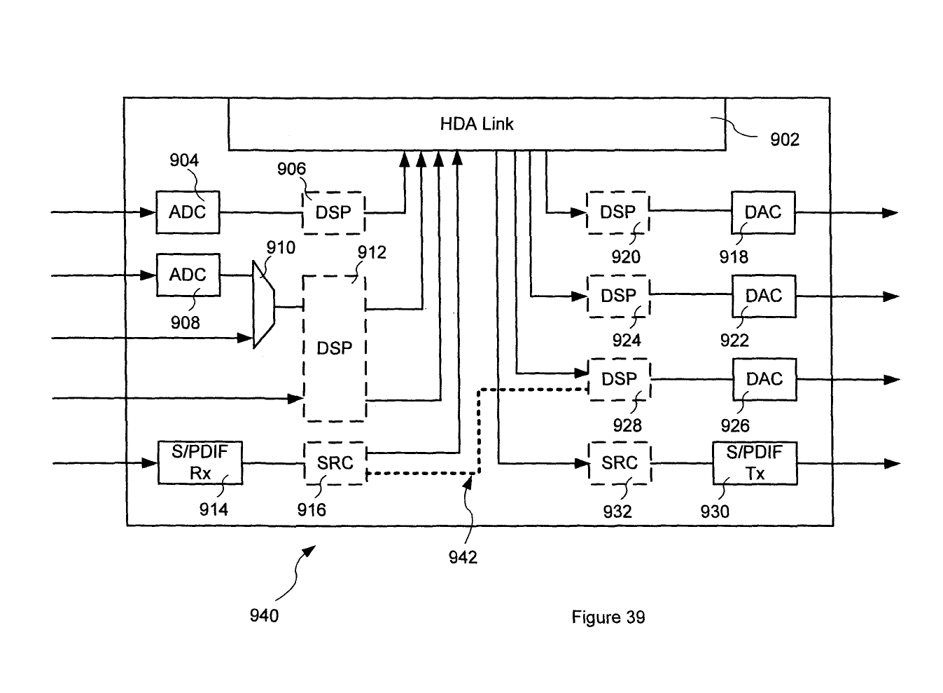

FIG. 39 schematically illustrates an HDA codec 940 according to an example of the present invention. HDA codec 940 contains the same components as HDA codec 900, with like components having the same reference numerals. As will be apparent to the skilled person, DSP blocks 906, 912, 920, 924, 928 and SRC blocks 916 and 932 are entirely optional.

In addition to the audio paths of codec 900, HDA codec 940 additionally is provided with a custom test audio path 942 that directly connects the S/PDIF receiver 914 to the DAC 926 via the SRC 916 and DSP 928. Test audio path 942 does not start or end at the HDA link 902.

During testing, codec 940 can be placed into (mounted on a socket of) an audio test board. Test data applied in the form of a S/PDIF stream to S/PDIF receiver 914 can be transferred along a digital to digital test audio path 942 from the S/PDIF receiver 914 to DAC 926 to evaluate codec performance, without the need to plug the codec to an intelligent controller that is external to the test apparatus. In testing the codec shown in FIG. 39, it is only necessary to connect the codec to an external apparatus that allows the test path to be set up. However, this apparatus need not be a HDA controller or any other intelligent apparatus. The apparatus need only be hardware capable of supplying a pattern of bits that allow the test path to be enabled (e.g. a so-called “bit-basher”).

The provision of test audio path 942 allows the HDA codec to be tested without the need to connect the codec to an intelligent controller that is external to the test apparatus, hence saving time and money during testing processes. The use of the custom test path also simplifies diagnosis by eliminating the HDA link, HDA bus and HDA controller as sources of possible faults or unpredicted behaviour.

Audio test path 942 is controlled in the codec 940 using the custom verb structure that is provided for in the HDA specification. The custom verbs are capable of being set such that an input stream source, such as S/PDIF receiver 914, supplies its data to an output stream source, such as DAC 926, rather than to the HDA link and the output stream source obtains its data from the input stream source rather that from the HDA link. As an example, the custom verbs may act to control multiplexers at the output/input of each input stream source and output stream source respectively, such as to select among alternative routes for the audio data.

Typically, one such custom verb will be employed though it may be possible to achieve the desired routing with multiple custom verbs. For example, if SRC 916 always supplies both the HDA link and DSP 928 with the same data, it is then up to the DSP to select which data source to use. If data is sent to the HDA link when it has not been properly enabled, that data will be ignored. Alternatively, one custom verb could be used to control the behaviour of several components simultaneously. Such custom verbs may be implemented as part of control logic (including control software) of the codec. Although logically associated with specific nodes of the codec they need not be physically associated with the nodes.

In one preferred configuration, the custom verbs are not recognised by the driver software used to manage the HDA controller, but are reserved for use by the manufacturer and/or by preferred customers involved in the development phase of an end-user system. In other words the test audio path is only operable during a special “test mode” of the codec, whose manner of activation may be withheld from end users and (possibly) from some or all customers who manufacture systems using the codec.

After testing, the codec may be switched into a “normal operation” mode, perhaps irreversibly. This means that test audio path 942 is not visible to the HDA controller, which means that the HDA controller is not aware of test audio path 942 during normal operation of the HDA codec 940 by the end user. The test audio path thus remains unused during normal operation so that the codec can comply with the HDA specification.

In another preferred configuration, the test path is made available during normal operation, for any non-HDA application of the codec which might be performed instead of or alongside its HDA-compliant functions.

One such application of the custom audio path 942 is in telephony. It is common practice in the telephony to provide a voice back audio channel (side tone) for reproduction at the speaker of a telephone that provides a low level signal of the user's own voice in the earpiece. This voice back audio provides the user with a more natural conversation experience. It is necessary that the voice back channel has very little latency, in order to prevent the user hearing a delay in his/her own voice.

If a device, such as a handheld computer, relies on HDA for its audio functionality then, it may not be possible to provide a digital to digital voice back channel to the user using conventional techniques, because of the latency involved in an audio path starting and ending with the HDA link. This latency is caused by the depth of the DMA system and the speed of the operating system. However, there is increasing demand for telephony functions such as cell phone applications using HDA codecs and mobile internet devices.

The custom audio path 942 could therefore be provided in this application to provide the voice back channel, as latency is reduced by not going through the HDA link. In this way, an HDA codec in accordance with the present invention can be made more useful for devices including a telephony function, potentially making HDA more attractive as the audio standard for mobile telephones and other communication devices.

As will be apparent to the skilled person, although only one test audio path is shown and described, any number of test audio paths may be provided that may connect any input with any output. Also, by use of multiplexers or the like as already mentioned, an audio path may be provided between more than one input/output at one end and more that one input/output at the other end of the audio test path. This allows, for example, the same set of test data to be applied to multiple outputs of the codec simultaneously; testing can then include switching between the output sources to compare the results, e.g. S/PDIF RX 914 to DAC 918, DAC 922, DAC 926.

As mentioned earlier, communications between an HDA codec and HDA controller are made over the HDA bus by sending frames of data consisting of a plurality of streams, each having a stream format. The stream format structure is provided at the transmitter side (e.g. HDA codec) for interrogation by the recipient (e.g. HDA controller). The stream format structure in HDA has 6 fields for indicating the format of a stream that is being communicated. The first field is a stream type (TYPE) field that indicates whether or not the stream is PCM or not. The second field is a sample base rate field (BASE) that indicates whether the sample base rate of the stream is 48 kHz or 44.1 kHz. The third field is a sample base rate multiple field (MULT) that indicates what multiple (if any) of the sample base rate the stream is transmitted at. The fourth field is the sample base rate divisor field (DIV) that indicates what division (if any) of the sample base rate the stream is transmitted at. The fifth field is a bits per sample field (BITS) that indicates the number of bits in each sample of the stream. The sixth field is a number of channels field (CHAN) that indicates the number of channels in the stream.

The following table taken from Intel High Definition Audio Specification, Rev. 1.0, shows the structure in more detail.

| Bit | Description |
|---|---|
| 15 | Stream Type (TYPE): If TYPE is non-zero, the other bits in the |
| | format structure have other meanings. 0: PCM 1: Non-PCM |
| 14 | Sample Base Rate (BASE): 0 = 48 kHz 1 = 44.1 kHz |
| 13:11 | Sample Base Rate Multiple (MULT): 000 = 48 kHz/44.1 kHz or |
| | less 001 = x2 (96 kHz, 88.2 kHz, 32 kHz) 010 = x3 (144 kHz) |
| | 011 = x4 (192 kHz, 176.4 kHz) 100-111 = Reserved |
| 10:8 | Sample Base Rate Divisor (DIV): 000 = Divide by 1 (48 kHz, 44.1 |
| | kHz) 001 = Divide by 2 (24 kHz, 22.05 kHz) 010 = Divide by |
| | 3 (16 kHz, 32 kHz) 011 = Divide by 4 (11.025 kHz) 100 = |
| | Divide by 5 (9.6 kHz) 101 = Divide by 6 (8 kHz) 110 = Divide |
| | by 7 111 = Divide by 8 (6 kHz) |
| 7 | Reserved |
| 6:4 | Bits per Sample (BITS): Number of bits in each sample: 000 = 8 |
| | bits. The data will be packed in memory in 8-bit containers on |
| | 16-bit boundaries. 001 = 16 bits. The data will be packed |
| | in memory in 16-bit containers on 16-bit boundaries. 010 = |
| | 20 bits. The data will be packed in memory in 32-bit containers |
| | on 32-bit boundaries. 011 = 24 bits. The data will be packed |
| | in memory in 32-bit containers on 32-bit boundaries. 100 = |
| | 32 bits. The data will be packed in memory in 32-bit containers on |
| | 32-bit boundaries. 101-111 = Reserved |

In a first example of the present invention, two of the fields in the stream format structure of HDA are used in order to flag that the data being transferred in a stream is floating point data. The codec is arranged to indicate that data being communicated is floating point data, when the stream type (TYPE) field is set to indicate that the data in the stream is PCM data and the bits per sample field (BITS) is set to indicate that the stream contains 32 bits per sample. This is a new use of two existing HDA fields.

PCM, in the audio context, generally implies that the samples are integer values which in some way represent the amplitude of an audio signal at a certain instant of time. For example, the absolute level may be represented by each sample word. With demands for ever-higher fidelity and the advancement of computing power, the number of bits per PCM sample has increased over the years, from 8 bits to 16 (e.g. as used in CD audio) and now 24 bit processing becoming the standard. The next step would be 32 bit integer PCM, but whether this would offer any real benefits is debatable.

For practical purposes, 24 bit integer samples are not audibly different from 32 bit integer samples, because the least significant bits of 32 bit data are lost in the analogue performance of audio devices and limitations of the human ear. Codecs available to date therefore do not usually support 32 bit data, even though it is supported in the HDA specification.

Meanwhile, higher-level processors such as a CPU of a system in which the codec might be installed, increasingly use floating point data (e.g. IEEE 754-1985, also called Float32) for audio processing, as this can be more convenient for DMA handling, volume control, and effects processing such as spatialisation. If such a higher-level processor receives audio samples in an integer format, it may first have to perform a floating point conversion prior to processing the audio further.

IEEE 754-1985 (Float32) requires samples in the form of 32 bit words, which may be represented as numbered from 0 to 31, left to right. The first bit is the sign bit, S, the next eight bits are the exponent bits, ‘E’, and the final 23 bits are the fraction (or mantissa) ‘F’:

| S | EEEEEEEE | FFFFFFFFFFFFFFFFFFFFFFF |
|---|---|---|
| 0 | 1 8 | 9 31 |

Thus, in comparison with 32-bit (integer) PCM, eight bits are reserved for the exponent, which is not present in the integer representation.

The codec can perform floating point conversion of integer (fixed point) data before transmission, thereby providing the controller and its higher-level circuitry with data in a format which can readily be used, and eliminating the need for the controller to perform the floating point conversion. This conversion, and the transmission of floating point as opposed to integer data, can be started and stopped at any time by use of the above flagging technique, thus allowing flexible operation. Conversion of integer to floating-point data can be performed by an algorithm well known in the art, and which will be familiar to the skilled person. By performing this conversion within the codec, the higher-level processors of the system are freed from this task thereby allowing greater use of the system resources for other purposes.

Conventionally, the stream type bit (TYPE) is used by the HDA controller to indicate whether or not the data in a stream that is being communicated is PCM or not. The stream type bit does not indicate what the format of the stream is i.e. is it AC3/Dolby Digital, DTS etc.

If the data is PCM (which for present purposes includes both integer and floating-point data such as Float 32), there is no header data. The HDA controller can process the audio data directly, as it knows the format (integer of floating point) from the TYPE and BITS fields as explained above.

Thus in the first example, the TYPE and BITS fields are both used in order to flag that data being transferred in a stream is floating point data. If the TYPE field is specified as PCM and the BITS field indicates 32 bits, floating point data is flagged.

In the case where S/PDIF paths, which are tied to specific nodes in the codec, are present, if the TYPE field is specified as non-PCM and the BITS field indicates 32 bits, “raw S/PDIF” data is flagged. However, in the case of non-S/PDIF paths, the codec can be configured to ‘ignore’ the TYPE field and assume that if 32 bit data is indicated in the BITS field, the data being transferred in a stream is floating point data.

In a second example, the BITS field alone is used in order to flag that data being transferred in a stream is floating point data. If the BITS field indicates 32 bits, floating point data is flagged.

Whilst the above example refers to 24-bit and 32-bit data by way of example, the present invention is of course not limited to this example, and could be extended to any sample lengths. Moreover the form of the floating point data is not limited to that described above in relation to Float32; the numbers of bits in the exponent and mantissa may be varied.

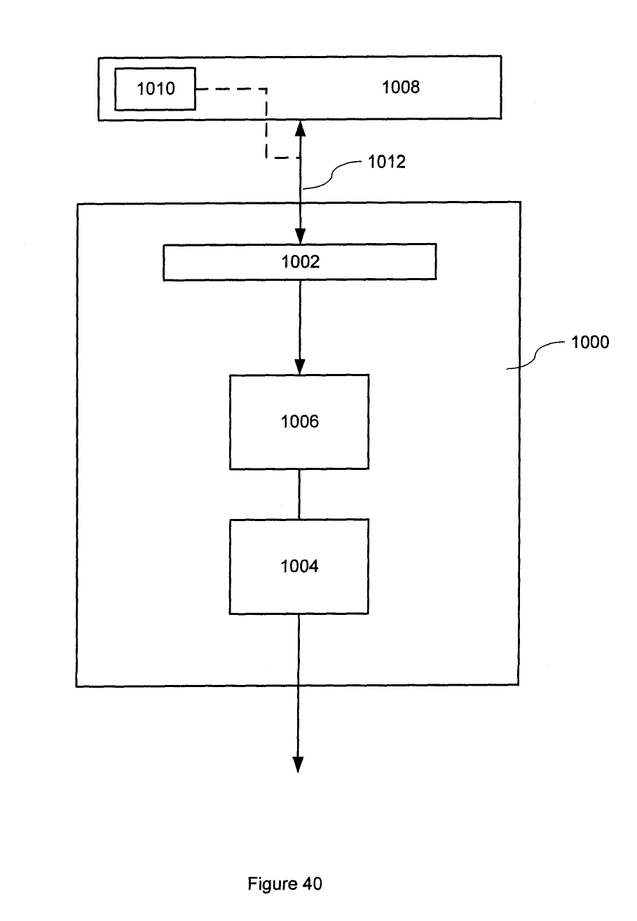

FIG. 40 schematically illustrates a HDA codec 1000, comprising a HDA link interface 1002, an audio amplifier 1004 positioned at an output of the codec 1000 and gain updating means 1006, that are arranged to update the gain of the audio amplifier 1004. Although audio amplifier 1004 is shown in FIG. 40 to be located at an output of the HDA codec 1000, audio amplifier 1004 may be positioned at the input of HDA codec 1000, such that it amplifiers audio signals input to the HDA codec 1000.

The audio amplifier 1004 acts to amplify an audio signal for output from the HDA codec. The audio amplifier 1004 may be associated with a headphone output (not shown) or the like.

The gain updating means 1006 are operable in response to a gain update request, to update the gain of the audio amplifier 1004. The gain update request may be issued from a HDA controller 1008 with which codec 1000 is communicating or from a different unit from within the codec 1000 (also not shown).

The gain updating means 1006, upon receiving the gain update request will update the gain of the audio amplifier, if the current signal level of the amplifier is at a zero cross point at the time of the gain request. However, if the current signal level of the amplifier is not at a zero cross point at the time of the gain request, the gain updating means 1006 will not update the gain of the amplifier.

Thus, the gain updating means needs to be aware, or made aware, of the signal level in some way. This can be achieved in a number of ways.

A first possibility is for the gain updating means (zero cross detector) to monitor directly the level of the input signal as it is fed to the audio amplifier.

A more convenient approach may be for the gain updating means to monitor a value representative of the input signal level; for example a digital sample value where “0000” might represent no signal and “FFFF” the maximum signal level. Where samples are buffered prior to digital to analogue conversion, it is a simple matter to examine them. This approach may be preferable in allowing the zero crossing to be anticipated before it occurs.

A third possibility is to monitor the level of the output signal from the amplifier. Though clearly less preferable in view of the small time delay involved, this may be sufficient for some purposes. Even a slightly later detection of the zero crossing may suffice to minimise noise produced in the gain update, as the signal level may be quite small for a short time after the zero crossing has occurred.

In any of the above cases, “monitor” need not mean continuous tracking of the signal level: it is sufficient that the gain updating means merely be aware of the zero crosses. For example, a circuit may be provided to issue a signal every time the signal level crosses zero, this signal being supplied to the gain updating means.

In an ideal case, the signal level is at a zero crossing (or within a set tolerance above or below, considered to be insignificant) at the time of receiving the command. In this instance the gain update is performed immediately.

Assuming that that the current signal level of the amplifier is not at a zero cross point at the time of the gain request, the codec 1000 is arranged to delay the gain change and try again a plurality of times during a predetermined number of clock cycles. For example, the signal level may be checked at every clock cycle to see whether a zero crossing has been reached. If the signal level of the amplifier changes to a zero cross point during the predetermined number of clock cycles, the gain updating means 1006 is arranged to update the gain.

If the signal level of the audio amplifier does not change to a zero cross point at any point during the predetermined number of clock cycles, the gain updating means is arranged to update the gain of the audio amplifier unconditionally at the end of the predetermined number of clock cycles, thus forcing the update to occur regardless of the signal level at that time.

The predetermined number of clock cycles are based on the bit clock (BCLK) 1010 that is provided to the HDA codec 1000 by a HDA controller 1008, on a signal line of HDA link 1012. This sets the maximum time before the gain update can be performed, since BCLK is always 24 MHz. In this way, it can be ensured that the gain update takes place within a reasonable time period, preventing annoyance to the user.

The gain updating means 1006 is controlled to wait the predetermined number of cycles by a custom verb, that indicates the non-zero cross condition to the gain updating means 1006.

By causing the gain updating means to wait for an amount of time before forcing a gain update, the likelihood of the gain update being performed at a zero cross point is increased. Meanwhile, because the clock cycle of BCLK is fixed and predictable, it can be prevented that the codec reacts too slowly to the commanded gain update.

Although the above technique provides a single predetermined number of cycles followed by an unconditional gain update, the technique could be refined by adding a conditional gain update after a lesser predetermined number of cycles, so long as the signal level is below a certain threshold. That is, the most audible artefacts occur when a gain update is made at a point of large signal level, whereas a gain update made at a timing with a relatively quiet signal will be less noticeable.

Likewise, it is not necessary in the present invention to wait for an exact zero level of the signal. As indicated above, a predetermined tolerance level may be considered close enough to zero not to be noticeable. The terms “zero crossing” and “zero cross point” in the claims are thus to be interpreted broadly.

Another example of the present invention addresses the above-mentioned problem of assigning (re-tasking) an output port (output socket) of a codec.

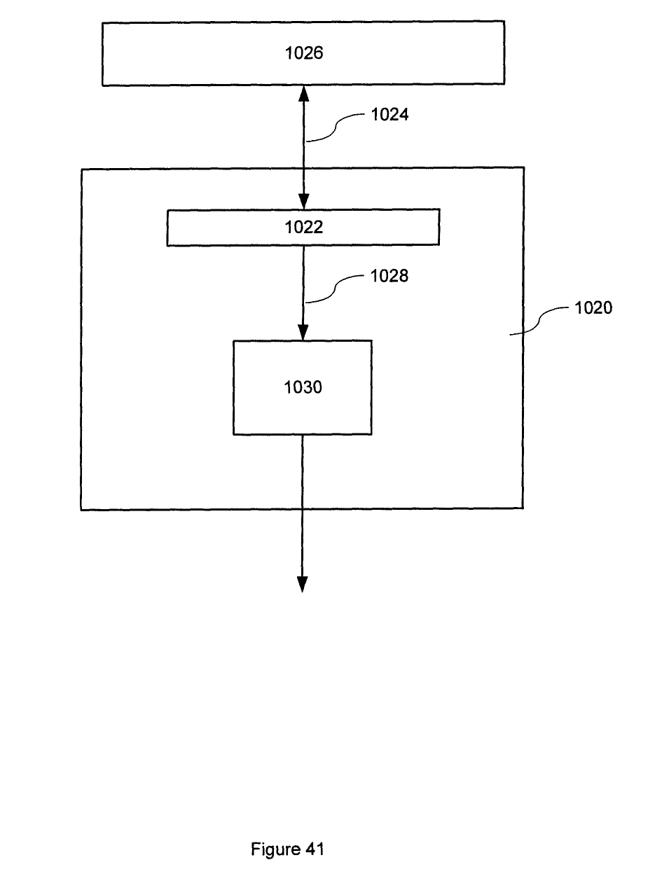

FIG. 41 schematically illustrates a HDA codec 1020 comprising a HDA link 1022, which acts as an interface for the HDA bus 1024 that communicates with a HDA controller 1026.

The HDA codec 1020 comprises an output audio channel/path 1028, which is output from the HDA codec 1020. The codec comprises a signal level limiter 1030 that is arranged to limit the signal level of the audio channel 1028.

The signal level limiter 1030 allows the output audio channel 1028 to be used in a line out mode and in a headphone mode using one and the same amplifier. The signal level limiter 1030 limits the line load of the output audio channel 1028 to 0.8 Vrms in headphone mode and 2 Vrms in line out mode.

The signal level limiter reduces the signal level in headphone mode by using a −8 dB attenuator, enabled using a standard HDA headphone enable control. This is a new use of an existing control. The attenuator may already be provided, for example used to comply with local laws on permitted sound levels.

In other words, instead of using the headphone enable control to select between two different amplifier circuits, this control is employed to engage an attenuator placed before a single amplifier. The attenuator may be in the digital domain, i.e. applied prior to digital to analogue conversion of the output audio channel.

Consider the situation of a headphone jack being inserted in to the port associated with the audio channel 1028 by mistake. The codec detects the headphones and enables a headphone enable bit. The HDA codec 1020 is responsive to the headphone enable bit, and the signal level limiter 1030 is arranged to limit the signal level of the audio channel 1028 to the headphone level of 0.8 Vrms with the −8 dB attenuator, using the headphone enable control. By limiting the signal level (line out load) upon detection of headphones, accidental damage to the headphones caused by plugging into the “wrong” port can be avoided.

Conventional HDA compliant personal computers and the like e.g. laptops usually contain three audio ports, typically in the form of 3.5 mm jack sockets. One of the jack sockets is usually designated as a microphone input, another jack socket as a line input and the final jack socket as line output. Analogue signals fed to either input are supplied to an analogue to digital converter (ADC) of a HDA codec for capturing. As a line input source has different impedance requirements and signal level characteristics to a microphone input source, it is necessary for the two input jack sockets to be coupled to analogue to digital converters via appropriate input stages. Conventionally, separate input stages are provided for each of the microphone input and the line input.

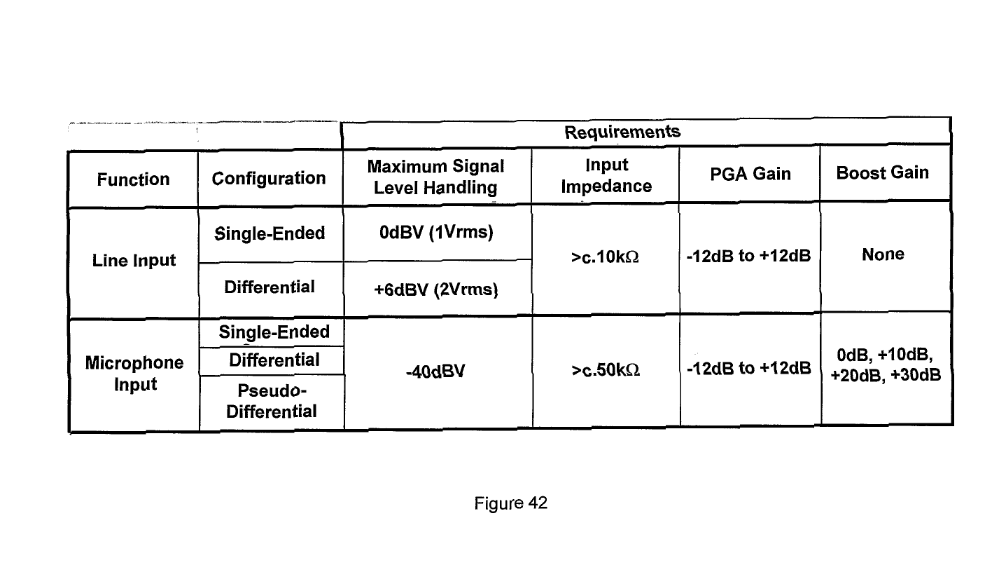

FIG. 42 shows a table listing the possible input configurations that need to be supported by a HDA compliant personal computer for both line inputs and microphone inputs. As can be seen in FIG. 42, a line input can be either single-ended or differential. In both these cases, it is necessary to present an input impedance of around 10 kΩ. A microphone input can be single-ended, differential or pseudo-differential with an input impedance of around 50 kΩ in all cases. Both microphone and line input signals may be routed through a programmable gain amplifier (PGA) with a gain of −12 dB to +12 dB, but the microphone input will typically be provided with an additional boost stage giving a defined boost of up to 30 dB.

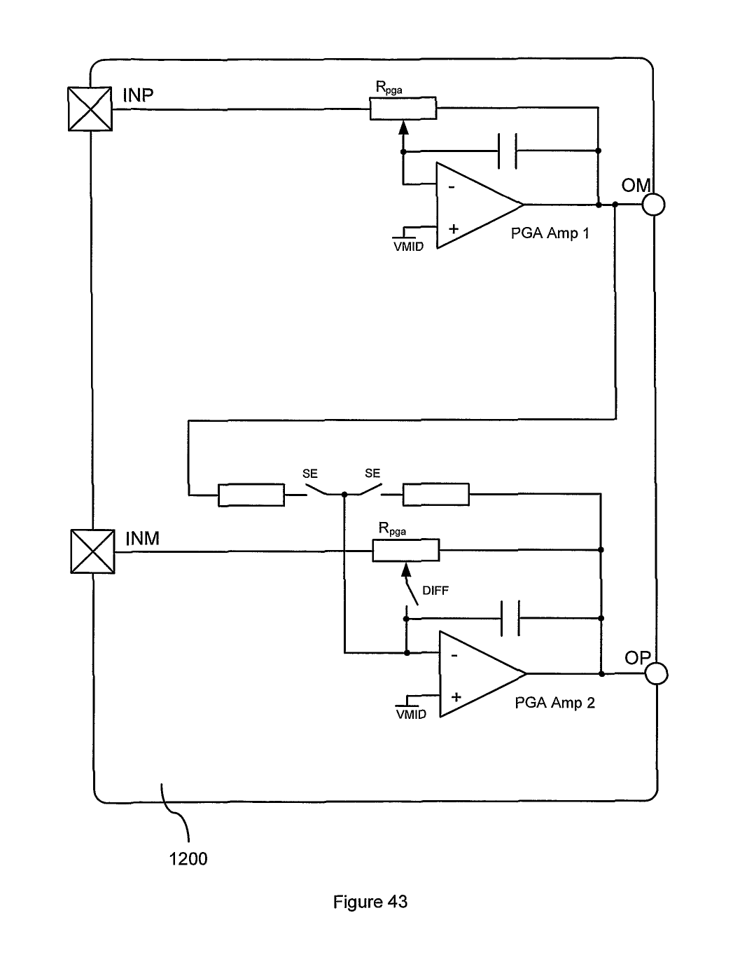

FIG. 43 illustrates a known input stage 1200 of an ADC (not shown). Input stage 1200 uses a single-stage, inverting amplifier configuration. This input stage is designed for use with line input sources only.

It is not possible for input stage 1200 to be effectively used as an input stage for microphones, because the impedance presented by the input stage 1200 varies inversely with the gain added by the input stage. Normally, a high gain leads to a relatively low impedance and unacceptably high noise level.

In view of this, assuming that a HDA codec in a HDA compliant personal computer utilises input stage 1200 for line inputs, it would also be necessary to provide a dedicated separate input stage for microphone type inputs. This is undesirable, because two input stages will be required to support all of the input configurations shown in FIG. 42, thereby increasing the number of components needed, pin count, chip area and cost.

In order to reduce the number of components and to minimise production costs of a HDA codec, it is desirable to provide a single input stage that can support all of the different configurations shown in FIG. 42.

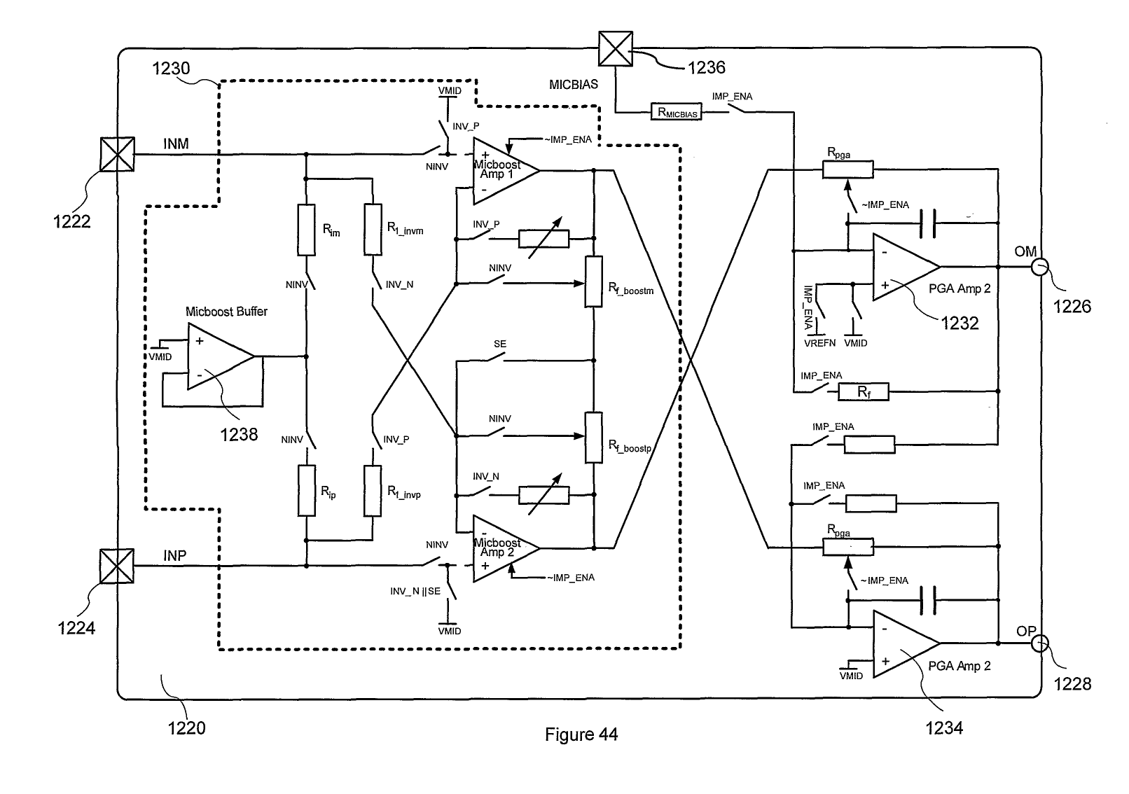

FIG. 44 illustrates an input stage 1220 according to an embodiment of the invention. A single-channel input stage is shown. As will be apparent to the person skilled in the art, in practice multiple (typically two) such input stages may be provided in front of each ADC of the codec, one per channel. Input stage 1220 is intended primarily for microphone inputs, but has a versatile input architecture that can also support line inputs.

Input stage 1220 comprises an input terminal INM 1222 and an input terminal INP 1224. Input terminal 1222 and input terminal 1224 are arranged to receive signals from an input source, e.g. a microphone input or line input. Input terminal 1222 and input terminal 1224 are coupled to a first output OM 1226 and a second output OP 1228 via microphone boost circuitry (stage) 1230 and a first programmable gain amplifier (PGA) 1232 and a second PGA 1234. Input stage 1220 is also provided with a microphone bias (MICBIAS) input 1236 as an input into the PGA 1232 for use with certain microphone types such as an electret condenser which requires a bias voltage. Various switched are present, which collectively for a switching means applied to the input terminals and internal connections within the microphone boost stage 1230. Switches also allow selectable connection between microphone boost stage and the PGAs 1232, 1234.

It is desirable for input stage 1220 to support a microphone sensitivity level of −45 dBV and an SNR of 65 dB in microphone inputs. To meet this requirement, an input referred noise floor significantly lower than −110 dBV is required, as is a high input impedance and common-mode noise rejection.

In order to achieve these requirements with reasonable silicon area and power means, the microphone boost stage 1230 is placed before the PGA amplifier 1232 and PGA amplifier 1234. This is beneficial from a noise perspective however does raise other issues. Any dc-offset from the microphone boost stage 1230 is amplified by a high-gain thus there will be significant dc-offset at the input to the PGA amplifiers 1232, 1234. This will be modulated by the PGA gain setting and cause zipper noise.

Input stage 1220 of FIG. 44 can be configured in a number of different input configurations. These include a differential non-inverting input configuration, a differential inverting input configuration (pseudo-differential input configuration) and a single-ended inverting input configuration. Input stage 1220 can also be configured in an impedance sense configuration, as will be described later. Switching within the microphone boost stage 1230 determines which configuration is currently set.

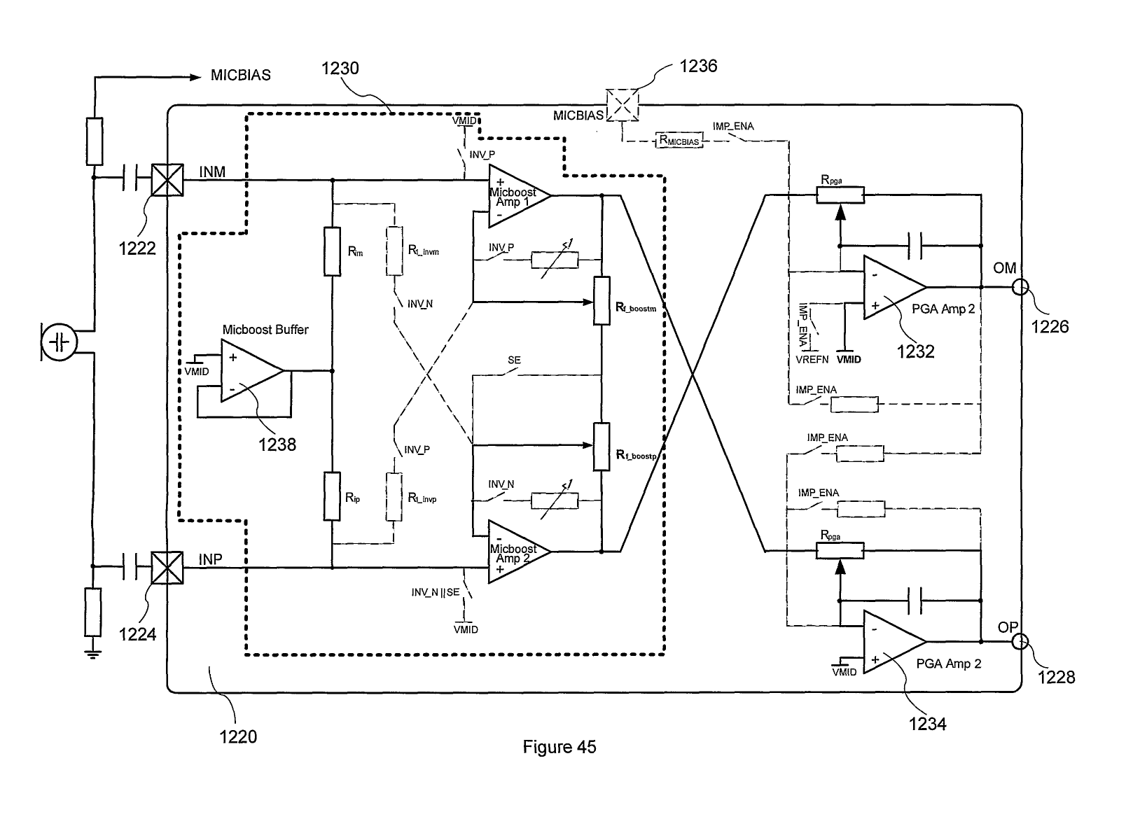

FIG. 45 illustrates the input stage of FIG. 44 in which the microphone boost stage 1230 is switched such that the input stage is in a differential non-inverting configuration. In FIG. 45, parts of the input stage that are not utilised in this configuration are shown with a dashed line. This configuration provides a high input impedance. It also makes the common-mode gain of the microphone boost stage 1230 independent of gain setting (and equal to unity). A buffered reference (microphone boost buffer) 1238 is required to provide dc bias for the ac coupled inputs. Also, the maximum signal level is limited by the common-mode input range of the amplifier. For this reason, this configuration is suitable for use for low-level, high impedance input signals such as microphone inputs.

It can be shown that the mic-boost amplifiers (Micboost Amp 1 and 2) are the dominant noise contributors. Because of the gain arrangement the PGAs 1232, 1234 contribute very little to the noise, thus these amplifiers can be scaled back. Note that the noise contribution of the microphone boost buffer 1238 and associated resistors is assumed to be common-mode and therefore rejected by the input stage in this configuration.

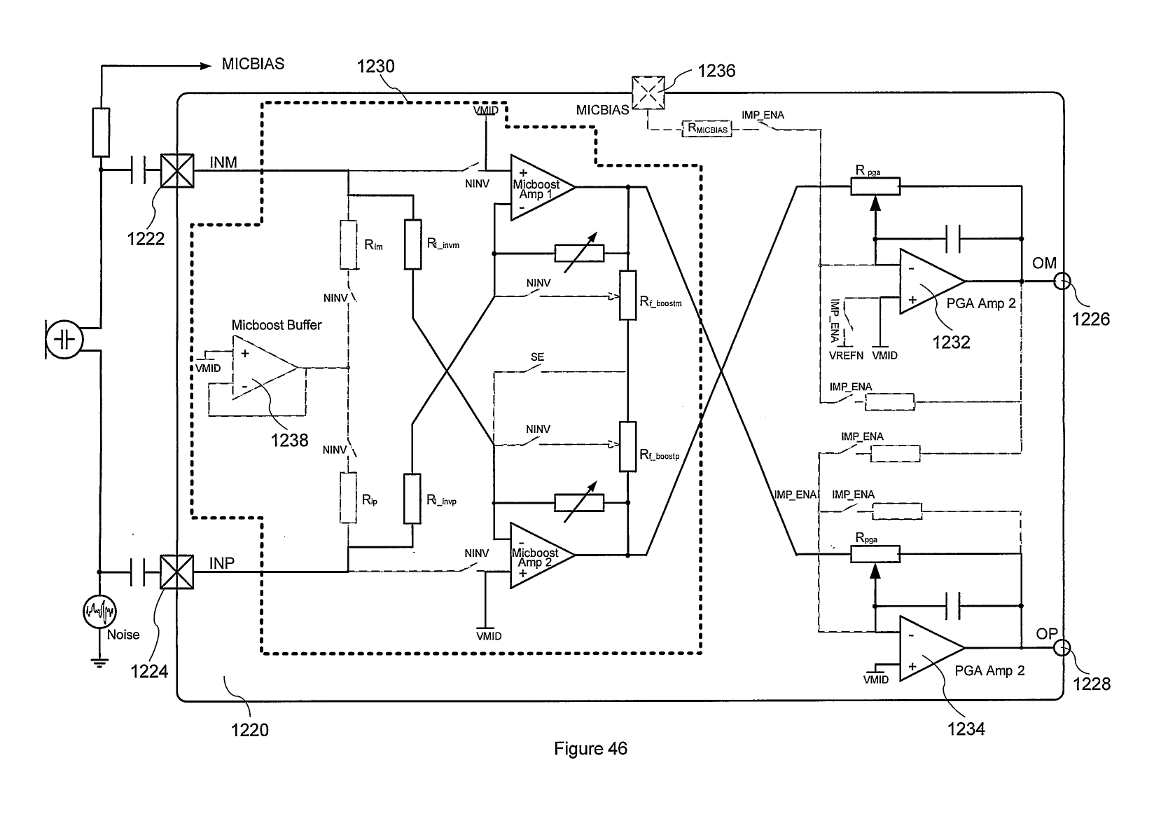

FIG. 46 illustrates the input stage of FIG. 43 in which the microphone boost stage 1230 is switched such that the input stage is in a differential inverting configuration (pseudo differential configuration). This configuration can be used for a pseudo-differential input where any noise on the ground return of the microphone is made common-mode and will be rejected by the input stage. The inverting configuration results in a much lower input impedance. For noise constraints, the input impedance in this configuration is set at 10 kΩ. Note that due to the presence of the virtual earth (VMID) at the input of the op-amps this configuration is also suitable for line input signals.

In this configuration, the input resistors (R₁₋ᵢₙᵥₘ, R₁₋ᵢₙᵥₚ) are now significant noise contributors. This contribution to the noise can be lowered by lowering the input impedance of the input stage.

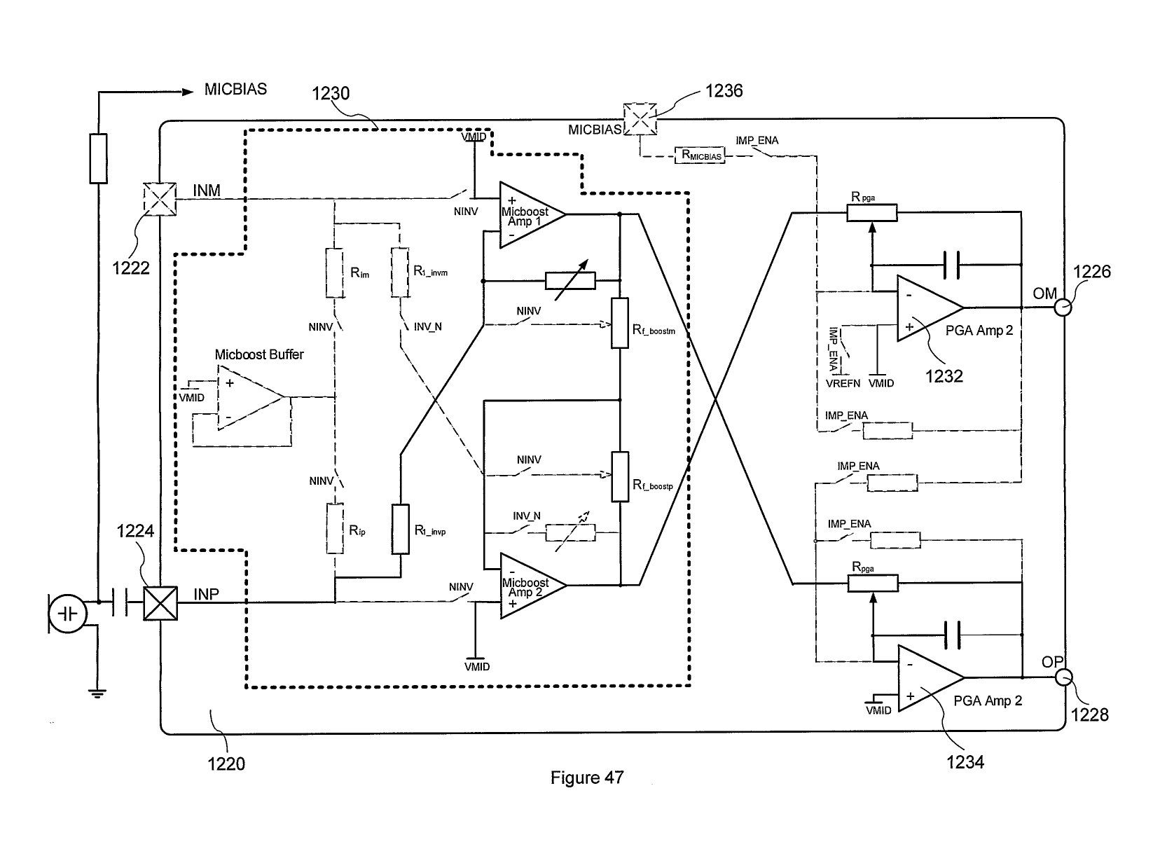

FIG. 47 illustrates the input stage of FIG. 43 in which the microphone boost stage 1230 is switched such that the input stage is in a single ended inverting configuration. This configuration is used when the input is connected in a single-ended way. Again, for noise constraints, the input impedance of this configuration is limited to 10 kΩ.

This configuration provides that advantage that the single-to-differential conversion gives 6 dB of gain, which in turn means the gain in the microphone boost stage 1230, can be dropped by 6 dB accordingly.

The configurability of input stage 1220 of FIG. 44 allows the system designer to trade-off factors such as noise, input impedance and common-mode gain.

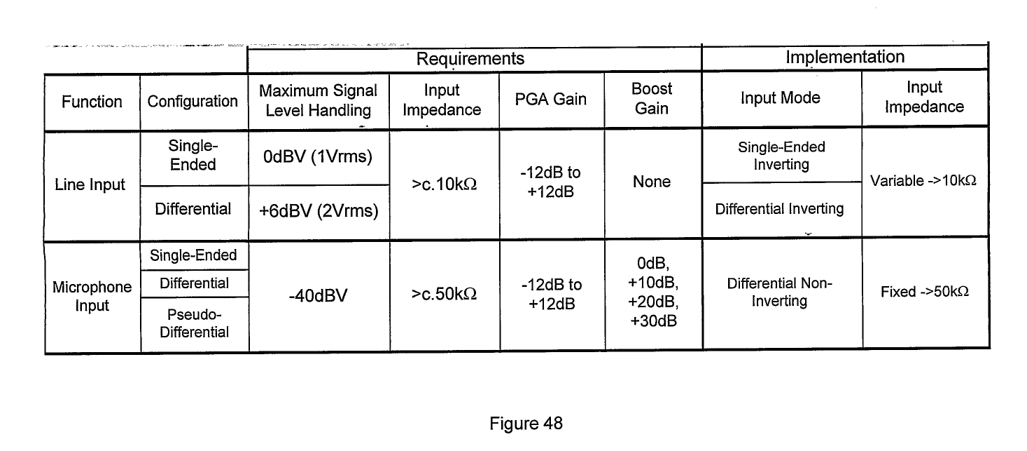

FIG. 48 shows a table listing, in a similar fashion to FIG. 42, the possible input configurations for both line inputs and microphone inputs and how in one example of the present invention these input configurations are supported.

As can be seen in FIG. 48, for all microphone inputs, the input stage is configured in the differential non-inverting configuration, with the input impedance fixed at 50 kΩ. For single-ended line inputs, the input stage is configured in the single-ended inverting configuration and for differential line inputs, the input stage is configured in the differential inverting configuration (pseudo-differential configuration). For all line inputs, in both configurations of the input stage, the input impedance is variable, but limited to 10 kΩ.

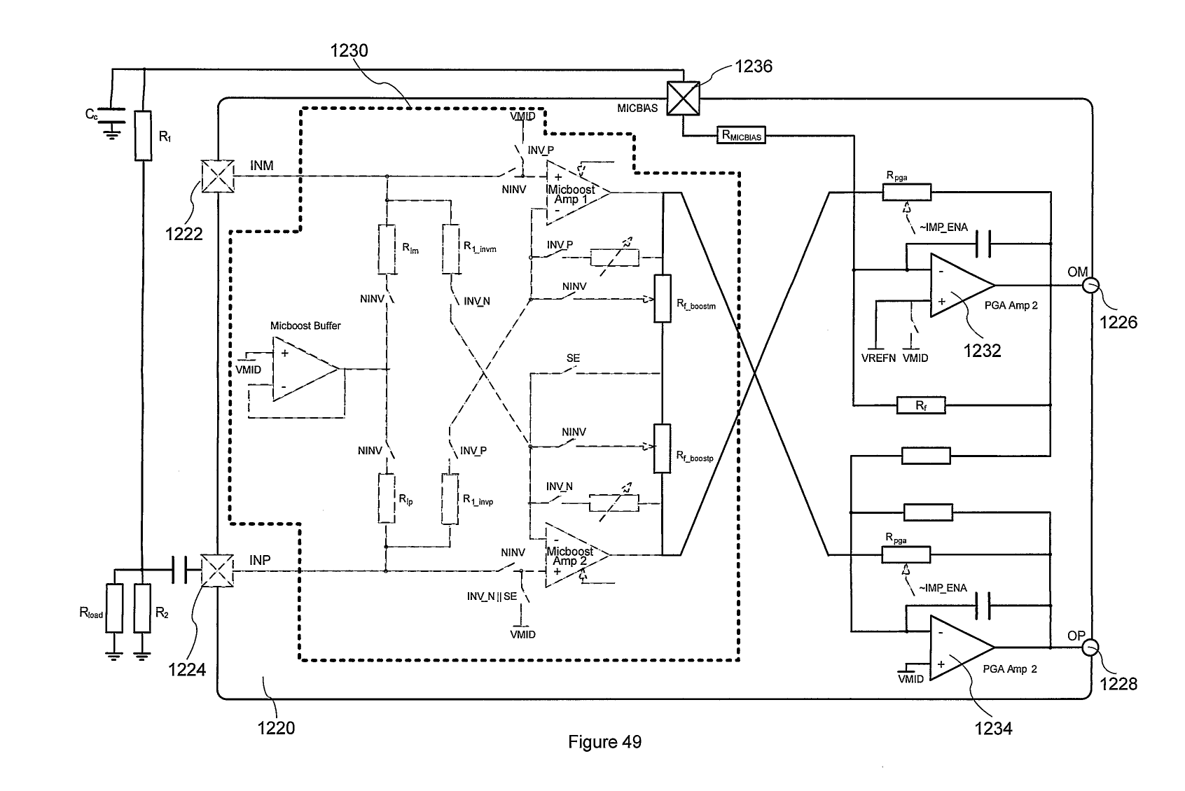

Another feature of input stage 1220 of FIG. 44, is that it can also be used to sense the impedance of the load connected to the microphone bias circuit (input) 1236. This impedance sense configuration is shown in FIG. 49.

A microphone load will typically be configured as shown in FIG. 49. In this diagram the microphone is represented by R_{load}. Also shown are two biasing resistors, R₁ and R₂, as well as a microphone bias compensation capacitor C_{c}. In this impedance sensing configuration the output voltage of the input stage will be given by:

$${V}_{OM} = {V}_{refn} ( 1 + \frac{{R}_{f}}{{R}_{A}} )$$

$${V}_{OP} = A V D D - {V}_{OM}$$

$$Where \text{:}$$

$${R}_{A} = {R}_{MICBIAS} + {R}_{1} + {R}_{2} \vert \vert {R}_{load}$$

The microphone impedance can therefore be measured by monitoring the current drawn on the microphone bias input (pin) 1236.

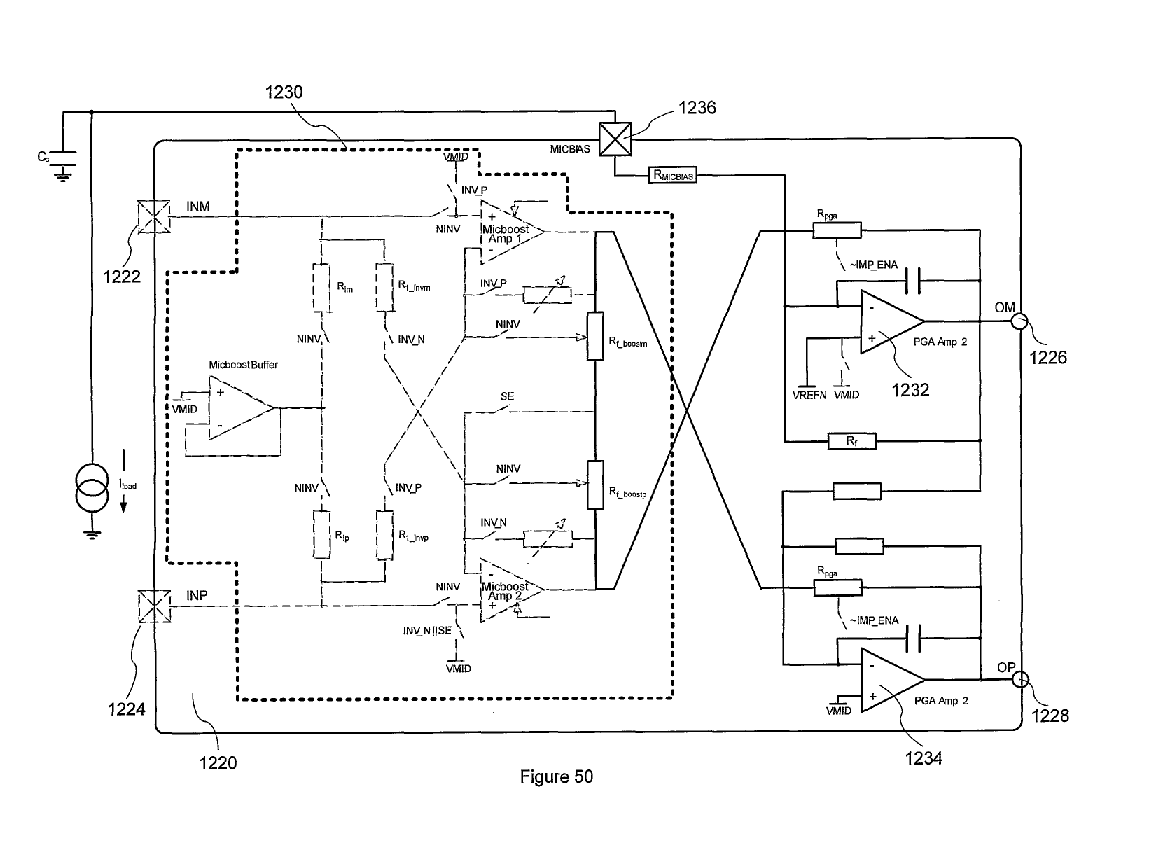

It is also possible, for evaluation purposes to sweep a current source load on the microphone bias pin 1236 rather than trying to directly measure an impedance. FIG. 50 illustrates a configuration of the input stage, which is arranged to perform an impedance sweep measurement.

In this case:

V_{OM}=I_{load}·R_{f}+V_{refn}

V_{OP}=AVDD−V_{OM}

By performing an impedance sense measurement using either the configuration of FIG. 49 or the configuration of FIG. 50, not only the presence of a microphone but also some indication of the type of microphone may be obtained. This avoids the need for additional circuitry (such as another DAC or a set of comparators) dedicated to impedance sensing.

In the case of a HDA codec, the above-mentioned configurability may be controlled via the HDA link, as will now be explained.

A HDA compliant audio system e.g. a personal computer, laptop or the like, may comprise a HDA codec with analogue to digital converters each equipped with the input stage of FIG. 44. The HDA codec is operable to communicate data and signalling with an external HDA controller through serial data transmission over a HDA link. The audio system also contains at least one input jack socket for receiving analogue signals from a microphone input or line input.

Consider the situation in which a jack plug of a microphone is inserted into a jack socket of the HDA compliant audio system. The audio system may detect insertion of the jack plug in the jack socket by monitoring the opening or closing of switch contacts. As will be apparent to the person skilled in the art, any method of detecting jack insertion into the audio system could be employed. As mentioned above, impedance sensing may be used. Assuming, however, the physical detection of the jack plug, then upon detecting the insertion, the HDA codec notifies the HDA controller of the insertion. This notification may be in the form of the HDA codec setting a status bit in a register, which the HDA controller can read using a get verb.

In response, the HDA controller sends a command to the HDA codec instructing the codec to configure the input stage to an impedance sense mode, such as one of the configurations shown FIGS. 49 and 50. Upon completion of the impedance sense, the HDA codec notifies the HDA controller of the impedance of the input source. This notification may be a simple indication (such as high or low, or a set of ranges), rather than any exact value, and may again be in the form of setting a status bit in a register for the HDA controller to read.

The HDA controller can then select the appropriate configuration of the input stage depending upon the detected impedance. In this example, the detected impedance indicates that the input source is a microphone. The HDA controller will therefore send a command to the HDA codec for the input stage to be configured in the differential non-inverting mode as shown in FIG. 45.

The HDA controller may use a look up table in order to determine which configuration of the input stage is appropriate for each detected impedance.

Embodiments of the invention can be used in devices such as audio codecs that are used in audio apparatus including, for example, desktop and laptop computers (the latter term also intended to cover small form-factor equipment such as mobile internet devices or MIDs), mobile telephones, portable media players, multifunction devices combining features of mobile telephones, media players, and digital cameras, and so on. In addition, devices embodying the present invention may find use in home audio/AV apparatus including hi-fi amplifiers, home cinema receivers, disc players, set-top boxes, external DACs and so forth. Embodiments of the present invention may also find use in headphone amplifiers and headphones, especially those employing audio processing for noise cancellation for example, and in-car entertainment systems having audio capability including sat-nay and video systems. Another application of audio devices employing the present invention is to a so-called “hub” for managing and distributing multiple audio and/or video sources in the home. More generally, embodiments of the invention may be applied to reproducing and/or recording any media involving audio data such as video files, DVDs etc., and in numerous other applications. A further use of such devices is in electronic musical instruments and recording equipment used in music production.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications, embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re-)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims or drawings. The word “comprising” does not exclude the presence of elements or steps other than those listed in a claim, “a” or “an” does not exclude a plurality, and a single element or other unit may fulfil the functions of several units recited in the claims. Any reference signs in the claims shall not be construed so as to limit their scope.

It should also be noted that the attenuation, or decrease, of a signal amplitude is a form of amplification, thus the word “amplify”, amplifying“, “amplified” and the like can be taken to mean an increase or a decrease in the amplitude of a signal. Similarly any reference to “gain” applied may refer to a gain less than unity being applied (that is the effect of applying “gain” to a signal may result in its attenuation). The terms “gain” and “amplify” are intended to be interchangeable. Also any reference to “addition”, “add” or “adding” may equally mean subtraction. Any reference signs in the claims shall not be construed so as to limit their scope.

In the context of this description, “codec” refers to any device or circuitry which is physically distinct from the controller; it should be noted however, that codecs need not be exclusively hardware based. Typically, driver software is used to control functional blocks of the codec under supervision of the controller.

In the context of the description the term “processing” is not limiting to the manipulation or modification of data. Indeed, it should be understood that processing may also mean receiving, handling and transceiving data.

Whilst endeavouring in the foregoing specification to draw attention to draw attention to those features of the invention believed to be of particular importance, it should be understood that the applicant claims protection in respect of any patentable feature or combination of features hereinbefore referred to and/or shown in the drawings whether or not particular emphasis has been placed thereon.

1. An audio device arranged for communication of data and signalling with a controller, signalling from the device to the controller being made in discrete time slots, the device comprising:
a plurality of nodes, each assigned a priority value and each having one or more unsolicited response sources capable of generating an unsolicited response for transmission to the controller, wherein unsolicited responses generated from a particular node are assigned the priority value of that node; and
unsolicited response management means operable to hold unsolicited responses generated by the plurality of nodes that are awaiting transmission to the controller,
wherein when two or more unsolicited responses are awaiting transmission to the controller in the unsolicited response management means, the device is arranged to transmit the unsolicited response with the highest assigned priority value first, in the next free time slot.

2. A device according to claim 1, wherein when more than one unsolicited response awaiting transmission in the unsolicited response management means have the same assigned priority value, the device is arranged to transmit the unsolicited response that was generated first of the unsolicited responses with the same priority value, before transmitting other unsolicited responses with that same priority value.

3. A device according to claim 1, further comprising priority definition means by which the priority value for each node may be user defined.

4. A device according to claim 1, wherein the priority definition means is responsive to an instruction communicated via the controller.

5. A device according to claim 1, wherein each node is assigned a unique priority value.

6. A device according to claim 1, wherein the unsolicited response management means is a virtual queue, which is arranged to store unsolicited responses awaiting transmission and order them for transmission according to their assigned priority values.

7. A device according to claim 6, wherein the virtual queue is a fixed array which contains an entry associated with every unsolicited response source.

8. A device according to claim 7, wherein each entry comprises a trigger status value, a priority value and a trigger order value, wherein
the trigger status value indicates whether or not an unsolicited response has been generated from the particular unsolicited response source,
the priority value indicates the priority assigned to unsolicited responses generated from the particular unsolicited response source, and
the trigger order value indicates the order in which unsolicited responses held in the fixed array were generated.

9. A device according to claim 8, wherein the codec is arranged to calculate an entry value for of each entry in the fixed array by concatenating the trigger status value, the priority value and the trigger order value.

10. A device according to claim 9, wherein the trigger status value is more significant in the concatenation of the entry value than the priority value and the priority is more significant in the concatenation of the entry value than the trigger order value.

11. A device according to claim 10, wherein the entry in the table with the lowest value is transmitted first, in the next free time slot.

12. A device according to claim 10, wherein the entry in the table with the highest value is transmitted first, in the next free time slot.

13. A device according to claim 11, wherein the entry in the array with the lowest value or the highest value is found using a search routine.

14. A device according to any of claim 8, wherein the fixed array keeps a record of the number of unsolicited responses held in the array.

15. A device according to any of claim 8, wherein the trigger order value for each unsolicited response held in the fixed array is updated when an unsolicited response is sent to the controller.

16. A device according to claim 8 wherein each of the nodes is responsive to a request from the controller to generate a solicited response, such solicited responses occupying some of said time slots.

17. A device according to claim 16 wherein the device is an HDA codec for communication with an HDA controller via a HDA bus providing said time slots with a capacity of one solicited or unsolicited response per time slot.

18. A device according to claim 17, wherein a HDA custom verb is used to set, in the register of a particular node, the priority value for unsolicited responses generated from that node.

19. A method of managing status reports transmitted from a device to a controller, comprising:
defining sequential time slots each for transmission of one status report at a time from the device to the controller;
assigning a respective priority value to each of a plurality of functional units of the device capable of autonomously generating a status report;
temporarily storing each status report autonomously generated by said functional units prior to transmission to the controller; and
when two or more status reports are awaiting transmission to the controller, transmitting the status report with the highest assigned priority value first, in the next available time slot.

20. The method according to claim 19 wherein the device is a HDA codec, the controller is an HDA controller, the time slots are provided by an HDA bus, and the autonomously generated status reports are unsolicited responses of nodes of the HDA codec.

21. The method according to claim 20 wherein the HDA controller requests solicited responses from nodes of the HDA codec and the solicited responses take precedence over the unsolicited responses for transmission in said time slots.

22. Software for a device, the device arranged to transmit status reports one by one in discrete time slots to a controller, the software when executed by control logic of a device performing the functions of:
assigning a respective priority value to each of a plurality of functional units of the device capable of autonomously generating a status report;
temporarily storing each status report autonomously generated by said functional units prior to transmission to the controller; and
when two or more autonomously generated status reports are awaiting transmission to the controller, transmitting the status report with the highest assigned priority value first, in the next available time slot.

23. A computer-readable medium on which is recorded the software according to claim 22.

24. An electronic apparatus including the device of claim 1.

25. The electronic apparatus of claim 24 in the form of a portable computer or mobile internet device.

26. The electronic apparatus of claim 24 in the form of an audio system.

27. The electronic apparatus of claim 24 in the form of a mobile telephone, personal media player or multifunction device combining these functions.

28. The electronic apparatus of claim 24 in the form of an audio hub.
